(19) United States
(12) Patent Application Publication
(10) Pub. No.: US 2003/0149934 A1
(43) Pub. Date: Aug. 7, 2003

(54) Computer program connecting the structure of a xml document to its underlying meaning

(76) Inventor: Robert Peel Worden, Cambridge (GB)

Correspondence Address: Richard C Woodbridge, Woodbridge & Associates, P O Box 592, Princeton, NJ, 08542-0592, US

(21) Appl. No.: 10/275,310

(22) PCT Filed: May 11, 2001
(86) PCT No.: PCT/GB01/02078

(30) Foreign Application Priority Data
May 11, 2000 (GB) 0011426.4

(51) Int. Cl. G06F 15/00

(52) U.S. Cl. 715/513

(57) ABSTRACT

A computer program which uses a set of mappings between XML logical structures and business information model logical structures, in which the mappings describe how a document in a given XML based language conveys information in a business information model.

### FIELD OF THE INVENTION

This invention relates to computer program connecting the structure of an XML document to its underlying meaning.

### DESCRIPTION OF THE PRIOR ART

To conduct e-business transactions, companies need a common language through which to exchange structured information between their computer systems. HTML, the first-generation language of the Internet, is not suited for this task as it defines only the formatting of information, not its meaning. Extensible Markup Language—XML—has been developed to address this deficiency: XML itself is not a language, but gives a facility for users to define their own languages (“XML-based languages”), by defining the allowed elements, attributes and their structure. Like HTML, XML consists of text delimited by element markers or ‘tags’, so it is easily conveyed over the Internet. In XML however, the tags can define the meaning and structure of the information, enabling computer tools to use that information directly. By defining an XML-based language through a “schema”, users may define that XML messages which conform to the schema have certain defined meanings to the computer systems or people who read those messages. For instance, a schema may define an element ‘customer’ with the effect that text which appears between ‘customer’ tags, in a form such as <customer>J. Smith</customer>, gives the name of a customer. A message is simply a document or documents communicated between computer systems.

XML has been designed to convey many different kinds of information in a way that can be analysed by computer programs, using a set of tags (as explained above) which determine what kind of information is being conveyed. Information in XML documents can also be viewed by people, using a variety of techniques—for instance, transforming the XML into HTML which can be viewed on a browser.

However, in order to view such information, or to write computer applications which use the information in XML documents, it is necessary to know how the XML language encodes different kinds of information.

For instance, one of the most common application programming interfaces (APIs) to XML is the Domain Object Model (DOM), in which XML structure in a document is converted to an internal tree structure in the computer memory, and the API gives facilities to navigate this tree. To use a DOM interface, the application designer needs to know the structure of the DOM tree and how to navigate the DOM tree to extract each kind of information he needs.

As another example, the current W3C candidate for an end-user query language for XML, whereby users may ask questions and retrieve the answers from an XML document, is called XQuery. In order to use XQuery effectively, a user needs to understand the structure of an XML document, and how that structure encodes information.

The result is that in order to adapt XML applications to different XML languages, very often either the source code of the application needs to be changed or the users need to understand the structure of a new XML language. As XML languages proliferate, these changes can be very expensive.

As noted above, the allowed elements, attributes and structures for an XML-based language are defined in the ‘schema’ for that language. The W3C-approved standard schema ‘notation’ for XML schemas is the Document Type Definition, or DTD. Several other schema notations are in use, including XML Data Reduced (XDR) and XML Schema, which is now a W3C recommendation. For any given schema notation, such as DTD, XDR and XML Schema, many schemas will have been written. Each schema defines a particular XML-based language.

This open-ended facility to define XML-based languages, each language having a well-defined set of possible meanings, has led to a proliferation of industry applications of XML, each with its own language definition or ‘syntax’, where syntax means the structure of elements, attributes and content model links in an XML message, which should conform to the structure required for the language in the schema. A schema defines the applicable syntax; there can be different schemas defining the same syntax in different schema notations.

XML has been embraced enthusiastically by all of the major IT suppliers and user groups. Its standardization and rapid uptake have been a major development in IT over the past three years. Industry rivals like IBM, Microsoft, Sun, and Oracle all support the core XML 1.0 standard, are developing major products based on it, and collaborate to develop related standards. XML can therefore be thought of as the standard vehicle for all Business-to-Business (B2B) e-commerce applications. It is also rapidly becoming a standard foundation for enterprise application integration (EAI) within the corporation.

A major problem is that of XML ‘interoperability’, i.e. enabling a computer system ‘speaking’ XML in one XML-based language to communicate with another system using a different XML-based language. In this context, the two computer systems may be in different organisations (for e-commerce) or the same organisation (for application integration): XML interoperability can also be a problem within an organisation too—if different package suppliers favour different XML-based languages of XML, all their applications may need to be integrated within that one organisation

An element of any XML interoperability solution must include some form of translation between the different XML-based languages (Le. translation of documents in one XML-based language to another XML-based language): there is a standardised XML-based technology, XSL, and its XML-to-XML component XSLT, for doing so. However, translating between many XML-based languages is difficult, even using XSL, for the following reasons:

If there are N different XML based languages which a company may have to use, then in principle up to N×(N−1) XSL translation files may be needed to inter-operate between them. The numbers can be forbidding. On the BizTalk repository site (see below), there are 13 different XML formats for a ‘purchase order’. If even a small fraction of the 156 XSL translations are needed, this is a challenging requirement.

XSL is a complex Programming Language. To write an error-free translation between two XML-based languages, one must understand the semantics of both XML-based languages in depth; and understand the rich facilities of the XSL language, and use them without error.

There is a significant problem of version control between changing XML-based languages. As each XML-based language is used and evolves to meet changing business requirements, it goes through a series of versions. As a pair of XML-based languages each go through successive versions, out of synch with each other, and some users stay back at earlier versions, a different XSL translation is needed for every possible pair of versions—just to translate between those two XML-based languages. While much of a version change may consist of simple extensions and additions, some of it will involve changes to existing structures, and may require fundamental changes in the XSL.

The XML translation problem is often portrayed as an issue of different ‘vocabularies’, in that different XML-based languages may use different terminology—tag names and attribute names—for the same thing. However, the differences between XML-based languages go much deeper than this, because different XML-based languages can use different structures to represent the same business reality. These structural differences between XML based languages are at the heart of the translation problem. Just as in translating between natural languages such as English and Chinese, translation is not just a matter of word substitution; deep differences in syntax make it a hard problem. Finally, it might be impossible to translate between one XML-based language to another not just in practice, but in principle: the meanings may just not overlap.

The track record of XSL translation to date is not encouraging. For instance, the BizTalk website (see below) is intended to be a repository for XSL translations between XML-based languages, as well as for the XML-based languages themselves. But while (at the time of writing) over 200 XML-based languages have been lodged at BizTalk, there are few if any XSL translations between XML-based languages. In practice it seems to be a forbidding task to understand both your own XML-based language and somebody else's XML-based language in enough depth to translate between them. Suppliers of XML-based languages are not to date stepping up to this challenge.

A similar problem of interoperability arose in the 1980s with the emergence of relational databases. In spite of the existence of an underlying technology to solve it Relational Views), it has in practice not been solved in twenty years. The result has been an information Babel within every major company, which has multiplied their information management and IT development costs by a large factor.

A significant feature of XSL is that it makes no explicit mention of the underlying meanings of the XML actually being translated: it in effect typically comprises statements such as “translate tag A in XML-based language 1 to tag B in XML-based language 2”. Hence, it nowhere attempts to capture the equivalence in meaning between tags A and B, or indeed what they actually mean.

Further reference may also be made to the following.

(1) Techniques to capture the meaning and structure of business information in implementation-independent terms, going back to data modelling and entity-relationship diagrams, including also UML class models, the W3C recommendation RDF-Schema, and AI-based ontology representations such as KIF, the DAML+OIL notation.

(2) Sun's XML-Java initiative, which aims to provide developers with automatically generated Java classes which reflect the structure of an XML-based language. This operates at the level of the XML syntax, not the semantics.

(3) The OASIS backed ebXML repository initiative, which talks about using UML to capture information about XML-based languages.

(4) XML parsers, which can convert XML from an external character-based file form into an internal tree form called ‘Domain Object Model’ (DOM) standardised by W3C; and can also validate that an XML message conforms to some schema, or language definition.

(5) XSL translators, which can read in an XSLT file, store it internally as a DOM tree, then use that DOM tree to translate from an input XML message in one language to an output XML message in another language.

(6) The W3C XPath Recommendation, which is a method of describing navigational paths within an XML document; XSLT makes use of XPath.

### SUMMARY OF THE PRESENT INVENTION

In a first aspect of the invention, there is a computer program which uses a set of mappings between XML logical structures and business information model logical structures, in which the mappings describe how a document in a given XML based language conveys information in a business information model.

Hence, the present invention envisages in one implementation using a set of mappings between an XML language and a semantic model of classes, attributes and relations, when creating or accessing documents in the XML language. In this implementation, a mapping is a specification of which nodes should be visited and which paths (e.g. XPaths) traversed in an XML document to retrieve information about a given class, attribute or relation in the class model.

The set of mappings between an XML language and a class model may be embodied in an XML form called Meaning Definition Language (MDL), which is described in more detail in this specification.

Using the mappings, a piece of software (the interface layer) can convert automatically between an XML structural representation of information (such as the Domain Object Model, DOM) and a representation of the same information in terms of a class model of classes, attributes (sometimes referred to as ‘properties’) and relations (sometimes referred to as ‘associations’. This conversion can be in either direction: X structure to class model, or vice versa.

The key benefit of mappings is: If applications are interfaced to XML via mappings (which are read by software as data, not ‘hard-coded’ in software), then any application can be adapted to a new XML language by simply using the mappings (i.e. data) for the new language, without changing software.

Using mappings and an appropriate interface layer, three important applications are possible, as described in depth in the Detailed Description of this specification:

Meaning-level query language: queries are stated in terms of the class model. The query tool retrieves data from an XML file via the mappings, so (a) users do not need to know about XML structure, (b) the same query can be run against multiple XML languages.

Meaning-Level API: Applications in e.g. Java use an API (to the interface layer) which refers only to the class model, not to XML structure. The interface layer uses mappings for a language to translate class-model-based API calls into XML structure accesses for the language. Applications can adapt to new XML languages by simply changing the mappings, i.e. with no change to software.

Translation: The interface layer gets information from an XML document in language 1 and converts it into class model terms. Then the interface layer converts the same information from class model terms back to language 2—so the information is translated in two steps from language 1 to language 2. Or a tool can use mappings to generate XSL which translates documents from language 1 to language 2.

If we focus for the time being on the application of the present invention to translation, this invention has several advantages over the prior art approaches to solving XML interoperability: First, it solves the N×(N−1) proliferation of translations problem, since the effort required to define the mappings for N languages is proportional to N, not N×(N−1). Secondly, it places the XML interoperability solution in the hands of individual business organisations, removing the need to wait for a common business vocabulary to arise (as required by many of the repository or supra-standards initiatives). The term ‘business organisation’ should be construed to cover not just a single organisation but also a group of organisations. The term ‘XML logical structures’ is defined in section 3 of the W3C XML specification.

The business information model preferably categorises the information relevant to the operations of a business organisation in terms of the following logical structures: classes of entities, the attributes of those entities of each class and the relations between the entities of each class. This trilogy of structures, referred to in this specification as ‘classes, attributes and relations’ are examples of business information model logical structures. These classes, attributes and relations may be contained in a Universal Modelling Language (UML) class diagram, or similar notation. The mappings between the logical structures in each XML-based language and the logical structures in the business information model may define how syntactic structures in each XML-based language relate to the business information model: the syntactic structures may readily be derived from Document Type Definitions (DTDs) or from any other form of schema notation such as an XDR file or XML Schema file. The business information model may categorise the information used by one or more organisations not only in terms of Universal Modelling Language class diagrams, but also in terms of ontological knowledge representation techniques, such as an RDF Schema model or a DAML+OIL model.

Each XML-based language may be described in its schema definition as a set of element types, attributes and content model links. Elements, attributes and content model links will be referred to collectively as ‘XML objects’. XML objects are an example of XML logical structures. The way in which each XML-based language conveys information in the business information model may then be defined by mappings between XML objects and the classes, attributes and relations (i.e. ‘logical structures’) of the business information model. Information about the mappings may be stored in an intermediate file, XML or otherwise. One such XML-based language for storing definitions of mappings is, as noted earlier, called Meaning Definition Language (MDL) and makes use of the W3C XPath recommendation. In MDL, XPath is used to define which paths in an XML document need to be traversed in order to extract the different entities, attributes and relations of a business information model.

In one implementation, it is possible to generate XSL using the sets of mappings for a first and a second XML based language to enable a document in the first XML based language to be translated automatically to a document in the second XML based language. Using the set of mappings involves the step of reading XML documents defining of the sets of mappings between XML logical structures and business information model logical structures. Messages can be dynamically translated from one XML language to another using the sets of mappings for the two languages to some common business information model.

As noted above, the mappings can be expressed in an intermediate mapping file in Meaning Description Language, MDL. One implementation of the present invention is therefore a tool which reads the MDL files (embodying the mappings of two XML languages) and uses it to generate XSLT to translate between them. It is also possible to provide a tool which can read MDL and, instead of using the mappings to generate XSLT, dynamically translates a message in one XML language to another. This implementation is described in more detail in this specification as a ‘direct translation embodiment’.

The XSL generated automatically may be in a file format and that file used by an external XSL processor to transform a document in the first XML-based language to a document in the second XML-based language. Alternatively, the XSL may be retained in some internal form such as the W3C-standard Domain Object Model, and then acted on by software which performs the same XML translation function as an XSL processor, acting directly on this internal form. Another possibility is that, instead of XSL, the system may generate source code in Java or some other programming language, which then performs the same translation functions as performed by an XSL processor.

The present invention envisages in one implementation an interface layer which uses the mappings of a first XML language onto a business model to read in data in the first XML language and convert it to an internal form reflecting the logical structures of the business model, and in which the interface layer uses the mappings of a second XML language onto the same business information model to convert data from the internal form reflecting the logical structures of the business information model to the structures of the second XML language. This can be used for translating between a first and a second XML based language. It can also be used to allow runtime translations, allowing the choice of the input and output XML languages to be made dynamically by the use of the appropriate mappings.

There are two important applications of MDL:

First, a meaning-based XML query language. This enables a user to interactively ask questions about XML documents in a form such as “display student.name where student attends course and course.name=‘French’”—so that the form of the question is dependent only on the business information model and is independent of any particular XML language. A tool then uses the MDL for some XML language to answer the question from an XML document in that language. The advantages over current XML-based query languages are (1) the user does not need to know about the structure of the XML and (2) the same query can be run against XML documents in many different languages. Hence, more formally, another aspect of the present invention covers a computer program in which an interface layer adapted to insulate code written in a high level language from XML based languages takes as an input a document in a M based language and converts information from a tree form (such as DOM) mirroring the structure of the XML based language to a form reflecting the business information model logical structures by using the mappings between them. This information is then displayed to the user, answering the query. The code written in a high level language allows users to submit queries in terms which reflect the logical structures of the business information model, not requiring knowledge of the structure of an XML language, and the translation layer allows a document in an XML based language to be queried, using the mappings of that XML language onto the business information model. The same query can be run against documents in different XML languages by using the sets of mappings appropriate for each such language.

The other important use of MDL is in a meaning-level application programming interface (API). This enables people developing an XML application in, say, java, to write their programs making reference only to the classes and objects in the business information model, without reference to the XML structure. The advantages are that programmers would not need to know about the structure of the XML, and the same programme could (by using MDL) run unaltered with several different XML languages. The benefits are therefore not to do with translation between XML languages per se; but with ‘internal’ translation from any XML to a form which depends only on the business information model—insulating developers from the vagaries of any one language. Hence, this invention covers an interface layer using the set of mappings described above and providing an API which insulates code written in a high level language which accesses or creates documents in XML based languages from the structure of those XML based languages. The interface layer may take as an input a document in an XML based language and converts in one or both directions between a tree mirroring the structure of the XML based language and business information model logical structures by using the mappings between them as described above.

Further aspects and details of the present invention are particularised in the appended claims.

Definitions

Throughout this patent specification these terms have the following meanings:

“XML-based language” is a specification of the allowed elements, attributes and content model links in a set of XML documents, as defined by a schema notation such as a DTD, XML Data Reduced or XML Schema

“XML” is the industry standard SGML derivative language standardised by the WorldWideWeb Consortium (W3C) used to transfer and handle data. (XML derives from SGML, Standard Generalised Markup Language. HTML is an application of SGML.)

“DTD” or “Document Type Definition” is a definition of the allowed syntax of an XML document. DTD is one example of a schema notation.

“Document”: A document is any file of characters. “XSL” is the industry standard translation language for translating documents between one XML-based language of XML and another. An example XSL document is given in this patent specification.

“XSLT” is that part of XSL which is intended mainly for translating one form of XML to another form of XML. The other part is for translation from XML to HTML and other formatting languages.

A “Programming Language” and “Computer Program” is any-language used to specify instructions to a computer, and includes (but is not limited to) these languages and their derivatives: Assembler, Basic, Batch files, BCPL, C, C+, C++, Delphi, Fortran, Java, JavaScript, Machine code, operating system command languages, Pascal, Pearl, PL/1, scripting languages, Visual Basic, meta-languages which themselves specify programs, and all first, second, third, fourth, and fifth generation computer languages. Also included are database and other data schemas, and any other meta-languages. For the purposes of this definition, no distinction is made between languages which are interpreted, compiled, or use both compiled and interpreted approaches. For the purposes of this definition, no distinction is made between compiled and source versions of a program. Thus reference to a program, where the programming language could exist in more than one state (such as source, compiled, object, or linked) is a reference to any and all states. The definition also encompasses the actual instructions and the intent of those instructions.

“Schema” is a set of statements in a schema notation such as DTDs, XDR etc which defines the allowed elements, attributes and content model links in an XML-based language.

“Schema Notation”: a given schema notation is a notation which defines how schemas compatible with that notation must be written. Schema notations include DTDs, XDRs, and XML Schema. Many schemas can be written in any one schema notation.

“XPath” is the W3C recommendation for a standard specification of navigational paths in an XML document.

“XMuLator” is a software embodiment of this invention.

### BRIEF DESCRIPTION OF THE FIGURES

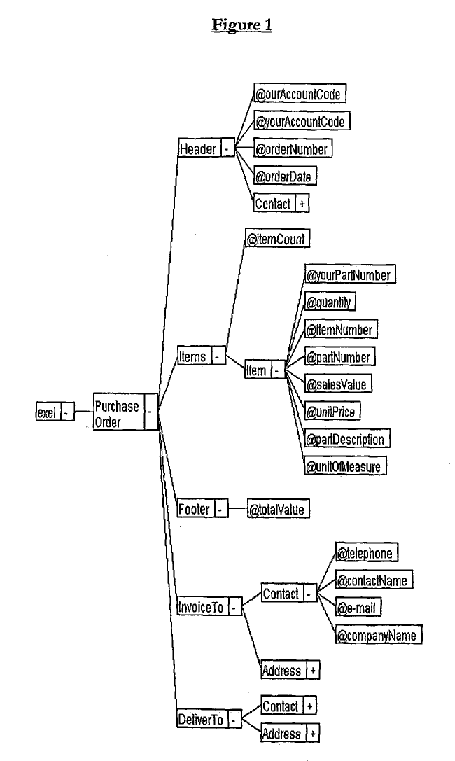

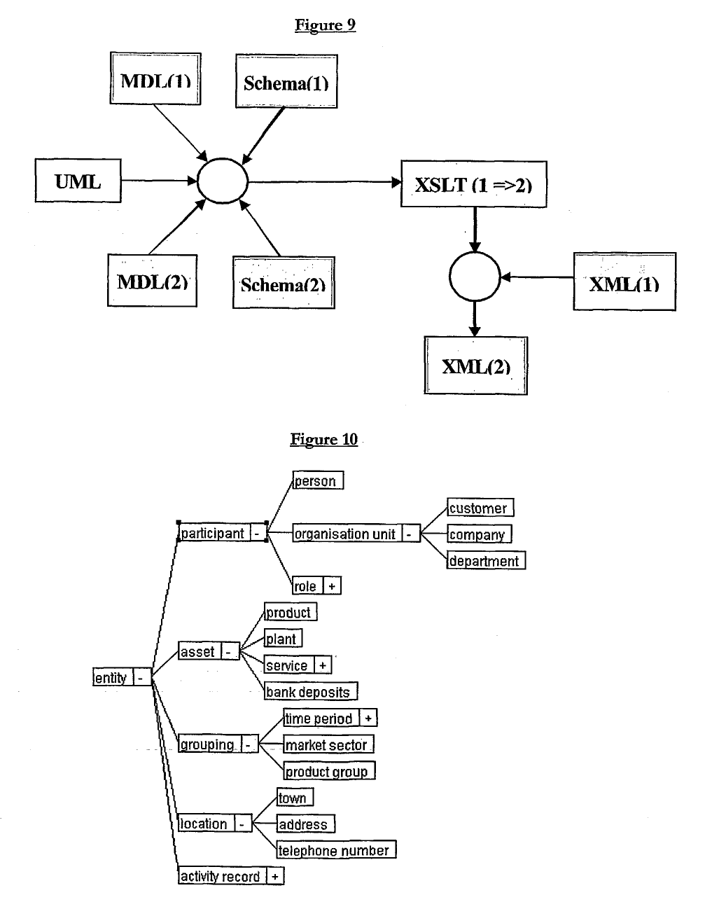

The invention will be described with reference to the accompanying Figures in which FIGS. 1-9 illustrate concepts relating to Meaning Definition Language and FIGS. 10-82 illustrate concepts relating to the XmuLator implementation of the present invention.

### DETAILED DESCRIPTION

Meaning Definition Language—MDL

XML is designed to make meanings explicit in the structure of XML languages. However, when we build XML applications today, we interface to XML at the level of structure, not meaning. We navigate document structure by interfaces such as DOM, XPath and XQuery. Therefore every developer or user has to re-discover for himself ‘how the structure conveys meaning’ for each XML language he uses. This is wasteful and error-prone. We need to develop tools so that XML developers and users can work at the level of meaning, not structure—with the tools providing the bridge between meaning and structure.

Schema languages such as XML Schema and TREX are about structure of XML documents. UML, RDF Schema, and DAML+OIL are about meaning. None of these notations provide the link between structure and meaning. Meaning Definition Language (MDL) is the bridge between XML structure and meaning—expressed precisely, in XML.

Using MDL, the language designer can write down—once and for all—how the structure of an XML language conveys its meaning. From then on, MDL-based tools allow users and developers to interface to that language at the level of meaning. The tools can automatically convert a meaning-based request into a structure-based provision of the answer. This chapter explains how, by introducing MDL and describing three working applications of MDL:

A Meaning-Level Java API to XML: allowing developers to build applications with Java classes that reflect XML meaning, not structure; then to interface those applications automatically to any XML language which expresses that meaning.

A Meaning-level XML Query Language: allowing users to express queries in terms of meaning, without reference to XML structure; to run the same query against any XML language which expresses that meaning, and to see the answer expressed in meaning-level terms

Automated XML translation, based on meaning: allowing precise, automatic generation of XSLT to translate messages between any two XML languages which express overlapping meanings.

The benefits of the meaning-level approach to XML are far-reaching:

Users and developers can work at the level of meaning—which they understand—rather than grappling with XML structures, where they may poorly understand the language designer's intention or make mistakes in the detail (particularly for large complex languages).

Applications, XML queries and presentations of XML information can be developed once at the meaning level, and then applied to any XML language whose MDL exists, without further changes

So whenever a new XML language comes along—as will frequently happen—all you need do is find (or if need be, write down) the MDL definition of that language. Then all your systems and users, using that MDL, will be immediately adapted to the new language, without any further effort. As XML usage grows and languages proliferate, the cost-savings from this easy adaptation will be huge.

The W3C Semantic Web initiative aims to make web-based information usable by automated agents. Currently, such automated agents are not able to use information from most XML documents, because of the diverse ways in which XML expresses meanings. So the semantic web depends on RDF, which expresses meanings in a more uniform manner than XML. MDL would enable agents on the web to extract information from XML documents, as long as their MDL was known—thus extending the scope of the Semantic Web from the RDF world to the larger world of XML documents on the web.

1. XML—MEANING AND STRUCTURE

In this section we introduce the Meaning Definition Language and show how it provides a precise bridge between XML Structure and XML Meaning—defining how XML structures convey meanings.

Before we build the bridge, we need first to describe the two pillars which MDL spans—Structure and Meaning. Before we do that, we shall introduce a sample problem which has great practical importance. The examples in this chapter will use that sample problem.

1.1 Example—Thirteen Purchase Orders

e-commerce is one of the killer apps which has propelled XML to fame over the past three years. Central to the conduct of much e-commerce is the electronic exchange of purchase orders. So a large number of XML message formats for purchase orders have been developed. Many of these can be found at the main X repositories such as XML.org and Biztalk.org.

The core meaning of a purchase order is fairly simple. A buying organisation sends an order to a selling organisation, committing to buy certain quantities of goods or products. There is one order line for each distinct type of goods, specifying the product and the amount required. The purchase order may also define who authorised or initiated the purchase, whom the goods are to be delivered to, and who will pay. Many other pieces of information may be given in specific purchase orders, but that is the basic framework.

We shall see below how the scope of this ‘core purchase order meaning’ can be defined, and the range of ways in which the core meaning is conveyed in XML. For the moment we note that many different XML languages—certainly many more than thirteen—can be found which convey more or less the same ‘core purchase order’ meaning in different XML structures. We have studied thirteen of them in some detail. Typical of the purchase order formats we have analysed with MDL are:

The BASDA purchase order message format, part of the BASDA eBIS-XML suite of schemas available from the Business & Accounting Software Developer's association (BASDA) at www.basda.org.

The cXML protocol and data formats, used by Ariba in their e-commerce platform.

Purchase order messages generated from an Oracle database by Oracle's XML SQL Utility (XSU); these have a relatively flat structure which mirrors the database structure directly.

The Navision purchase order message format from Navision Software a/s in Denmark, (http://www.navision.com/), a part of the Navision WebShop e-commerce solution.

Purchase order message formats from he Open Applications Group (OAG) in the OAGIS framework for application integration.

Now imagine you are setting up to sell goods by XML-based e-commerce, and your clients tell you what purchase order message formats they use. They are the customers, and you cannot tell them to use your own favorite XML format, so your systems must be able to accept all these formats—and others, as new e-commerce frameworks emerge. That is the test problem used for the examples in this chapter.

1.2 Defining XML Structure

There is a proliferation of ways to define XML structures. In spite of W3C support for XML Schema, the proliferation shows little sign of abating, with other candidates such as TREX and RELAX supported by many. We will have to learn to live with a diversity of schema-defining languages. Despite this diversity, two points remain true:

Schema languages are mainly about structure, not meaning. For all the work that has gone on to define data types in XML Schema and other Schema languages, type is only a small part of meaning. It is of little use to know that some element has type ‘date’ if I do not know what the date relates to, or how it relates to it. Is it the date of a purchase order, or someone's birthday? Is it the date the order was sent, or approved, or received? Data type on its own tells you none of these things.

The most important structure information remains ‘what XML trees are allowed’. AR schema languages basically define allowed nesting structures of elements. Even the elaborate apparatus in XML Schema for deriving complex types by extension or restriction serves only to define what nodes can be nested inside other nodes, and their sequence restrictions.

So the most important tool for understanding XML structure is a tree diagram, showing the possible nesting structure of elements (without repetition of the repeatable elements). A typical tree diagram, for one of the published purchase order formats we have analysed, is shown in FIG. 1.

This XML purchase order structure, from Exel Ltd, is one of the simpler purchase order structures available. It shows most of the core purchase order meaning components in a fairly self-evident way. For instance, the ‘Header’ element contains information about the whole purchase order, such as the order date. Each order line is represented by an ‘Item’ element which gives the quantity, unit price and so on of the order line.

Attribute nodes are marked with ‘@’. The number of distinct nodes in this tree diagram (with repeatable nodes not repeated) is 55. Not all of these are shown in the diagram; the ‘+’ boxes show where sub-trees for ‘Address’ and ‘Contact’ have not been expanded in the diagram.

Other purchase order message formats can be much more complex—having hundreds or even thousands of distinct nodes, even without repeating any repeatable nodes. To fully understand even a few of these formats is a non-trivial exercise.

1.3 Defining What XML Documents Mean

A minimal model of XML meanings assumes that any XML document can express meanings of three kinds:

About Objects in Classes: information of the form “there is a product” or “there are three purchase order lines”

About the Simple Properties of the Objects: “the product type is ‘video camera’” or “the product price is $31.50”.

About Associations between the Objects: “the goods recipient has this address” or “this manufacturer made that product”.

Associations are often referred to as ‘relations’, but we will use the UML term ‘association’ everywhere for uniformity. It is hard to see how much meaning can be expressed at all without using all three of the core meaning types. Inspection of any data-centric XML document shows that it expresses meanings of all three types: about objects, simple properties and associations.

These three concepts are the building blocks of UML class diagrams. They have a successful track record of application in modelling of information and knowledge—for, instance, in Entity-Relation Diagrams and AI frames.

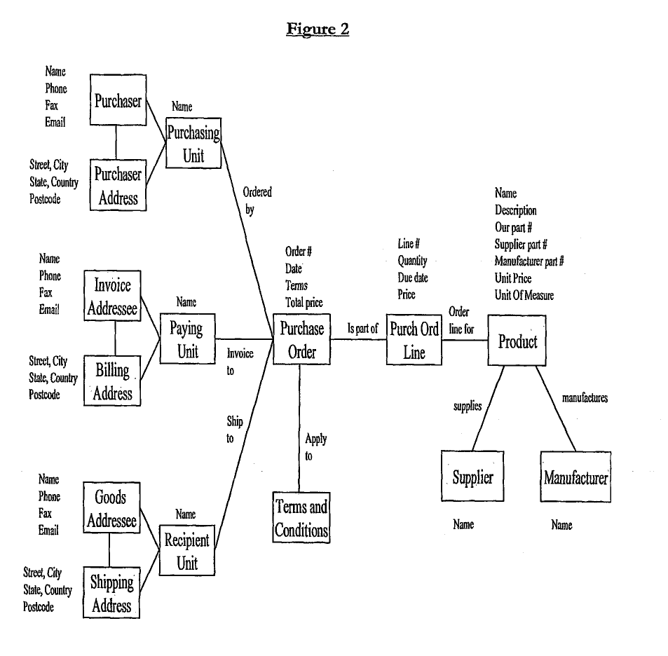

We can draw a class diagram (see FIG. 2) showing the core object classes, properties and associations expressed by typical purchase order messages.

Here, classes of object are denoted by boxes, and associations by lines. Simple properties are denoted by words next to the boxes. To summarise a central part of the diagram in words: “Several purchase order lines can be part of a purchase order. Each order line has a line number and a quantity, and is an order line for a product”.

Most XML purchase order message formats convey a large part (if not all) of the information on this diagram—while some convey extra information not on the diagram. For instance, you can easily spot the equivalences between some of the properties of this diagram with nodes of the Exel XML purchase order message shown above.

As this is a UML class model, it can be expressed in any notation for class models. One notation is XMI, an XML language designed for interchange of metadata, for instance between CASE tools. However, XMI is a highly generic language designed to support many types of metadata, and in practice is rather verbose.

RDF Schema, proposed as a foundation for defining the meanings of web resources in RDF, embodies the same three concepts of classes, properties and associations Cm RDF and RDF Schema, the term ‘property’ encompasses both what we here call ‘simple properties’ and ‘associations’). XML encodings of RDF Schema are more concise than XMI, and more readable. The ontology formalism DAML+OIL is a modest extension of RDF Schema, which retains its readability while adding a few extra useful concepts, and has a well-defined semantics. We use DAML+OIL (March 2001 version) as our preferred way to encode in XML the model of classes, associations and properties needed to define the meanings of XML documents, for use in association with MDL.

A fragment of DAML+OIL describing the purchase order class model in the diagram has the form:

<daml:Class rdf:ID = “purchaseOrder”>

<rdfs:label>purchaseOrder</rdfs:label>
<rdfs:comment>document committing one organisation to purchase
goods from

another</rdfs:comment>

<rdfs:subClassOf ID = “purchaseOrderPart” />

</daml:Class>
<daml:Class rdf:ID = “orderItem”>
<rdfs:label>orderItem</rdfs:label>

<rdfs:comment>one line of a purchase order, specifying a quantity of
one

item</rdfs:comment>

<rdfs:subClassOf ID = “purchaseOrderPart” />

</daml:Class>
<daml:ObjectProperty ID = “[orderItem]isPartOf[purchaseOrder]”>

<rdfs:label>isPartOf</rdfs:label>
<rdfs:domain rdf:resource = “#orderItem”/>
<rdfs:range rdf:resource = “#purchaseOrder”/>

</ daml:ObjectProperty >
<daml:DatatypeProperty ID = “orderItem:quantity”>

<rdfs:label>quantity</rdfs:label>
<rdfs:domain rdf:resource = “#orderItem”/>
<rdfs:range rdf:resource =

“http://www/w3.org/2000/10/XMLSchema#nonNegativeInteger”/>
</daml:DatatypeProperty>

Note the use of three different namespaces—with prefixes ‘daml:’ ‘rdf:’ and ‘rdfs:’—because DAML+OIL is an extension of RDF Schema incorporating concepts from RDF and RDF Schema. The daml:Class elements define a class inheritance hierarchy in a fairly straightforward way; properties and associations are inherited down this taxonomy. daml:DatatypeProperty elements define simple properties of objects in classes. The resource name (ID) of these properties must be unique across the model, but property labels such as ‘quantity’ may occur several times in different classes, with different meanings for the properties. The XML Schema data type of any simple property is defined. daml:Object Property elements define associations, using rdfs:domain and rdfs:range elements to identify the two classes involved in each association.

A class model, as expressed in DAML+OIL or XMI, generally defines a space of possible meanings, and its coverage is made wide enough to encompass a set of XML languages. Any one XML language typically only expresses a subset of the possible objects, associations and properties in the class model.

That is the apparatus we use to define what meaning an XML language conveys; next we consider how it conveys that meaning.

1.4 MDL—Defining how XML Expresses Meaning

There follows an outline description of MDL—intended to give enough of the flavour of MDL to understand the sample applications which follow. This outline does not cover all aspects of MDL—for that, see the full description at http://www.charteris.com/mdl.

If an XML language expresses meanings in a UML (or DAML+OIL) class model, then an MDL file can define how the XML expresses that meaning. The MDL defines how the XML represents every object, simple property or association which it represents.

Generally, particular nodes in the XML structure express particular types of meaning; for instance each element with some tag name may represent an object of some class, or each XML attribute may represent some property of an object. However, there is more to it than that.

To define how an XML language represents information, you need to define not only what nodes carry the information, but also the paths to get to those nodes. The best way to define such paths is to use the W3C-recommended XPath language. For instance, you need to define what XPaths to follow to get from a node representing an object to the nodes representing all of its properties. This leads to the core principle of MDL: For every type of meaning expressed by an XML language, MDL defines which nodes carry the information, and what XPaths are needed to get to those nodes.

MDL is designed to be the simplest possible way to define this node and path information in XML. It turns out that the nodes and paths you need to define how XML represents information follow a simple 1-2-3-Node Rule:

To define how XML represents objects of some class, you need to specify one node type and the path to it from the root node

To define how XML represents a simple property of objects of some class, you need to specify two node types and a path between them.

To define how XML represents some association between classes, you need to specify three node types and some of the paths between them

We shall see how this works out in the examples which follow.

1.4.1 Structure of MDL

The primary form of an MDL document is a schema adjunct. Schema Adjuncts are a recent proposal for a simple XML file to contain metadata about documents in any XML language, which goes beyond the metadata expressed in to typical schema languages (in any way thought useful by the person defining the adjunct) and may be useful when processing documents. Schema Adjuncts have a wide range of potential uses.

An MDL document is an adjunct to a schema (e.g. an XML Schema) which defines the structure of a class of documents. The MDL defines the meanings of the same class of documents. An MDL document has a form such as:

<schema-adjunct target=http://www.myco.com/myschema.xsd
xmlns:me=”http://www.myCo/dmodel.daml” >
<document>
...
</document>
<element context = ‘product’>
...
</element>
<element context = ‘product/manufacturer’>
...
</element>
<attribute context = ‘product/@price’>
...
</attribute>
</schema-adjunct>

The attribute ‘target’ of the top schema-adjunct element is URL of the schema of the XML language which this MDL describes, when there is a unique schema. (he case of XML languages using elements from several namespaces is not discussed here.) The namespace in the schema-adjunct element (in this example with prefix ‘me’) has a namespace URI for the semantic model (e.g. in DAML+OIL) which this meaning description is referenced to. This could be an RDDL URI, enabling access to the DAML+OIL model. Thus the top schema-adjunct element gives the means for an MDL processor to access both the schema and the semantic model, and to check the MDL against each of them individually or together.

The <document> element is not discussed further here. <element> and <attribute> elements each define what meaning is carried by various elements and attributes in the XML language. For each <element> element, its ‘context’ attribute defines the XPath needed to get from the root of the document to the element in question (and similarly for attributes). The contents of the <element> element define what meaning that element carries (and similarly for attributes). The ways in which they do this are illustrated by the examples below.

1.4.2 How XML Encodes Objects

Objects are almost always denoted by XML elements. There is typically a 1:1 correspondence between element instances and objects in a class. Therefore the MDL for an element may typically say ‘all elements of this tag name, reached by this path, represent objects of that class’. A typical piece of MDL to do this:

<element context=“/NavisionPO”>

<me:object class=“purchaseOrder”/>

</element>

This simply says “every element reached from the document root by the XPath ‘/NavisionPO’ represents one object of class ‘purchaseOrder’.”

Thus in accordance with the 1-2-3 Node Rule, the MDL to define how XML represents an object defines one node type, and the path to it from the document root. This is shown in FIG. 3 below.

There are cases where one element simultaneously represents two or more object of different classes. In that case, in the MDL there may be several ‘me:object’ elements nested inside the same ‘element’ element.

MDL may provide two further pieces of information about how elements represent objects, which we mention but do not describe in detail here:

An element may represent object of a class only conditionally—only when certain other, conditions (in the XML document) apply. MDL lets you define what those conditions are—i.e. just which elements represent objects.

When an XML document represents objects of a class, it will usually not represent all objects of the class, but only those objects which satisfy certain inclusion conditions (in the semantic model). MDL lets you define what the inclusion conditions are—i.e. which objects within the class are represented in the document.

1.4.3 How XML Encodes Simple Properties

Simple properties are nearly always represented in XML in one of two ways:

Either a simple property is represented by an attribute (i.e. the value of the attribute represents the value of the simple property)

Or the value of a simple property is represented by the text value of an element.

In either case, you need to tie together the property with the object of which it is a property—the object instance which owns the property instance. This is done in MDL by defining the XPath to get from a node representing an object to the node representing its property.

A typical piece of MDL which defines how XML represents a property is:

<element context=“/NavisionPO/Line/Unit_of_Measure”>

<me:property class=“product”

property=“unitOfMeasure”>

<me:find fromPath=“Unit_of_Measure”/>

</me:property>

</element>

The ‘me:property’ element defines what property the element represents; it defines the property name (‘unitOfMeasure’) and the class (‘product’) of which it is a property.

In this case, the MDL for objects of class ‘product’ is:

<element context=“/NavisionPO/Line”>

<me:object class=“product”>

</element>

Therefore each ‘Line’ element represents a product, and each ‘Unit_of_Measure’ element represents the ‘unitOfMeasure’ property of the product—as defined by the ‘me:property’ element in the MDL. The ‘fromPath’ attribute states that to get from an element representing a ‘product’ object to the element representing its unit of measure, you have to follow the XPath “Unit_of_measure”—that is, find the immediate child element with that name.

The ‘fromPath’ attribute serves the important purpose of tying up each object instance with the actual properties of that object instance. Without it, an XML document might represent many objects, and many property values, but you might not be able to link them together correctly. XPath is the general way to define the linkages.

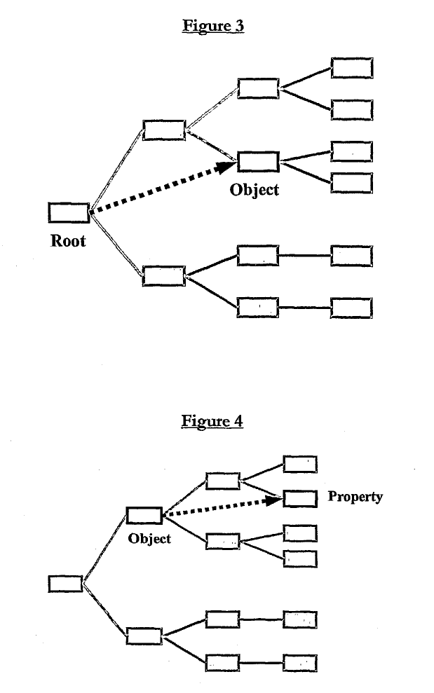

Again in accordance with the 1-2-3 Node Rule, the MDL to define how XML represents some property depends on two node types (nodes representing objects, and nodes representing the property) and the XPath between them. This is shown in FIG. 4.

MDL can describe other aspects of how XML represents properties, which we will merely mention here but not describe in detail:

It may be that not all elements of given tag name, reached by a given XPath, represent a property; sometimes certain other conditions may need to be satisfied. MDL lets you define what these conditions are.

The XML may represent the value of a property in a particular format, which may need conversion to a ‘central’format defined in the semantic model. MDL lets you define formast conversion methods, e.g. in Java or XSLT.

1.4.4 How XML Encodes Associations

As described above, the ways in which XML languages represent objects and properties are generally straightforward, and present few problems. However, the representation of associations (aka relations) in XML is more complex, and requires careful consideration.

XML can represent associations in three main ways, which at first sight look very different from one another:

By nesting of elements: e.g. when ‘orderLine’ elements are nested inside a ‘purchaseOrder’ element, this means that all the order line objects are part of the purchase order—representing the association [order line ‘is part of’ purchase order]by element nesting.

By overloading of elements: e.g where the same ‘line’ element represents an order line, the product which the order line is for, and the association [order line ‘is for’ product].

By shared values: where elements representing the two associated objects are remote from one another in the XML, but their association is indicated by the fact that they share common values of some elements or attributes.

Each one of these three methods occurs commonly in practice, and cannot be neglected. Fortunately, the three methods all share some common underlying principles, which means that the same XPath-based form of description can be used to define all of them. We can define a common three-node model of representing associations, which covers all these cases.

In any XML representation of an association [E]A[F] between objects of class E and class F, nodes of some type denote instances of the association. We call these association nodes. Therefore each instance of an association in a document involves just three nodes—the two elements representing the objects at either end of the association instance, and the association node itself. To define how XML represents the association, we need to define how to tie together the three nodes of each instance of the association. If we can tie together these three nodes, we have in so doing tied together the two object-representing nodes—and can thus find out which object instances are linked in an association instance. That is all the information carried in an association, so it defines fully how XML represents the association.

In many cases, the three-node model will be ‘degenerate’ in that two or more of the three nodes will be identical; a two-node model, or even a one-node model, would have been adequate. Nevertheless, the three-node model is adequate for all cases; the fact the it is more than adequate for some cases does not matter.

MDL defines how the three nodes are linked using XPath expressions, and supplementary conditions which the nodes must satisfy (these are necessary to describe the ‘shared value’ representation of associations). MDL provides the means to define the XPaths both from the object-representing elements to the association node, and in the reverse direction. When extracting association information from a document, paths in either direction may be needed—either to go from E=>A=>F, or to go in the reverse direction.

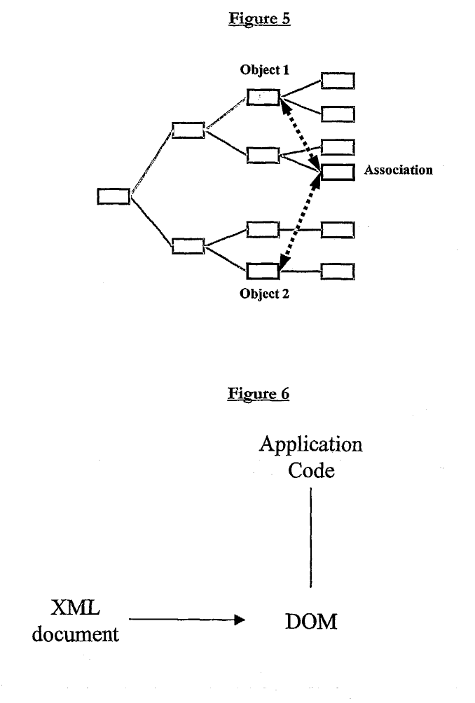

The three-node model of associations is shown in FIG. 5.

In cases where the three-node model is an overkill, and two or more of the nodes of any association instance are identical, then the XPaths between the identical nodes are just the trivial ‘.’ path which means ‘stay where you are’.

Therefore the full MDL definition of an association has a path from the root to define the set of association nodes, and it has relative paths between the association nodes and the elements representing objects at the two ends of the association. For instance, when an association is represented by element nesting, the MDL is of a form such as:

<element context=“/NavisionPO/Ship_to/Ship_to_Contact”>

<me:object class=“goodsAddressee”/>
<me:association assocName=“worksFor”>

<me:object1 class=“goodsAddressee”

fromPath=“.”
toPath=“.”/>

<me:object2 class=“recipientUnit”

fromPath=“Ship_to_Contact”
toPath=“parent::Ship_to”/>

</me:association>

</element>

The ‘me:object’ element says that elements of tag name ‘Ship_to_Contact’ represent objects of class ‘goodsAddressee’.

The ‘me:association’ element says that the same elements also represent the association [goodsAddressee]worksFor[recipientUnit]. So in this case, the association node is the same as one of the object-representing nodes (i.e. the one representing the goods addressee). The fromPath and toPath attributes of the me:object1 are both trivial ‘stay here’ paths; they mean ‘to get from the association node to the goodsaddressee node, or back again, just stay where you are’.

The me:object2 element defines how to get from the association node to the ‘recipientUnit’ node, or back again. In this case it is clear that recipient units are represented by ‘Ship_to’ elements, which ate parent nodes to the ‘Ship_to_Contact’ nodes. So the toPath attribute says ‘go to your parent node’ and the fromPath attribute says ‘go to your Ship_to_Contact child node’.

All this says that the association [goodsAddressee]worksFor[recipientUnit] is represented by element nesting. But because it does so by using general XPath expressions, which can also be used for any other representation of an association, the association information can be extracted by general XPath-following mechanisms.

Again in accordance with the 1-2-3 Node rule, the MDL to define how XML represents some association depends on three node types (two for the objects linked by the association, and one for the association node) and some XPaths between them.

1.4.5 A Simplification—Shortest Paths

MDL requires you to specify XPaths for both simple properties and associations—to define how you get from a node representing an object to the nodes representing its properties and associations.

Specifying all of these paths might be a lot of work, unless you had an automatic tool to help you do it. Fortunately, in the vast majority of cases, the required path—for instance the path from a node representing an object to a node representing one of its simple properties—obeys a ‘shortest path’ heuristic; it is the shortest possible path from the one node to the other. Similarly, nearly all paths from object-representing nodes to their association nodes are shortest paths.

We can therefore simplify the language by defining that the default XPath is always the simplest path; you only need to define the XPath explicitly when it is some different path. This means that the great majority of XPaths need not be provided explicitly, but can be simply computed by MDL-based tools.

In the examples we have always used full-form MDL; but in practice the language can be written more tersely without most of the paths.

1.4.6 How to Use MDL

In summary, MDL defines ‘how information is encoded in XML’ in a rather uniform manner for the three main types of information, about objects, properties and associations. For each type of information, the MDL says ‘to extract the information from an XML document, follow these XPaths’.

MDL-based tools are given a definition at the level of meaning—in the semantic model—of what is required, and then they use the information in the MDL to convert this automatically to a structural description of how to navigate (or construct) the XML to do this.

To do so, builders of MDL-based tools need to solve two problems—the input problem and the output problem.

The Input Problem is to extract the information from an ‘incoming’ XML document and view that information directly in terms of the classes, simple properties and associations of the semantic model. From the nature of MDL, this problem is fairly simple to solve. MDL defines the XPaths you need to follow in order to extract from a document a given object, or any of its simple properties, or any of its associations. So to find the value of any simple property or association of some object, you simply need to follow the relevant XPaths in the document, as defined in the MDL. This is easily done if you have an implementation of XPath, such as Apache Xalan.

The Output Problem is to ‘package’ the information in an instance of the semantic model into an ‘outgoing’ XML document which conveys that information. It is not quite so obvious how to do this from the definition of MDL, but in fact it is fairly straightforward. You need to construct the document from its root ‘downwards’. Generally you will come to nodes representing objects before you come to nodes representing their properties and associations. As you come to each node type, you check in the MDL what type of information the node type represents (e.g. what class of object, or what property), and you check what instances of that type of information exist in the semantic model instance. You then construct node instances to reflect these information model instances.

We will illustrate this by describing three MDL-based tools which allow users and developers to view XML at the level of its meaning. The first and second of these—a Java API to XML, and a meaning-level query language—only require a solution to the input problem; while the third (automated XML translation) requires a solution of both the input problem and the output problem.

2. Meaning-Level API to XML

When we write applications to use XML in a language such as Java, we generally interface between the application and the XML via some standardised API, such as the W3C-recommended Domain Object Model (DOM). Several XML parsers provide high-quality implementations of the DOM API, and many XML applications are built on top of them.

The way this works, for a read-only application which consumes XML but does not create it, is shown in FIG. 6.

Here, the XML document is read in by the parser, which makes available the DOM interface to the resulting document tree, for use by the application code.

However, the DOM interfaces are defined entirely in terms of document structure—giving facilities to construct and navigate the document tree in memory. Therefore interfacing to XML via DOM has two drawbacks:

Developers are interested in getting the meaning out of an XML document (or putting it in). To do this via DOM, they need to understand the XML document structure, and how it conveys meanings, quite precisely. For large and complex XML languages, this is costly and error-prone.

Applications need to be written with one document structure in mind, ‘hard-wiring’ that document structure into the code. If the application is to be re-used with another XML language which conveys the same meanings, that application needs to be rewritten.

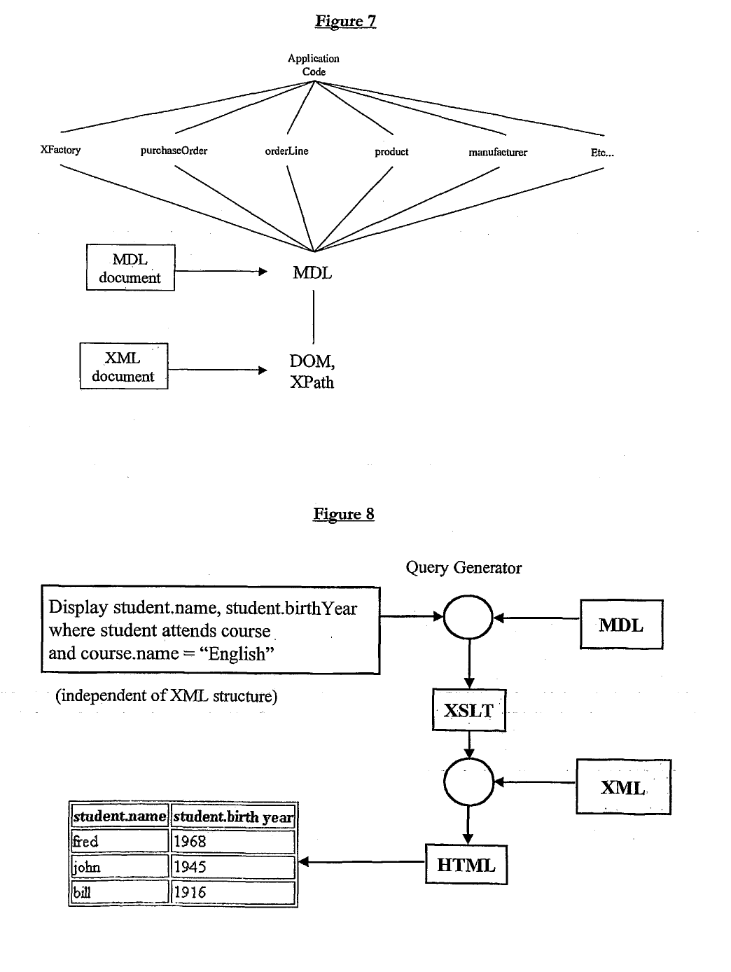

Using MDL, we can write applications which interface to the XML at the level of its meaning, not its structure—and so avoid the two drawbacks above. The way this works (again for a read-only application which consumes XML but does not create it) is shown in FIG. 7.

The components of this diagram will first be outlined before discussing some of them in more detail:

The Application Code is written by the developer in Java to accomplish whatever the application is about. This code uses the classes immediately below it in the diagram—classes which reflect only the semantic model of the domain, and are independent of XML structure.

The classes purchaseOrder, orderLine, product, manufacturer and so on are the classes of the UML (or DAML+OIL) semantic model. Each instance represents one purchase order, order line, and so on—the objects of the semantic model which supports the application. The available object instances are precisely the object instances represented in the input XML. Their instance methods return the values of an object's properties, or sets of other objects linked to that object by the associations of the semantic model.

The class ‘Xfactory’ is a factory class which can return all the purchaseOrder objects, or all the orderLine objects, or all objects of any class represented in the XML.

The class ‘MDL’ reads in the MDL file for a particular XML language and stores all its information in internal form. It then makes available methods used by the classes of the semantic model, and by the factory class, to return values which reflect information in the XML document.

The XPath and DOM APIs are an implementation of these W3C standard interfaces—for instance, as provided by the Apache Xalan Xpath/XSLT implementation with the Apache Xerces XML parser.

A typical sample of application code, using the purchase order XML languages described earlier, looks like:

// compute the total quantity of all items in a PO
int totQuant(Node root, MDL mdl)

{

int total = 0;
Xfactory xf = new XFactory(root,mdl);
Vector oLines = xf.everyOrderLine( );
if (oLines != null)

for (int i = 0; i < oLines.size( ); i++)

{

orderLine ord =

(orderLine) oLines.elementAt(i);

total = total + ord.quantity( );

}

return total;

}

This calculates the total number of items, summed over all order lines for a purchase order—possibly not a very useful number, but sufficient to illustrate the approach. Compared with typical DOM-based XML applications, there are two remarkable things about this piece of code:

It is simple to write and understand—compared for instance to code which uses the DOM

It is completely independent of XML structure—so it will run unchanged with any XML purchase order message format, provided that XML's MDL definition is available.

The MDL instance mdl has previously been initialised and has an internal representation of the MDL file. First the method above creates an XFactory instance, and uses that instance to create a Vector oLines of all orderLine objects represented in the XML message. It then inspects the individual orderLine objects, and for each one adds its quantity to the total. All the work of navigating the XML document to find this information is done by the supporting classes.

The next layer of classes in the diagram above (XFactory and all the domain classes such as purchaseOrder) are all generated automatically from the DAML+OIL definition of the semantic model.

The class XFactory has one method for each class in the semantic model—to return a vector of all the objects of the class represented in the XML document The generated code for one of these methods looks like:

/* return a Vector of all orderLine objects represented in the XML
document;
or null if the language does
not represent orderLines. */

public Vector everyOrderLine( )
{

int i;
Vector res = null;
NodeList nl =

mdl.getAllObjectNodes(“orderLine”, root);

if (nl != null) {

```
res = new Vector( );
for (i = 0; i < nl.getLength( ); i++)
  {res.addElement
  (new orderLine(nl.item(i),mdl));}
```

}
return res;

}

As can be seen, this code can be generated just by substituting the class name at several places in a standard template.

The source code for each class of the semantic model is also generated automatically. A typical generated class has source code:

import org.w3c.dom.*;
import java.util.*;
public class orderLine
{

private Node objectNode;
private MDL mdl;
public orderLine(Node n, MDL m)

{objectNode = n; mdl = m;}

// String value of ‘quantity’ property
public String quantity( )
{return mdl.getPropertyValue

(“orderLine”,“quantity”,objectNode);}

/* single purchaseOrder object related by

[orderLine]isPartOf[purchaseOrder] */

public purchaseOrder isPartOf_purchaseOrder( )
{
purchaseOrder res = null;
Node nl = mdl.getRelatedObjectNodes

(“orderLine”,“isPartOf”,“purchaseOrder”,
objectNode,1);

if (nl != null)

{res = new purchaseOrder(n.item(0),mdl);}

return res;

For reasons of space, only one or two of the property and association methods are shown. Typically a class has many properties and associations, each with its own method.

Note that the generated code depends on the semantic model, but not at all on the XML structure or MDL. The same generated code can be used unchanged with many different XML languages.

These classes use lazy evaluation of their properties and associations. When an instance is created, its only internal state consists of the node in the XML document which represents the object. Whenever the value of a property or association is required, the value is computed by calling the MDL class instance, which navigates the XML to retrieve the values. It would of course be possible to cache values in each instance, so that repeated evaluation did not cause repeated traversal of the DOM tree, but this has not yet been done.

Again, you can see that this source code is generated quite simply by substituting various class names, property names and association names in standard code templates.

All the semantic-level generated classes rely on the class MDL to get information from the XML document. It is here that the real work is done, but it is not difficult work The MDL class reads in the MDL file, stores it in an internal form, and then makes available three core methods used by the generated classes. The three core methods retrieve objects, properties and associations from the XML document

getAllObjectNodes(String className, Node root) is given the root node of the XML document and returns a NodeList of all nodes in the document which represent objects of class ‘className’

getPropertyValue(String className, String propertyName, Node objectNode) is given the node object Node which represents an object, and returns (as a string) the value of one of its properties, as represented in the XML.

getRelatedObjectNodes(String class1, String relation, String class2, Node obj12, int oneOrTwo) is given the node representing one of the objects in an association, and returns a NodeList of nodes representing all the objects of some class related to the first object by some association. OneOrTwo is 1 or 2 depending on whether the input object is of class1 or class2—on the left-hand side or the right-hand side of the relation name.

The code of the MDL class is completely independent of the application, being driven by the data from the MDL file. The implementation of the three core methods is fairly straightforward, since the class MDL knows all the XPaths to be traversed in the document to retrieve the relevant information. Currently the MDL class makes use of the following XPath interfaces provided by the XPathAPI class of Apache Xalan:

selectNodeList(Node n, String xPath) returns a NodeList of all nodes reachable by following the path xPath from the node n.

selectSingleNode(Node n, String xPath) returns a single node, in cases where you know only a single node can be returned.

These interfaces make the job of the MDL class very simple.

Therefore by using the XPath interface to XML documents, and using a few simple intermediate classes (some generated, and others independent of the application) we are able to insulate the Java application completely from the details of XML document structure. With this interface, developers can work at the level of semantic model classes which they understand. They do not have to learn the intricacies of XML document structure; and their applications will work unchanged with many different AL document formats. For instance, the sample purchase order application fragment works unchanged with any of the 13 different XML purchase order message formats we have analysed with MDL. Applications can even switch dynamically to handle messages in different XML languages at the same time.

Here we have only discussed ‘read-only’ applications which read XML but do not write it. The application of these techniques to read/write applications is a bit more complex, but very feasible.

As XML languages continue to proliferate, we believe that the benefits of this meaning-level style of application development—in quality, development costs and maintenance costs—will be overwhelming. There is no reason not to start doing it now.

3. Meaning-Level XML Query Language

The current state of XML query languages is in a sense similar to the current state of programming APIs to XML. To use an XML query language, such as the current draft W3C recommendation XQuery, you need to understand the structure of the XML document being queried and to navigate around it retrieving the information which interests you.

This has the same drawbacks for query users as the structure-level APIs have for developers. Users need to understand the structure of XML languages—which for large languages may be costly and error-prone—and queries are not transportable across XML languages.

Using MDL, we can build XML query tools which operate at the level of meaning rather than structure. In such a language, the query is expressed in terms independent of XML structure—so users can formulate queries without knowledge of XML language structures, and the same query can be re-used across many XML languages which express the same meaning.

A small demonstrator of a meaning-level XML query language has been constructed, which works as in FIG. 8.

This demonstrator is a batch Java program which accepts as input:

A text file containing the text of the query

The MDL for the language being queried against

The program itself does not answer the query, but generates a piece of XSLT. This XSLT, when used to transform a document in the language, will transform it into a piece of HTML. When the HTML is displayed on a browser it shows the answer to the query against the document—as in the diagram.

The queries which are input to this tool are expressed in a simple language of the form:

Display class.property, class.property . . . where condition and conditi on and . . .

Names of classes and properties are taken from the semantic model. Each condition is either of the form ‘class.property=value’ (possibly using other relations such as ‘contains’, ‘>’) or of the form ‘className association className’. Despite its limited nature, this simple language can express a wide range of useful queries, linking together information about objects of several related classes. Most important, it expresses these queries entirely in terms of the semantic model, and independent of XML structure.

Typical queries in this language are:

Display orderLine.quantity, product.name where orderLine is PartOf purchaseOrder and orderLine isFor product.

Display address.city, address.zip where purchasingUnit hasAddress address.

The demonstration program parses and validates queries of this form, and devises a query strategy. This strategy defines the order of classes involved in visiting and filtering the objects of the classes mentioned in the query, using the query conditions to filter objects. The query strategy is then embodied in XSLT, using the MDL to convert semantic level conditions into XPaths to navigate the document.

The XSLT is then run on a standard XSLT processor, producing the output HTML file.

This is probably not the way you would want to run XML queries for everyday use, but it does demonstrate the capability. Alternative implementations could support interactive input of queries and display of results—probably using an XPath implementation directly to navigate the document, rather than generating XSLT containing XPath expressions.

In summary, this style of meaning-level query language has two key benefits over other existing XML query languages:

Users can write queries without knowing the structure of XML documents

The same query can be freely re-used across documents in several different

XML languages, provided their MDL is known.

4. Automated XML Translation

A core application of XSLT is to translate documents from one XML language to another. It is implicit, although rarely stated, that the intention of such translations is to preserve the meaning in the documents. Therefore we would expect a Meaning Definition Language to be very relevant to XML translation.

It is only possible to translate documents between XML languages if their meanings overlap. If one language is about cookery and another about astronomy, we could not translate at all from one to the other. At the simplest level, we can test the overlap in meaning between two languages by comparing their MDL. We can test which components of meaning (which classes, properties and associations) are represented in both languages. It is only these ‘overlap’ components or meaning that can be translated. So the MDL overlap acts as a specification of the translation.

However, we can do much more than this. Since MDL defines not only what information is expressed by each XML language, but also how it is expressed, the MDL can tell us how to extract each component of meaning from the input document, and how to package it in the output document. Therefore the MDL for the two languages (together with their structure definitions) is sufficient to create automatically the complete XSLT translation from one to the other. Charteris have developed a translation tool, XMuLator, which does just this. The way this operates is shown in FIG. 9.

The XMuLator translator generator is represented by the shaded circle. It takes as input:

The UML (or DAML+OIL) semantic model of classes, properties and associations

The structure definition (XML Schema or XDR) for the input language—here denoted as language (1)

The MDL definition for the input language

The structure definition for the output language—here called language (2)

The MDL definition of the output language

As output it generates a complete XSLT translation between the two languages. This can be used by any standards-conformant XSLT processor (such as XT, Saxon or Xalan) to translate documents from language 1 to language 2.

We have used XMuLator to generate and test all 13*12 translations between the thirteen purchase order message formats described above. We have verified that the output documents have the required structure for their lanaguages, and correctly represent all the information that can in principle be conveyed in the translation—i.e all the information conveyed by both the languages involved in a translation.

We have also carried out a stringent ‘round trip’ test of the translations. In this, we verify that when a document is translated through some cycle of languages (such as A=>B=>A or A=>B=>C=>D=>A) the output document is a strict subset of the input document—so that any information which survives the round trip survives it undistorted. In general, not all the information in the input document will survive a round trip, because the languages do not overlap perfectly in the information they convey.

Amongst the 13 different purchase order languages we have translated are some deeply nested languages, and some very shallow languages, such as those resulting from the use of the Oracle XML SQL Utility (XSU). Therefore the translations have involved major structural changes to the XML—not just a few changes in tag names. These major structural transformations have all passed the stringent round trip test.

There are currently two alternatives to this meaning-based generation of XSLT translations. The first is to write XSLT by hand, and the second is to generate translations by some XML to-XML mapping tool such as Microsoft's BizTalk Mapper. The meaning-based approach has major advantages over both of these.

Compared with the meaning-driven approach, writing and debugging of XSLT is much more expensive and error-prone. Even to write one XSLT translation is, we believe, more costly than to write down the MDL for the two languages involved. The XSLT is generally a much larger and more complex document than the two MDL files; and in many cases you will already have the MDL files available.

However, it is when there are several different languages that the advantages of the MDL approach become overwhelming. With N different languages, you may require as many as N*(N−1) distinct translations between them. Using MDL, the cost of creating all these translations grows only as N (this is the cost of writing all the MDL files). This can rapidly amount to a huge cost difference—especially as each different language may go through a series of versions.

We believe that in practice the MDL-based approach is much more reliable than hand-writing of XSLT. Using MDL-based translation, as long as the meaning of each language has been captured accurately, then the translation will be accurate—accurate enough to pass the stringent round-trip tests. For complex languages, debugging XSLT to that level of accuracy would be very time-consuming.

XML mapping tools such as Biztalk Mapper display two tree diagrams side by side, showing the element nesting structures of two XML languages. The user can then drag-and-drop from one tree to the other, to define ‘mappings’ between the two languages, and these mappings are used to generate an XSLT translation between them. However, this simple node-to-node mapping technique does not capture all the ways in which the two XML languages may represent associations; therefore it is not capable of translating association information correctly. For instance, if one language represents an association by shared values, while the other represents the same association by element nesting, tools like BizTalk Mapper cannot do faithful translations in both directions. Since association information is a vital part of XML content, and XML languages represent associations in a wide variety of ways, this means that XML-to-XML mapping tools will fail for many important translation tasks. Furthermore, since these tools require mappings to be defined afresh for each pair of languages, the cost of creating all possible translations between N languages grows as N*(N−1), rather than N.

Therefore the meaning-based automatic translation method, which is enabled by MDL, has major advantages over other available methods of XML translation.

5. MDL and the Semantic Web

The vision of the Semantic Web is that the information content of web resources should be described in machine-usable terms, so that automatic agents can do useful tasks of finding information, logical inference and negotiating transactions. Therefore work on the Semantic Web has emphasised tools for describing meanings such as RDF Schema and DAML+OIL.

The Resource Description Framework (RDF) was designed to be semantically transparent—so that an automated agent can extract and use information from any RDF document, provided the agent has knowledge of the RDF Schemas used by the RDF. For RDF documents, therefore, access by automated agents is a realisable goal.

However, RDF is designed primarily to represent metadata—information about information resources on the web. This is how RDF tends to be used, so the semantic transparency and automated processing extends only to metadata in RDF. It is widely recognised (e.g Berners-Lee 1999) that XML itself does not have this semantic transparency—precisely because XML can represent meaning in many different ways.

Therefore as it stands, automated agents cannot access the information in (non-RDF) XML documents. They cannot step outside the RDF world to access the information in the bulk of XML documents on the web. This severely limits the ability of automated agents to access the information they need.

MDL can remove the restriction. If the authors of an XML language define its meaning in MDL, then (as described in previous sections) an automated software agent can access the information in any document in the language—greatly extending the power of automated agents.

We can illustrate this by a typical usage scenario for the Semantic Web. I hear from a friend about some Norwegian ski boots, but do not know the name of the manufacturer. I want to buy them over the web. My software agent finds the leading ontologies (RDF Schema based) used to describe WWW retail sites. From these ontologies it learns that Ski boots are a subclass of footwear and of sports gear; that to buy footwear you need to specify a foot size. It then inspects the RDF descriptions (metadata) of several online catalogues. The catalogues themselves are accessible in XML, whose MDL definitions are all referenced to the same RDF Schema. From the RDF, my agent identifies those catalogues which contain information about the kind of goods I want.

The agent then needs to retrieve information of the form ‘footwear from manufacturer based in Norway who makes sports gear’—applying the same retrieval criteria to several XML-based catalogues, which use different XML languages, and very different representations of the associations [manufacturer]makes[product], [manufacturer]based in[country] and so on. The only automated way to make these retrievals is to know the XPaths needed to retrieve the associations from the different XML languages. The MDL definitions of the languages provide just this information, enabling my software agent to retrieve and compare what it needs from the different catalogues.

Thus the agent uses a two-stage process of (1) access RDF metadata to find out which catalogues are relevant, and (1) using MDL, access the XML catalogues themselves and extract the required information. This two-stage process is much more powerful that the first enabled by RDF on its own.

In summary, realising the Semantic Web will require not only semantics, but also a bridge between semantics and XML structure. MDL provides that bridge.

6. Documentation and validation

There are two other important applications of MDL which we have not described in this section, but will briefly mention:

The MDL for an XML language serves as a precise form of documentation of what the language authors intend it to mean, and how it is intended to convey that meaning. Since the language authors' intentions are not always clear from the schema and associated documentation, this extra documentation can be very useful.

Since MDL forms a bridge between meaning and structure, an MDL file can be validated against the definition of possible meanings (e.g. a DAML+OIL class model), against the definition of XML structure (e.g. an XML Schema), or against both together. This validation forms a very useful check that the XML is capable of conveying the meanings which the language authors intended. We have found that in many cases, the XML structure does not match up precisely with the intended meanings; these validation checks will frequently produce useful warnings.

7. The Meaning-Level Approach to XML

We can summarise the potential impact of MDL as follows: MDL will enable both applications and users to interface to XML at the level of its meaning, rather than its structure.

Using MDL, users and application designers need not be concerned with the details of XML structure—with elements, attributes, nesting structure and paths through a document. They can think purely in terms of the meaning of the document (the objects, properties and associations it represents) and leave it to MDL-based tools to deal with document structure. These tools will automatically navigate the XPaths necessary to extract meaning from structure.

This meaning-level approach to XML has tremendous advantages—allowing users and developers to think at the level of meaning, which they understand; freeing them from the need to understand XML document structures, which may be extremely complex; and allowing us to develop any application once and then adapt it automatically, via MDL, to new XML languages in its domain.

We believe that as XML languages continue to proliferate, the benefits of the meaning-level approach will become overwhelming. In time, all access to XML documents will move to the level of meaning rather than structure. There are many precedents for this move in the history of programming. There is an almost inevitable tendency to move up from structural, implementation-level tools to application-level, meaning-level development tools. The whole progress from assembler languages to high level languages, then to ‘fourth generation’ languages is an example of this trend. Another example comes from databases.

In the 1970s databases were based on a Codasyl navigational model, which exposed a pointer-based database structure to users and application developers. To get at information you had to grapple with database structure, following the pointers. Relational Databases and SQL removed this tight structure dependence of data, enabling us to view data in more structure-independent ways. This was such an advance that it swept the Codasyl database model into history.

In the next few years, we will make similar advances in how we regard XML documents, seeing them in terms of their information content rather than structure. Structure-centred views of XML may become history, just as Codasyl databases are now history. MDL can be the key tool to enable this meaning-level view of XML.

Demonstration programs for the MDL-based meaning-level API to XML, and the meaning-level query language are available (as Java source code and jar files, with sample XML and MDL files) from http://www/charteris.com/mdl.

This detailed description concludes with an Appendix 1, which is the User Guide to an implementation of the present invention known as the XMuLator™. Appendix 1 should be consulted for a detailed discussion of the following points:

Solving the XML Interoperability problem

The Model of business meanings

Building a business information model

Capturing the syntax of XML schemas

Recording how XML represents business information

Generating and using xslt transformations

Building the business process model

Installing and running XMuLator™

Utilities

Appendix A: Sample XSL Transformation

Appendix B: XmuLator Database Schema

Appendix C: Mapping Rules

The remainder of this section of the Detailed Description will focus on the transformation algorithm.

Generating Translations

In this section a preferred embodiment of generating the translations is given. This describes the essence of the algorithm

XMuLator Algorithm Outline

The information input to the transformation generation algorithm consists of three main parts:

1. The business information model, consisting of the definitions of classes of entities, attributes of those entities and the relations of those entities. The information content of these is just what the user inputs. This is stored in a relational database in three main tables—one for classes (including the class hierarchy, defined by storing a superclass in each class record), one for attributes and one for relations. The same information could of course be stored in an object-oriented database or in other forms. Generically, business information classes, attributes and relations will be referred to as “business model objects”. Business model objects are examples of business information model logical structures.

2. The definitions of XML-based languages, consisting of information automatically extracted from their DTDs or XDR files (and in future, XML schemas). Generically, a DTD or XDR or XML schema will be referred to as a “schema”. The schema information is stored in relational form, in three main tables—one for the element types in the schema, one for the attributes and one for the content model links (in a schema, the content model of an element defines how other elements are nested inside it—what element types are allowed, any ordering and occurrence constraints, etc). One content model link is stored for every element type that can be nested immediately inside another element type. The whole of the information in a schema, including the allowed orders of elements in an element, can be reconstructed from what is stored in the three tables. Generically XML element types, attribute types and content model links will be referred to as “XML objects”. XML objects are examples of XML logical structures.

3. The definitions of how each XML-based language represents information in the business information model. One XML object (element, attribute or content model link) can represent one or more business model objects (class, attribute or relation). When it does so, there is said to be a “mapping” from the XML object to the business model object. These mappings are stored in three main tables—one of which defines which business model entities of a given class are represented by which XML objects, one defining which business model attributes are represented by which XML objects, and a third table doing the same for business model relations. These tables contain supplementary information about how the XML object represents the business model object. The complete information content of these tables is defined by the user input

The storage of these objects in relational tables is not a necessary part of the algorithm. In practice all this information is held the main memory of the computer (for instance, as Java objects which are instances of Java classes) for the duration of the calculation which generates the XSLT. In some implementations, these Java objects can be created from information read in from files (typically XML files) rather than from a Relational Database.

Consider a translation between two XML-based languages (sources) called the input and the output source respectively. If an element of type A of the input represents entities of some class X, while some element type B in the output represents entities of a class Y, and Y is a superclass of X, then it may be possible to transform the input elements A into output elements B. This is possible because every X is a Y. But transformation is generally not possible the other way round because a Y may not be an X.

Before starting to generate the XSL, the algorithm constructs a set of quadruples {output element, output class, input class, input element} where the input element represents the input class, the output element represents the output class, and the output class is equal to the input class or is a superclass of the input class.

Content-bearing elements are those elements which represent business model objects. Wrapper elements are those elements which are not content-bearing, but which have to be traversed to get to content-bearing elements. In the output XML, they appear wrapped around the content-bearing elements.

The translation generation algorithm does a traverse of the output tree structure as defined by the output XML schema. The traverse is not a pure recursive descent, but has recursive descent parts (mainly to navigate through wrapper elements). This generates XSL which will create output XML with the output tree structure, obeying the ordering constraints of the output XML schema. As it navigates the output tree, at each stage the algorithm works out which nodes in the input tree (if any) contain the required information. It creates XSL to (a) navigate the input tree from the current input node to find those nodes (using XPath syntax), and (b) extract information from those nodes (e.g. values of attributes) to include in the output XML.

The generated XSL consists of a set of templates. There is one template for the top-level element type of the output XML, and one template for each output element type which represents a business model class. If output element A is nested inside element B, then the template for B contains an xsl:apply-templates node to apply the template for A, generating the instances of A nested inside the instances of B in the output XML. The templates for A and B are both attached to the root element of the XSL document, so the XSL tree is flatter than the XML tree it will create. Other templates are also generated to fill in details of relations and attributes.

A typical template for the top-level element, as generated by the algorithm, is:

<!-- Outermost wrapper node -->
<xsl:template match=“/schools6”>
<schools2>
<xsl:apply-templates select=“course6” mode=“main”/>
</schools2>
</xsl:template>

In this example, all output elements and attributes have names ending in ‘2’, while all input attributes and examples end in ‘6’. The top-level template simply calls templates for all elements which represent entities and which appear at the next-to-top level in the output. Comments are always contained as <!- comment ->(this is standard XML).

The XSL is first generated as a DOM tree, which is then written out as a text file. (DOM=Domain Object Model, a W3C standard for internal program representation of XML. XSL is a form of XML and so can be represented this way). Thus instead of having to write out the two <xsl:template> lines with two <schools2> lines between them, the algorithm has to attach an ‘xsl:template’ node to the root of the XSL document, and then attach a ‘schools2’ node to the ‘xsl:template’ node. Writing out this tree then produces the nested text, as in the example. This is standard practice, supported by DOM-compliant XML parsers.

For simplicity, assume the input has one top-level element type ‘ot’, and the input has one top-level element type ‘it’. With many details left out for clarity, the algorithm to generate the top-level tree is to call topTemplate(ot, it) where: topTemplate(e,g)

{

[attach to root] xsl:template node match = g;
[attach to template] XSL node e (to generate e in the output XML);
for each content model (CM) link in e:
{

f = output element inside the CM link;
if (f is a wrapper element) topTemplate(f,g);
else if (f represents class C)

and (input element h represents C or a subclass D)
{
[attach to template] xsl:apply-templates select = (input path from g to h);

}

}

}

For every output element f which represents a class C, and for which there is an input element h representing C or a subclass D, the algorithm generates a template. A typical one of these entity-representing templates is:

<!-- Entity ‘course’ -->
<xsl:template match=“course6” mode=“main”>
<course2>
<!-- Attribute ‘course:course name’ -->
<xsl:attribute name=“id2”>
<xsl:value-of select=“@name6”/>
</xsl:attribute>
<!-- Relation [student]attends[course] -->
<xsl:apply-templates
select=“parent::schools6/student6[contains(@attends6,current( )/@id)]”
mode=“main”/>
</course2>
</xsl:template>

The XPath to navigate the input tree is the stuff like ‘parent::schools6/student6’. These entity-representing templates are created by calls to classTemplate(f,h):

ClassTemplate(f,h)
{

[attach to root] xsl-template node match = h;

[attach to template] XSL node f;
for each XML attribute ao in f:
{

if (ao represents attribute A) and (input XML object ai represents A):
{

[attach to f] xsl-attribute ao;
[attach to attribute] xsl:value-of select = (input path from h to ai)
}
else if (ao represents relation R) and (input XML object ai
represents R)
{

[attach to f] xsl-attribute ao;
[attach to attribute] xsl:apply-templates select =

(input path from h to ai, with [conditions defining R])

}

}
doContentLinks(f,h);

}
doContentLinks(f,h)
{

(f represents class C; h represents class D)
for each content model link L in f (traversed in schema order)

{

g = output element inside CM link;
if (g is a wrapper) doContentLinks(g,h)
else if (g represents attribute A) and (input XML object ai represents
A):
{

[attach to f] XSL node g;
[attach to g] xsl:value-of select = (input path from h to ai);
}

else if (g represents class E) and (input XML object ai represents
subclass F)

and (L represents relation R between C and E)
and (input object ri represents R between D and F)

{

[attach to f] xsl:apply templates select =

(input path from h to ai with [conditions defining R]);

}
else if (g represents relation R) and (input object ri represents R)
{

[attach to f] XSL node g;

[attach to g] xsl:apply templates

select = (input path from h to ai with [conditions defining R])
mode = ‘relationx’;

[attach to root] xsl:template match = ai, mode = ‘relationx’;
for each (property used to identify the entity at other end
of relation)

{[attach to template] xsl:value-of select(property);}

}

}
}

These descriptions of the algorithm are highly simplified, with many details omitted t concentrate on the main principles.

Variations of the Above Embodiment

In the above embodiment, the algorithm operates in a manner analogous to that of a compiler, and in particular uses the technique known as ‘recursive descent’. The same effect could be achieved by using other compiler techniques, such as table driven or stack based, in which the recursion is ‘unwound’. Other translation approaches are also possible: the next section discuss a direct translation embodiment.

A Direct Translation Embodiment

In this embodiment, rather than outputting a text XSL file which is used by a separate XSL processor, the transformation information is used ‘in situ’ to translate XML on the fly. In many cases this might be a very sensible thing to do anyway. A procedure or algorithm to accomplish this is now described.

1. The XSL is generated as described elsewhere in this patent specification, and stored in memory.

2. read the input XML to form a DOM tree of input XML.

3. create the root of an output XML DOM tree.

4. navigate around the XSL DOM tree (using a standard DOM API, and perhaps using a ‘visitor’ design pattern), and at every node just follow the instructions on that node—to traverse a bit of the input tree, read a value from the input tree, apply a template, create a bit of the output tree, etc., and then

5. output the output DOM tree to a file.

In a typical example of this direct translation embodiment, the translator program reads in XML-based definitions of the mappings onto the business information model for each language. These XML-based definitions include definitions of the XPaths to be navigated in each XML language to extract each kind of information in the business information model. When generating a piece of the output XML, the translator looks up what kind of business information that piece of output XML conveys, looks up the XPaths in the input XML needed to extract the same information, follows those paths in the input XML to extract the values of the information, and inserts those values in the output XML.

A Code Generation Embodiment

In this embodiment, the algorithm does not generate an XSL DOM tree or output file, but generates code in some programming language such as Java, C++ or Visual Basic for inclusion in a computer application. The computer application can then receive and send XML messages in the XML-based language, but can manipulate the information from the messages in terms of the classes, attributes and relations of the business information model—thus insulating the application from changes in the XML-based language.

In a Java-based implementation of this embodiment, the algorithm generates source code for a set of Java classes which correspond to the classes of the business information model. An XML parser is included in the application to read in external XML files to an internal DOM tree form, and vice versa To read information from an input message in some XML-based language, each Java class contains code which can traverse the DOM tree of the input XML message so as to read the information which the message conveys about entities of the class, their relations and attributes, and converts that information into a form which is independent of the XML-based language. The Java class makes this information available to the rest of the application by methods whose interfaces are independent of the XML-based language. Similarly for output of XML messages, the Java class constructs a DOM tree as required by the output XML-based languages, and then outputs that DOM tree as a character file using standard XML parser technology.

An Embodiment for Generating XML Schemas From a Business Model

Where there is a pre-existing XML schema /DTD/XDR and the user defines how it represents business information, the process is akin to reverse engineering—because the main purpose of the XML was to represent business information. This can be necessary because there are a lot of schemas which have been written by hand. There is now described an alternative procedure in which the business information model precedes the XML-based language:

1. create a business information model.

2. define requirements for an XML-based language in terms of classes, attributes and relations in the business information model that need to be represented.

3. Automatically generate an XML language definition (embodied in a schema definition) which meets those requirements, applying automatically various choices as to how different pieces of business information in the requirement are to be represented in XML.

4. As the schema is generated, record the automatically generated mappings between the elements, attributes and content model links of the schema and the classes, attributes and relations which the schema is required to represent in the business information model.

5. Use the techniques of this invention to generate XSL translations between messages of this XML-based language and other languages, which may have been created by hand or generated from the business information model as described here.

Using this procedure, the ‘how the XML represents business information’ does not need to be captured by hand, but emerges automatically from the generation process. There will still be a need for translation, and translators can still be generated by the algorithm as noted in (5) above.

Defining Mappings by Example

To define how an XML-based language represents business information, one might proceed not from the schema, but by constructing examples. One would build an instance of the business information model (e.g. as a small relational database or set of Excel tables), then write a piece of XML in the XML-based language, which represents the same information. From a few such examples a tool could reliably deduce how the XML represents business information, or tell you it needed more information to do so. The approach is, in some regards, similar to inductive language learning.

Appendix 1

XMuLator XML Transformation Tool

User Manual

May 2001

NOTE: The contents of Appendix 1 is a copyright work. This User Manual may only be reproduced in whole or part in conjunction with this patent specification and for no other purpose whatsoever. Inclusion of this User Manual in this patent specification does not waive or limit any rights owned by the copyright holder or constitute an express or implied licence of or under any rights owned by the copyright holder, other than as expressly granted above.

8. Solving the XML Interoperability Problem

8.1 The Interoperability Problem

XML has become the standard vehicle for all Business-to-Business (B2B) E-commerce applications, and is rapidly becoming the standard foundation for enterprise application integration (EAI) within the corporation. Many industry-specific and cross-industry XML-based message formats are being developed to support these exchanges between businesses and between applications. Therein lies the problem. Translating between these many XML languages is necessary, and is a hard problem.

If your company wishes to use one XML-based language, and your business partner wishes to use another, how will you talk to each other? If different package suppliers favour different languages, how will you integrate all their applications within your own organisation? The answer is to translate between the different XML based languages, and there is a standardised XML-based technology (XSL, and its XML-to-XML component XSLT) for doing so. Surely this will solve the translation problem? There are some important reasons why it will not:

If there are N different XML-based languages which your company may have to use, then in principle you may need up to N(N−1) XSL translation files to inter-operate between them. Even if in practice you do not need fully this number, the numbers are forbidding. On the BizTalk repository site, there are 13 different XML formats for ‘purchase order’. If you need even a small fraction of the 156 XSL translations, this is a challenging requirement.

XSL is a programming language, and not a very simple one at that. To write an error-free translation between two languages, you must not only understand the syntax and semantics of both languages in depth; you must also understand the rich facilities of the XSL language and use them without errors.

There is a huge problem of version control between the changing XML languages. As each language is used and evolves to meet changing business requirements, it goes through a series of versions. As a pair of languages each go through successive versions, out of synch with each other, and some users stay back at earlier versions, a different XSL translation is needed for every possible pair of versions—just to translate between those two languages.

The XML translation problem is often portrayed as an issue of different ‘vocabularies’, in that different XML languages may use different terminology—tag names and attribute names—for the same thing. If it were just this, the translation problem would be fairly straightforward. However, the differences between XML languages go much deeper than this, because different languages can use different structures to represent the same business reality. These structural differences between XML languages are at the heart of the translation problem. Just as in translating between natural languages such as English and Chinese, translation is not just a matter of word substitution; deep differences in syntax make it a hard problem.

The track record of XSL translation to date is not encouraging. For instance, the BizTalk website is intended to be a repository for XSL translations between XML languages, as well as for the languages themselves. But while over 200 languages have been lodged at BizTalk, I have not found on the BizTalk site a single XSL translation between languages. In practice it seems to be a forbidding task to understand both your own XML language and somebody else's language in enough depth to translate between them. Suppliers of XML languages are not stepping up to this challenge.

A similar problem of interoperability arose in the 1980s with the emergence of relational databases. In spite of the existence of an underlying technology to solve it (Relational Views), it has in practice not been solved in twenty years. The result has been an information Babel within every major company, which has multiplied their information management and IT development costs by a large factor.

If the XML translation problem is not solved effectively, the resulting industry-wide Babel of incompatible B2B links will be much harder to solve, and much more expensive. The XMuLator translation tool offers an effective way to solve it.

8.2 Meaning-Based Translation of XML

To translate between two different XML-based languages, you need to understand both their meanings. Translation is only possible where their meanings overlap. If their meanings have no overlap—if one language is about astronomy and the other is about chemistry—then any ‘translation’ between them is a mere symbolic sham. In this respect, XML is just like natural languages, where translation must be based on shared meaning. XSL, the standard language for XML translation, makes no explicit mention of the underlying meanings of the XML. A piece of XSL says things like ‘translate tag A in language 1 to tag B in language 2’, without ever stating that tags A and B mean the same thing, or what they mean. The meaning overlap between languages 1 and 2 is left behind in the head of the programmer who wrote the XSL.

XMuLator changes this. It puts meaning at the heart of the translation problem, and generates XSL out of the meanings. This has three big advantages:

Translation is driven by the underlying business reality, and everything about a translation can be traced back to business meaning. If there are difficult issues of business meaning, it makes them explicit and visible, not hidden in the syntax of XSL.

To create good translations, you need to understand about business meanings. You do not need to know XSL.

To translate between N different languages, you need to map each of them onto the same representation of business meaning—an effort proportional to N, rather than N(N−1). If each proponent of an XML language is prepared to make this one mapping onto business meaning, then his language can be translated automatically to any other which has also been mapped (as far as that is possible in principle—i.e. only where the two meanings overlap). The N-squared translation problem is solved.

8.3 Translating XML with XMuLator

To translate between any two XML-based languages using XMuLator, five steps are necessary:

1. Build a formal representation of the underlying business meanings in the domain—including a business information model—using a notation similar to UML class diagrams.

2. Capture the syntactic structure of each XML language, from its DID or XML, data (XDR) schema.

3. Define how each XML language represents business meaning, by mapping its syntactic constructs (elements, attributes and content models) onto the business information model.

4. From this information, XMuLator generates an XSLT file for the translation between the two languages.

5. Use the XSLT file to translate between an input file (in one XML language) to an output file (in the other language) which represents the same business meaning, wherever their meanings overlap.

A sixth step is highly desirable—use facilities in XMuLator to help to validate that the transformation is correct. In this sequence, steps (2), (4) and (5) are all automatic. Steps (2) and (4) are done by XMuLator, and step (5) is done by any XSL translator engine which conforms to the W3C standard for XSLT, such as James Clark's XT.

The hard work is in steps (1) and (3); most of this user guide is devoted to telling you how to do them, using XMuLator. They are both done through a graphical point-and-click interface, rather than by writing any formal language. However, we do not claim that steps (1) and (3) are easy, or can be done by an unskilled person in a morning. You will need to think clearly about business meanings, and to understand what each XML language is intended to do. You will encounter some hard issues about representing business meaning, both in UML class diagrams and in XML.

However, once you have understood the fairly simple mechanics of the business information model and of your XML languages, we promise you this: the difficulties you encounter will all be real difficulties. They are not artificial difficulties, imposed by this way of doing translations or by the tool. Using any other approach to XML translations—such as writing XSLT by hand—you will sooner or later encounter the same problems. The meaning-based approach and the XMuLator tool gives you a clear way of recognising the problems and tackling them, with a minimum of technical fog between you and the business issues.

Section 9 describes the form and content of a model of business meanings, the business information model. Section 10 describes how to build such a model using XMuLator. Section 11 describes how to capture the XML syntax. Section 12 describes how to map it onto the business information model. Section 13 describes how to create XSLT translations from the model and the mappings. Section 14 describes how to validate transformations using facilities in XMuLator. Section 15 describes how to build a business model in XMuLator, and to relate it to the information model. Section 16 describes how to install and run XMuLator, and section 17 describes some utilities.

9. The Model of Business Meanings

This section describes the form and content of the model of business meanings. Such a model consists of two main parts:

1. A model of business processes (‘the process model’)

2. A model of the things and information which take part in those processes (‘the business information model’)

To make sound XML translations, you should always construct both parts of the model of business meanings. A typical XML message is part of a business process, and it is vital to understand that process in order to understand what the XML message is doing. It is equally vital to understand the things which the message is about XMuLator has facilities for building both process models and business information models, and for linking between the two. However, in transforming XML messages from one language to another, the business information model is very much to the fore. The process model is a kind of background which underpins the meanings in the information model, and helps to define them more precisely, but the information model drives the translation process. Therefore the emphasis in this manual is very much on the business information model, and we return later to the process model in section 15. Meanwhile, do not forget the process model or forget that it underpins the information model.

9.1 The Content of a Business Information Model

To those who know the object-oriented design notation ‘Universal Modeling Language’ (UML) describing the content of a business information model is straightforward: a business information model contains approximately the same information as an extended UML class diagram. However, we shall describe the content of the model in terms independent of UML.

Business information is described primarily in terms of the types of things it is about—information may be about customers, products, bank accounts and so on. Each of these is a class of entity, which are arranged into a hierarchy of classes and sub-classes. For instance, every staff member is a person, so the class ‘staff member’ is a subclass of the class ‘person’.

In this manual, the word ‘entity’ is sometimes used loosely for ‘class’, because the XMuLator user interface uses the word ‘Entity’ rather than ‘class’. In reality, the entities are members of the classes.

The entities have both attributes (properties which belong to the entity) and relations (in UML called associations) with other entities. We will use the term relation for these association/relations.

The attributes an entity can have depend on what class it is in—for instance, anything in the class ‘person’ has a name. It then follows that, as any staff member is a person, any member of the class ‘staff member’ has a name. The class ‘staff member’ is said to inherit the attribute ‘name’ from the class person, and may also have other attributes of its own—attributes which are meaningful for staff members, but not for other types of person.

Relationships involve two classes of entity—for instance a person may own one or more cars, which is a relation between members of the classes ‘person’ and ‘car’. If any person can own a car, then so can any staff member—so the class ‘staff member’ inherits the relation ‘owns’ from the class ‘person’ and may have additional relationships of its own.

It has been found over many years that this basic structure—of classes, attributes and relations, with a class hierarchy—is capable of representing nearly all the types of business meaning which are needed in computer systems. Such a class hierarchy is the first thing you build in XMuLator.

9.2 Subtler Aspects of the Information Model

For the most part, building a business information model is a straightforward process of recording what types of things (classes) are important in the domain, with their properties and inter-relationships. The model should reflect these things in as straightforward a way as possible. However, from time to time you encounter subtler features where it may not be obvious what to do, and distilled experience of previous models is a very useful guide. We briefly note some of these subtler features here:

Attributes Versus Relations: One often encounters the question: is this feature an attribute or a relation? For instance, does a person have an attribute ‘address’ or does he have a relation ‘lives in’ to an entity ‘address’ in another class ‘address’? While there is no fixed answer to this question, a good general rule is: attributes should be atomic and single-valued, with essentially no internal structure of their own. If you did not use attributes somewhere, you would trail round the diagram following relation links without ever settling on a piece of readable data. Attributes are where the model ‘bottoms out’ to data values like ‘5’ and ‘Fred’. In this sense, because addresses tend to have internal structure such as Street, City, and PostCode, they should probably be entities in their own right.

Single Inheritance: The class model currently supported in XMuLator is a single inheritance model; each class can have at most one immediate superclass which it inherits from; the class hierarchy is a pure tree structure. This contrasts with other models (such as UML) which allow various forms of multiple inheritance; a class can inherit from many other classes, with more than just one line of immediate ancestors, and so the class diagram is not a tree. Multiple inheritance is sometimes trickier to understand, but often gives you economy of description. On the other hand, single inheritance, as used in XMuLator, implies no fundamental restrictions in what you can model. If you would like to get some attributes and relations in a class by multiple inheritance from several superclasses, in stead you have to choose just one class to inherit from, and then to add the other attributes and relations explicitly to the inheriting class, rather than getting them by multiple inheritance.

Making Relations into Classes: A relation can only involve two classes of entity, such as ‘person’ owns ‘car’.(sometimes these are the same class) You often want to represent relations involving three or more classes at once, such as ‘company’ sells ‘product’ to ‘person’ for ‘price’. The way to do this is to invent a new kind of entity ‘sale transaction’, with a new class of its own. Then a series of two-class relations—in this case ‘company’ is-seller-in ‘sale transaction’, ‘person’ is-buyer-in ‘sale transaction’, ‘product’ is-exchanged-in ‘sale transaction’ and so on, tie these different classes of thing together. The general rule is: if a relation involves three or more classes, or has any interesting properties of its own (other than the properties of the things taking part in it) then make it into a new class. This decision often depends on the scope of what you are doing. For instance, if you are just interested in the present moment, then the relation ‘person’ owns ‘car’ is a yes-or-no thing (either he owns it or he does not) and each instance of the relation (each ownership) has no other properties. But if you are interested in history, then ownership has a start date and an end date, so may qualify as a class in its own right.

Unique Identifiers: For any class, it is useful to define one or more unique identifiers. A unique identifiers is some set of attributes which defines entities in the class uniquely—that is, no two entities in the class can have all those attributes equal. One reason for needing unique identifiers is because relations are often represented by ‘foreign keys’ which are values of unique identifier attributes. For instance, to denote the fact that a course is taught by a lecturer, you can have attributes in any ‘course’ entity which define uniquely the lecturer who teaches it. This is commonly done in relational databases and in XML (it is not so common in object-oriented programming, where typically pointers are used in stead). As unique identifiers are a logical property of the business information, rather than of any implementation, they are recorded in the business information model. In principle, an entity could be uniquely identified by its relations; but in the XMuLator model unique identifiers must be combinations of attributes.

Abstractions and Approximations: In building the business information model, it is often useful to work with a more or less idealised, abstracted version of the world—for instance, assuming that some event happens at a discrete date, when in fact the event's ‘happening’ may sometimes spread out over several days. Computer systems are often built on such approximations, because they would be hopelessly complex without them; and if any such approximation is likely to be used for all computer systems and processes in a business, then you should use that approximation in constructing the business information model.

Cardinality of Relations: As a relation involves entities of two classes, it is characterised by a relation name, and the names of the two classes at either ‘end’ of the relation. Many relations place constraints on the number of entities at either end of the relation, either in real life or in the approximation to real life which you use to run a business, and build in to the information model. For instance, you may wish to assume that a car can only be ‘owned’ by one person, but that a person may own several cars. In this case the relation ‘person owns car’ is said to have cardinality 1:M. Currently XMuLator supports cardinalities 1:M, M:1, 1:1 and N:M. This is all you will ever need, but certain other tools and notations (such as UML) enable you to specify cardinality constraints more precisely—defining minimum and maximum numbers of entities at either end of the relation independently.

Dynamic Process Information: It may appear that the apparatus of classes, attributes and relations is best suited for the static aspects of business meanings, and is not so well suited for its dynamic aspects of processes and change. However, even within the information model you can represent pieces of processes by entities in new classes; for instance ‘invoice’ is an entity, and is also a piece of a sales process. Its relations to other pieces of the process can embody a lot about the dynamic behaviour of the process. Processes themselves are sometimes represented as entities in classes. However, dynamic information is mainly catpured in the business process model, and in links between entity/classes and the process model; you can capture facts such as ‘this entity is input to this process’. See section 15 for details.

Unbundling and Normalisation: Many computer file structures and data structures (for instance, many classes in object-oriented programming) bundle together information about several different types of thing together in the same object or file record. XML messages typically bundle a lot inside one element. In contrast, the business information model is maximally unbundled (or in relational database terminology, normalised) to make it absolutely clear what information pertains to what kind of entity. It should be so, to be able to represent the business realistically and flexibly, and it can be so, because it is a tool for analysis, and does not have to be ‘optimised’ for performance. Most of the bundled computing structures have been bundled partly for reasons of performance, partly for implementation simplicity in a specific application. This bundling typically has unforeseen costs when the application is broadened or altered.

Although we are describing the business information model in some detail, it should be borne in mind that the model is defined entirely in business terms, not in technology terms; it is not dependent on any computer technology, and should be understandable entirely in business terms.

In several years of building business information models, we have found that the classes near the top of the class hierarchy are very similar for all businesses. All the classes you will ever need can be cast as sub-classes of five main classes, ‘participant’, ‘asset’, ‘grouping’, ‘activity record’ and ‘location’, as illustrated in FIG. 10.

Briefly describing these top level classes:

Participant includes any person or organisational unit involved in the business.

Asset describes what the business is concerned about—inanimate objects, concrete or abstract.

Grouping describes the ways in which the company ‘carves the world apart’ in order to run the business—into time periods, geographical or market sectors, categories of customer, and other categories.

Location describes the physical or electronic locations involved in the business—places, addresses, telephone numbers.

Activity Record is concerned with how the business is conducted. In a paper-based business, this includes every piece of paper that records some piece of activity—such as invoices, contracts, and reports.

We would recommend that you build your own business information models in this manner—although it is not necessary to do so for the correct functioning of XMuLator.

This tree diagram of the classes and sub-classes is the top-level view of the business information model supported by XMuLator. The ‘+’ boxes in the diagram indicate where you can drill down to reveal more specific sub-types. While the top levels of this taxonomy are typically rather generic (as in the diagram), drilling down reaches entity types which are more and more specific to the business. In three or four levels you can reach some very diverse and business-specific entities.

Each node in the tree diagram denotes a class, which is a type of entity. There may be many entity instances of any type, but these are not directly represented in the information map. For instance, there is typically just one ‘person’ node, but there may be hundreds or thousands of individual people relevant to the company's business.

This hierarchy is easy to navigate and remains comprehensible in business terms, even for the most complex businesses. We have found that for a complex business, perhaps three or four hundred classes are needed; but you can navigate your way around the class diagram without having them all visible at once.

XMuLator also supports attributes and relations for these classes. The facilities for defining, viewing and editing classes, attributes and relations are described below.

By putting attributes and relations on high-level nodes in the tree, you can concisely summarise a lot of lower-level, more specific attributes and relations, and so keep the information model simple. However, high-level attributes and relations with inheritance should be used sparingly; if in doubt, use more specific low-level relations to capture the model precisely.

In this way the business information model catalogues all the information required to run a business. The model itself does not hold the information; but it describes the logical form the information must take if it is to serve the needs of the business. For instance, the map does not store actual customer addresses; but it stores the fact that each customer must have an address, and that the business should know the address. The map stores ‘meta-information’, or information about information.

The minimal description of a business information model, held by XMuLator, is as follows:

About entities:

name of the entity type

name of its parent entity type

description (may be blank)

About attributes:

name of the entity type whose attribute this is

name of the attribute

type of the attribute

description (may be blank)

About relations:

name of the first entity type involved

name of the second entity type involved

name of the relation

whether it is one-to-one, one-to-many, or many-to-many

description (may be blank)

This model of information is extensible; if you wish to store other information about entities, attributes or relations, this can be added and XMuLator will support it without changes to the code of XMuLator. How to do so is described in section 15.

10. Building a Business Information Model

Recall that the model of business meanings has two parts—the process model and the information model—and we recommend that they be developed in tandem. This section only describes how to build the information model. We recommend that in parallel, or in advance of the information model, you also build the process model as described in section 15. This will help ensure that the information model is complete and help in precisely defining the meanings of entities, attributes and relations.

Another recommendation is worth making up front. XMuLator has extensive facilities for recording and showing descriptive comments about the meanings of entities, attributes and relations. These descriptions can be quite important when working out the links (mappings) between the business information model and any XML language. When you do so, ideally you will have at hand good descriptions of the meanings of both. However, very often the specifications of XML languages do not have good descriptive comments; so you should try to ensure that at least your information model does have good descriptions. While it may be tempting to skimp on filling in of descriptions (‘I can fill those in later’), don't skimp; you probably won't come back to fill in the descriptions later.

We shall use a concise notation for menu selections. For pull-down menus in the main window of the XMuLator tool, we shall use a notation Menu/Menu Item or Menu/SubMenu/SubMenu Item, as in File/Connect.

There are also pop-up menus which can be seen by clicking on some object on the screen. The type of object may be an entity, attribute or relation in the business information model. Popup menu selections will be denoted in a similar way, using the type of the object first to denote which popup menu is involved—as in Entity/Show/Attributes or Attribute/Delete.

10.1 Getting the Business Model Right

The business information model is a taxonomy of entity classes, with attributes and relations. You may be concerned that you need to ‘get this model right’—in particular, to get the taxonomy structure right—before you can start using it to generate XML transformations. For two reasons, this is not the case.

First, the essence of the business information model is just a catalogue of classes, attributes and relations. Its ‘taxonomy’ aspect is mainly just a way of making the catalogue more economical—so that an entity class may inherit attributes and relations from its superclasses rather than having to define them afresh. If you don't get the inheritance structure right first time, all this means is that you will have to define some attributes and relations several times down different branches of the taxonomy, rather than defining them once on a superclass.

As far as XML transformation is concerned, these multiple definitions do not matter. As long as two different XML languages represent the same class, attribute, or relation, that information can be translated between them—wherever it is defined on the taxonomy.

For the same reason, the lack of multiple inheritance in the XMuLator business model does not stop you generating good XML transformations—it just means you may need to define an attribute or relation in several places, where multiple inheritance would have allowed you to define it just once.

There is a weak dependence of transformation on the structure of the taxonomy, in the following sense: if XML language L1 represents a class C, and language L2 represents a class D which is a superclass of C, then XMuLator can generate XSLT to translate this information from L1 to L2, but not the other way. To know that D is a superclass of C, you need to get that part of the taxonomy right. But this kind of subclass/superclass translation does not occur often.)

Second, XMuLator allows you to extend the taxonomy, and even alter its structure by moving a subtree from one place to another, as long as you do not ‘break’ the inheritance of any attributes and relations which have been mapped to XML languages. (If a structure change would do so, undo the mappings before you make the structure change, then re-do them afterwards) In practice this gives you a lot of freedom to refine the taxonomy structure as you learn more about the domain, without losing work.

10.2 Opening and Browsing the Model

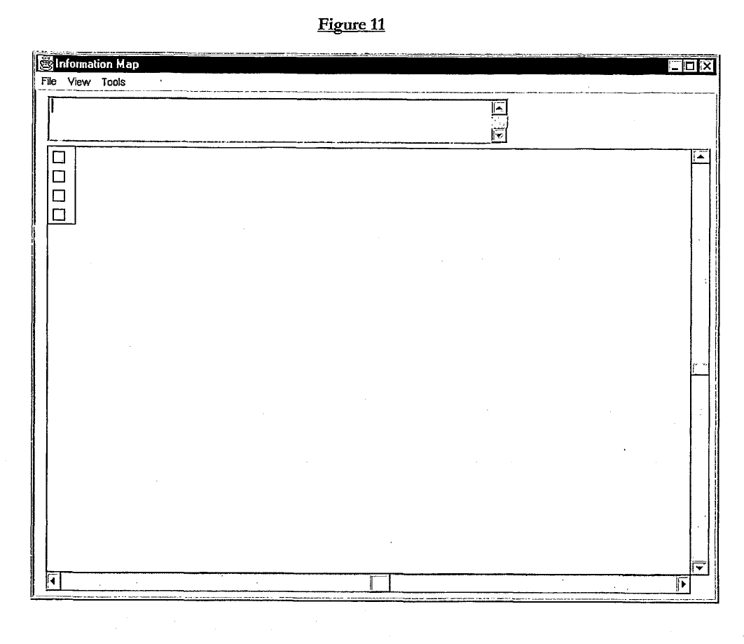

When XMuLator is started, the appearance of the screen is as shown in FIG. 11. The top scrolling area is for status messages, while the lower area (with horizontal and vertical scrollbars) will show the entity tree of the business information model. The coloured squares give popup menus for coloured highlighting of the tree; these menus will be denoted by Colour/ . . . No information map is shown yet because the tool is not yet connected to any database of map information.

The database of business model information is held in some form which can act as an odbc or jdbc data source (odbc=Open Database Connectivity, a common standard for accessing databases; jdbc=Java Database Connectivity, closely modelled on odbc). The forms that you will use are either a Relational Database (held on a database management system such as MS Access, Oracle or InterBase) or an Excel workbook. These forms may be stored locally on your machine, or remotely. In either case, you will need to know the odbc address (that is, the Uniform Resource Location, or URL) of the map database. See the section on Installation for more information on URLs.

To see the information map, you need to connect XMuLator to a map database. From the menu bar, choose File/Connect to show the dialogue as in FIG. 12.

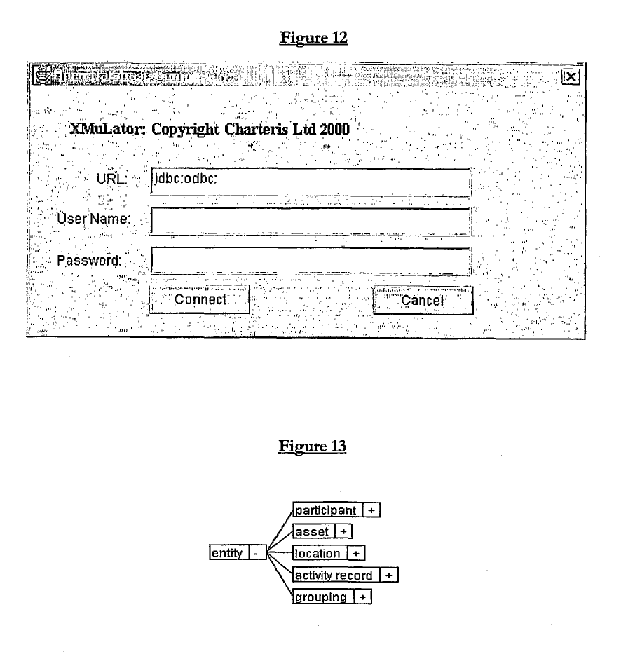

Enter the URL of the map database. Enter any user name and password needed to access the map database, and hit the ‘connect’ button. After a few seconds taken to load the map data, the screen should show the top-level entity tree of the business model (see FIG. 13).

When first shown, only the top-level nodes of the tree are visible; but any ‘+’ can be clicked to drill down one more level in the tree. If the mouse is hovered over any node, the text description of the node is shown as in FIG. 14.

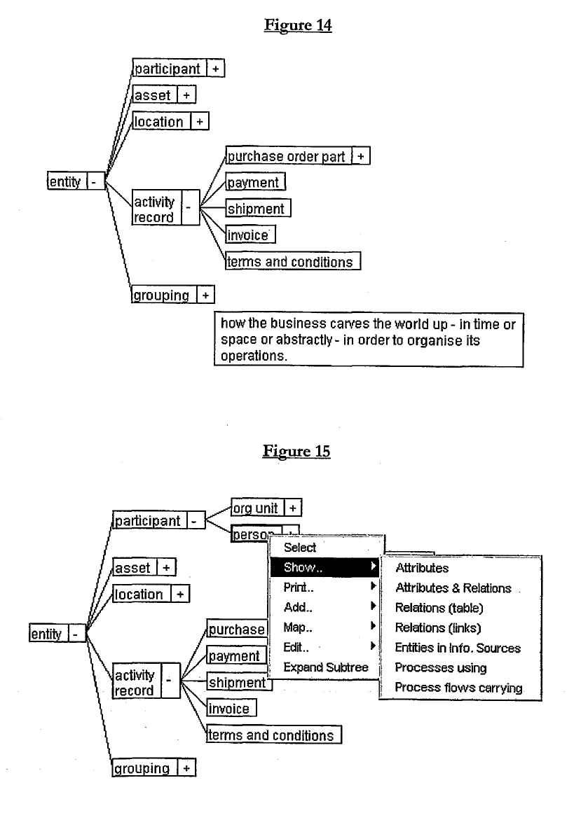

Clicking the mouse on any node reveals a pop-up menu of options for that node as can be seen in FIG. 15.

While clicking a ‘+’ box expands the tree to show the immediate children of the clicked node, using Entity/Expand Subtree will fully expand the subtree beneath that node to any depth. Clicking a ‘−’ box will fully contract the tree back to that node.

In the picture, the ‘Show’ item has been selected to see its sub-menu, of the things that can be shown. Choosing the ‘attributes’ option (Entity/Show/Attributes) shows a pop-up window of the attributes of the ‘person’ entity, as seen in FIG. 16.

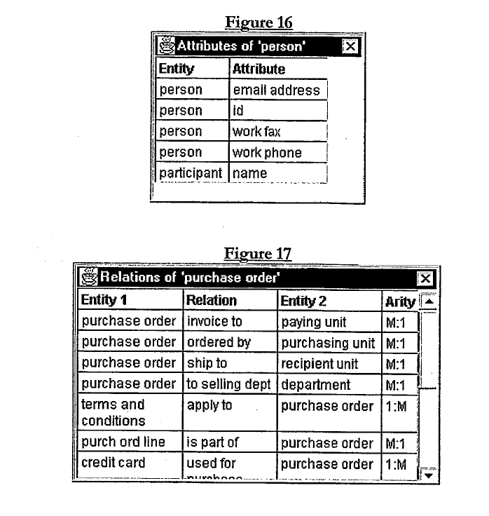

The window also shows the attributes which ‘person’ inherits from higher level nodes in the tree—in this case, from the ‘participant’ node. Similarly, Entity/Show/Relations (table) will show the relations of an entity as in FIG. 17.

The relations of an entity can be shown either in this tabular form, or as lines on the tree diagram. As you can only show the relations of one entity at a time, this stops the diagram getting too cluttered, as often happens with entity-relation diagrams (ERDs). Using Entity/Show/Relations (links) will draw relation lines for the relations of that entity, as in FIG. 18.

In this diagram the relations of the selected entity itself are shown in green, while relations inherited from higher entity nodes (if there are any) are shown in blue.

Hovering the mouse over one of the relation lines will give a description of the relation, as shown in the diagram (the mouse pointer is not shown).

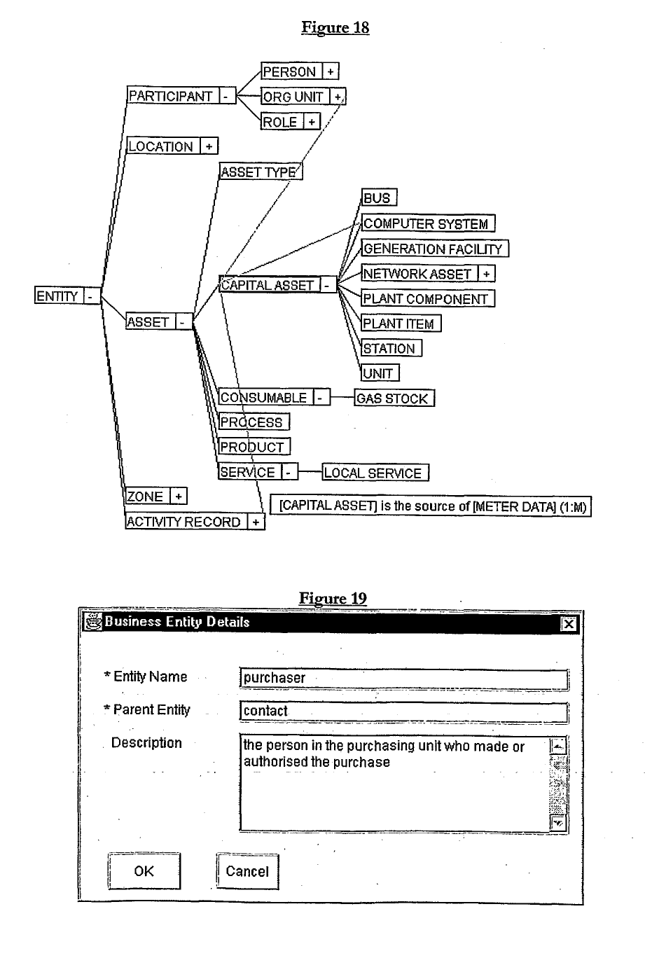

Entity/Edit Details shows a dialogue (FIG. 19) with all details of the entity itself.

In this case, only the minimal set of information for an entity is shown; but if additional entity information were stored in the map, it would be shown here.

Similarly, Attribute/Edit Details shows details held about the attribute, and Relation/Edit Details shows details of the relation, as seen in FIG. 20.

The popup menus needed to access these dialogs can be got by clicking on one of the attributes or relations in the tables of attributes and relations shown above. In this case, one optional fields (a name for the inverse relation) has not been filled in.

The types of extra detail information that can be held for entities, relations and attributes are quite open-ended, and can be either defined when a map database is set up or extended later.

10.3 Integrity of the Map Database

When you are building an information map, XMuLator makes numerous checks of the integrity of the map, and does not allow you to make changes which undermine its integrity. A map database which violated some of these constraints would, to the extent that it violates them, be meaningless; so violations are never allowed. The integrity checks take four forms:

Obligatory values: while some fields in the map data—such as text descriptions—can be left blank, other fields—such as entity names—must have non-blank values. These fields are marked with an asterisk in the dialogue boxes. You will be prompted to enter these values before the mapping tool will create any new record.

Allowed Values: Some fields can only have a few possible values. XMuLator presents the allowed values in a menu for you to select one, so it is impossible to enter any other value.

No Duplicates: For instance, there cannot be two entities with the same name; an entity cannot have two attributes with the same name; and so on. In checking for duplicates, the tool treats upper and lower case as distinct Try to adopt a consistent case convention across the whole map database, to avoid near-twins which differ only in case.

No Orphan Records: For instance, it would be meaningless to have an attribute in the business information model unless it were the attribute of some entity. Therefore there should be no attribute record in the map database without a corresponding entity record. Such a record would be an orphan, and the mapping tool prevents you from creating any orphan records.

The orphan records which you cannot create are:

No business entity without a parent entity (except for the top ‘entity’ entity)

No business attribute without a business entity

No business relation without business entities at both ends

No process node without a parent (except the top process node)

No process flow without start and end processes

No XML element without an XML source

No XML attribute without an XML entity

No XML content model link without outer and inner elements

No mapping without something at both ends of the mapping

These integrity conditions are enforced whenever you create, modify or delete records in the map database. Sometimes you will be asked to re-enter data to maintain integrity, before any update will be made.

The integrity constraints sometimes require you to do things in a certain order; for instance, you will have to create a new entity in the business model before you can create any of its attributes or relations.

Sometimes, when you delete records, XMuLator will delete other records to stop them becoming orphans, and so to maintain integrity you should take care that this does not produce effects you do not intend. For instance, whenever you delete an entity in the business information model, the mapping tool will automatically delete all its attributes and relations, and all the mappings from the entity, its attributes and relations to XNML selements, attributes and content model links. It will also delete all descendant entities below it in the tree, together with all their attributes, relations and mappings. This means you could almost wipe out the map database with one delete. Beware. Keep a backup copy.

10.4 Building the Entity Tree

The empty map database supplied with XMuLator already has a small entity tree with the top ‘entity’ node and its five immediate descendants. These can be modified if you wish; but generally you will build a business information model by expanding and editing this basic tree. To grow the tree below an entity node, or to modify it, click on the node to show its ‘entity’ popup menu. The relevant commands are as follows:

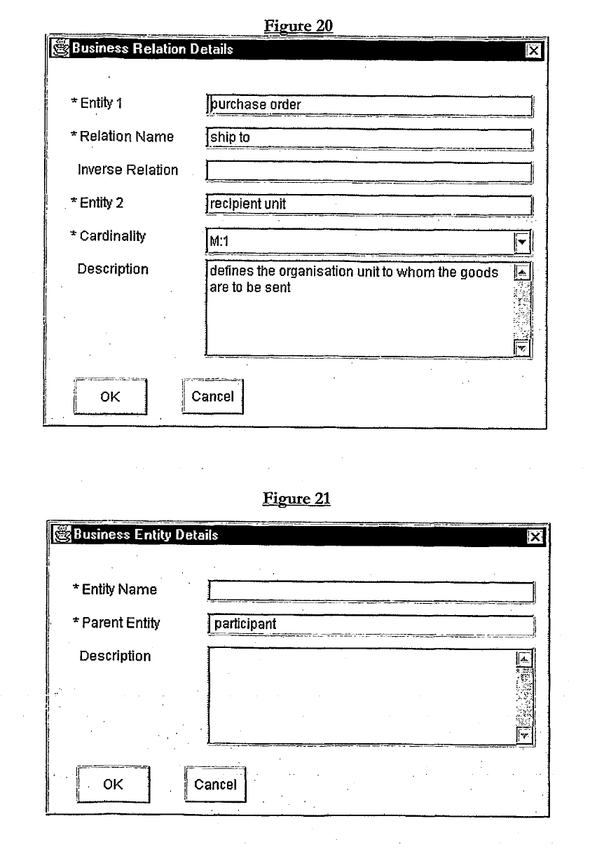

Entity/Add/Child Entity shows the following dialogue (see FIG. 21), enabling you to add an entity immediately below the selected entity in the tree.

In this dialogue and others like it, ‘*’ marks a field which must have a value; fields without ‘*’ are optional. The ‘Parent Entity ’ field is greyed out, showing you cannot change it. You need to provide a new entity name, and can provide an optional description. Do that now. The new child entity will be added below any other existing children in the screen image of the tree.

The tool will prevent you from adding an entity whose name duplicates any entity already present; in this it treats upper and lower case as distinct.

To change the name of an entity without moving it in the tree, use Entity/Edit/Details; similarly to add a text description, or change it

To delete an entity, use Entity/Edit/Delete; remember that this will delete all its attributes and relations, all its descendant entities with their attributes and relations, and all their mappings. You will be asked to confirm any delete command.

You may want to order the descendant nodes form an entity node in some meaningful order on the screen. To do this, use Entity/Edit/Move up to move an entity up one place in the order below its parent, or Entity/Edit/Move Down to move it down. Its whole sub-tree moves with it.

To move a sub-tree in any other way (that is, to attach it to a different parent) use Entity/Edit/Details on the root node of the subtree, and change the name in the ‘Parent Entity’ field to the name of the new parent.

10.5 Adding Attributes

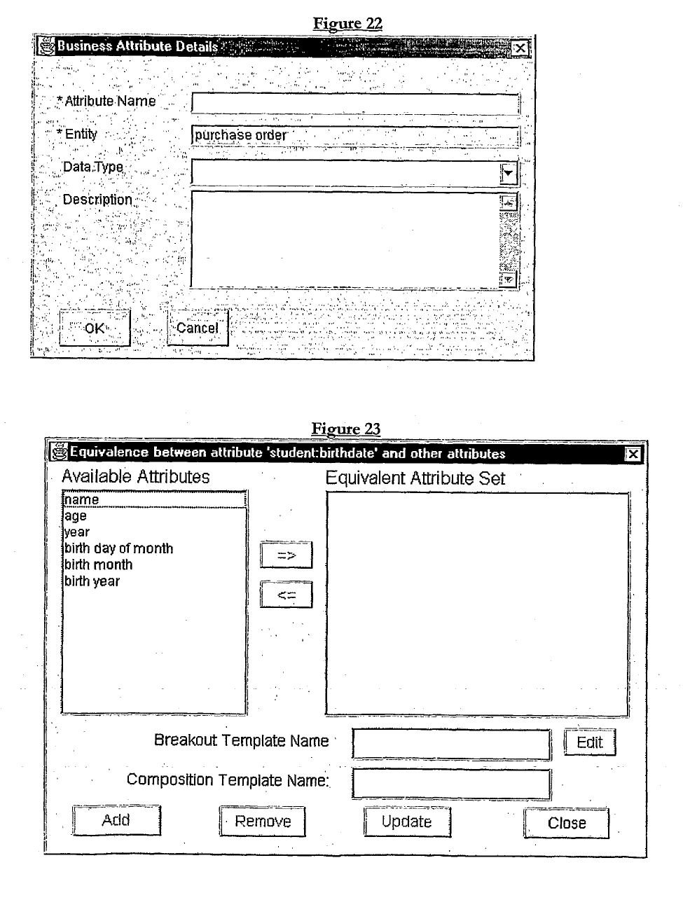

To add a new attribute to an entity, use Entity/Add/Attribute which will display the dialogue as in FIG. 22.

Duplicate attribute names will be detected and prevented. There is no choice in the order of attributes of a business model entity; they are displayed in alphabetical order.

It is currently possible to give a class an attribute with the same name as an attribute of an ancestor class—which the descendant class will inherit automatically. It is not a good idea to do this, because then the descendant class will appear to have two attributes with the same name.

To change an attribute name, first display a list of the attributes of the entity by Entity/Show/Attributes. Then click on the attribute name to display its popup menu, and select Attribute/Edit Details. Similarly to add or delete a text description.

To delete an attribute, display all the attributes of the entity as before and then use Attribute/Delete. You will be asked to confirm the deletion.

10.6 Equivalent Attributes

In building the business information model, you may often be faced with a question: should some piece of information be represented by one attribute, or by several? For instance, should a date be represented as a single character string which embodies (year/month/day) or should there be separate attributes for the year, the month and the day of the month?

(Note: To define, for instance, someone's date of birth you might choose to define a separate entity class ‘date’ and to use a relation from the person to the ‘date’ entity rather than a ‘birthdate’ attribute. But this only shifts the problem, and does not solve it. For the entity class ‘date’ you still need to define whether it has one attribute or three.)

This issue becomes important when defining mappings between the business model and different XML languages. If some XML language defines ‘date’ as a single element, then it is simple to map this element onto a business model attribute. Similarly if another XML language has separate elements for year, month and day, then these elements can be easily mapped to separate attributes in the business model—but could not be mapped to one ‘date’ attribute. So if you were forced to choose, in the business model, whether to use one attribute or three attributes to represent a date, any XML language which made the opposite choice could not have its date information translated by XMuLator.

To avoid this dilemma, when building the business information model you are not forced to choose between single- and multiple-attribute representation of the same information. In the ‘date’ example above, you can add all four attributes ‘date’, ‘year’, ‘month’ and ‘day_of_month’ and then record that ‘date’ carries the same information as ‘year’, ‘month’ and ‘day_of_month’ together.

This enables XMuLator to generate translations between XML languages which use either the single-attribute or the triple-attribute representation of dates. To enable it to do so, you will need to supply a set of XSLT templates which transform attribute values in either direction between the single-attribute and multi-attribute representations.(These XSLT templates might, for instance, be little more than calls to Java classes which do the actual data transformation—depending on how your XSLT processor supports Java or other extensions.) XMuLator will then incorporate copies of these templates, and the calls to them, at appropriate places in the XSLT which it generates.

To record the fact that one attribute is equivalent to several other attributes in combination, first show all attributes of some class by using Entity/Show/Attributes. Then select the attribute which you wish to make ‘composite’ and equivalent to some other ‘component’ attributes, and use the popup menu Attdibute/Equivalence. This will show a dialogue as in FIG. 23.

The row of buttons at the bottom of this dialogue are operations on the whole equivalence—to add, remove or update an equivalence, or to close the dialogue without further action. The parts of the dialogue box above the bottom row manage operations on the parts of an equivalence (i.e on individual component attributes, and template names).

To add an attribute to the set of component attributes which are equivalent to the single composite attribute, select the attribute to be added from the left-hand menu. Enter the name of the XSLT template which will translate from the composite attribute value to the value of this component attribute (as the ‘Breakout Template Name’, as this template will break out the component value from the composite value). Then press the ‘=>’ button to move this component attribute into the Equivalent Attribute Set. To remove an attribute from the set, press ‘<=’.

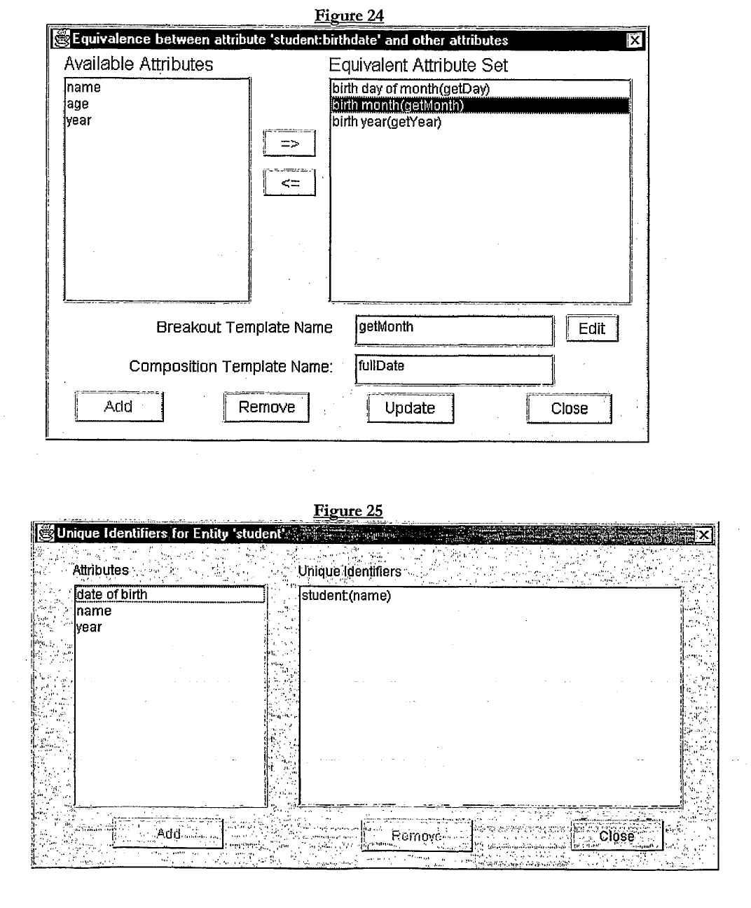

Type in the name of the XSLT template which will translate from the multiple attribute values to the single attribute value, (as the ‘Composition Template Name’) and press ‘Add’ to store the whole equivalence. The dialogue appearance should then look something like FIG. 24.

Each component attribute is shown in the right-hand ‘equivalent attribute set’ menu, followed by its breakout template name in brackets. To change the name of the breakout template for an attribute, select the attribute in the right-hand menu, edit the template name and press ‘Edit’. (Note this will not be reflected in the database until you press ‘Update’ for the whole equivalence).

The XSLT template which you provide to translate from the composite attribute representation to any of the component attributes must have just one parameter called ‘p1’. The template to translate from the component attributes to the composite attribute must have parameters ‘p1’, ‘p2’ and so on, one for each component attribute. The parameters denote the component attribute values, in the same order as the right-hand ‘Equivalent Attribute Set’ above.

For instance, in the example above if the composite attribute is ‘birthdate’ represented as ‘day/month/year’, and the component attributes are ‘day’, ‘month’ and ‘year’, the set of conversion templates might be as follows. To convert from the component attribute values to the composite attribute value:

<xsl:template name=“fullDate”>

<xsl:param name=“p1”/>

<xsl:param name=“p2”/>

<xsl:param name=“p3”/>

<xsl:value-of select=“concat($p1,‘/’,$p2,‘/’,$p3)”/>

</xsl:template>

To convert from the composite value to each of the component values:

<xsl:template name=“getDay”>

<xsl:param name=“p1”/>

<xsl:value-of select=“substing-before($p1,‘/’)”/>

</xsl:template>

<xsl:template name=“getMonth”>

<xsl:param name=“p1”/>

<xsl:value-of select=

“substring-before(substring-after($p1,‘/’),‘/’)”/>

</xsl:template>

<xsl:template name=“getYear”>

<xsl:param name=“p1”/>

<xsl:value-of select=

“substring-after(substring-after($p1,‘/’),‘/’)”/>

</xsl:template>

All data conversion templates for the business model are to be supplied in a single XSLT file, which XMuLator will require you to open before generating any transformations. If any of the templates is not given a name in the dialogue above, or not supplied in the template file, XMuLator will not be able to transform the attribute values, and will issue warnings to this effect.

Sometimes it is only possible to provide a template to convert in one direction, because information is lost in conversion and cannot be recovered. For instance, a representation of a full name which uses a middle initial cannot be converted back to recover the middle name. XMuLator will then be able to convert in one direction only.

Attribute value equivalences can be chained as many tunes as required. For instance an attribute ‘dateTime’ could be made equivalent to two attributes ‘date’ and ‘time’; then ‘time’ could be made equivalent to ‘hour’, ‘minute’ and ‘second’. However, in the current implementation, each attribute can be at the composite attribute for only one equivalence.

Attribute value equivalences are inherited from the class in which they are defined down to any subclasses of that class.

It is possible to define an attribute value equivalence which only has one ‘component’ attribute and one ‘composite’ attribute, and it is sometimes useful to do so. For instance, if two different single-attribute representations of a date are commonly used, then both representations could be built into the business model with an equivalence between them. Then as long as the appropriate conversion templates are supplied, XMuLator can translate between any XML languages using either representation.

However, it is often best not to clutter up the business model with these equivalent attributes, as you might end up (for instance) needing five or six representations of ‘date’ and it is best to keep the business model simple. In this case, it is best to define only one ‘master’ representation of date in the business model. Whenever an XML language uses a different representation of the date, templates to translate the date representation can be defined for that XML language and will be applied as appropriate. This is described in section 5.2.4.

10.7 Defining Unique Identifiers

When you have defined the attributes of a class, you will want to define which combinations of these attributes constitute a unique identifier for entities of the class. To do so, use Entity/Edit/Unique Ids. This will show a dialogue as in FIG. 25.

The attributes of the class (including those it inherits from its superclasses) are shown in the left-hand column. To create a new unique identifier, select all the attributes you want to be part of it, and click ‘Add’. The new unique identifier will then appear in the right-hand column, as illustrated. This shows the class name, and the set of attributes which constitute each unique identifier. There can be several unique identifiers.

The class name is shown because unique identifiers are inherited from superclasses. If any set of attributes uniquely picks out one entity from a superclass of this class, then it also uniquely picks out one entity from this class.

The ‘Remove’ button can be used to delete the unique identifiers which have been defined for this class, not those that were defined for its superclasses.

10.8 Adding Relations

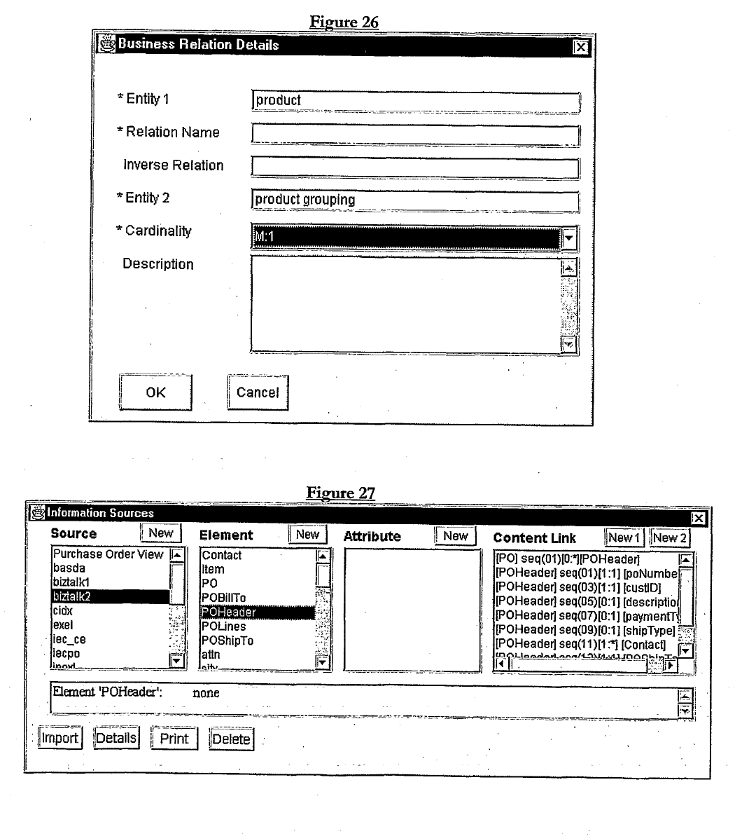

To add a new relation between two entities, drag the mouse from one to the other. This will drag a red line with it and then display the dialogue as in FIG. 26.

You will need to type in a relation name, and to choose one of the four possible values for ‘Cardinality’ (which the tool sometimes calls ‘Arity’ and has possible values 1:1, 1:M, M:1 and N:. The ‘Inverse Relation’ and ‘Description’ fields are optional.

Note that this dialogue defines that the relation exists, but does not define how it is implemented (e.g. in terms of one or another foreign key) because that is an implementation detail.

This method does not allow you to directly add a relation from an entity to itself. To do this indirectly, first add a relation from the entity to any other entity. Then display the relations of the first entity, select the new relation, and use Relation/Edit Details to change the name of ‘Entity 2‘to be the same as ‘Entity 1’. Messy, but it works. Note that these ‘selfish’ relations show twice in the list of relations—once for each end.

To delete a relation, select the entity at either end of the relation and use Entity/Show/Relations(table) to display all its relations in a table. Then select the relation to delete, use Relation/Delete, and confirm the deletion.

To change the name of a relation, select the relation as before and use Relation/Edit Details to alter the name of the relation.

11. Capturing the Syntax of XML Schemas

11.1 How XML Schema Syntax is Defined

When XML was first standardised by the World Wide Web Consortium (W3C), there was only one way to define the allowed syntax of an XML document, or set of documents: this was to write a Document Type Definition (DTD) for them.

Since that time, the limitations of DTDs have been recognised, and there have been initiatives to replace DTDs by better form of specification. While still consistent with the XML 1.0 standard in the space of XML documents they allow, these other schema notations enable users to constrain the allowed syntax of particular XML applications more precisely. In spite of these initiatives to replace them, DTDs are still very widely used.

One of these initiatives is XML Data, which led to XML Data Reduced (XDR). XDR is now widely used, partly because it is the schema definition language used on the Microsoft-backed BizTalk repository of XML schemas, where over 200 distinct schemas have been lodged to date.

These attempts to define a better XML schema language have culminated in XML Schema, a W3C backed language which is now close to standardisation. When the XML Schema standard is ratified by W3C, XMuLator will be extended to support it At present, XMuLator supports two main schema definition languages—DTDs and XDR. Most published XML language definitions can be found expressed in one or other of these schema languages.

XMuLator also recognises a third way of defining XML languages, denoted by the acronym ‘XSU’ which stands for the Oracle XML SQL Utility. This tool available from Oracle will automatically generate XML from an Oracle database. The syntax of the XML is related in a simple way to the database schema, and XMuLator can capture this XML syntax from the database schema.

11.2 Capturing XML Schema Syntax

To capture the syntax of an XML language in XMuLator, you do not have to know about the details of either DTDs or XDR, because the capture process is automatic from the DTD, XDR file, or relational schema (in the case of XSU). However, in order to map the XML syntax onto your business information model, and so to define how XML represents business information, you will need to understand how one or other of these schema languages works.

To capture an XML schema from a DID or XDR file, first ensure you have the URL of the file (if it is remote) or have a local copy of it. Then from the main menu select View/Sources to show a dialog box as in FIG. 27.

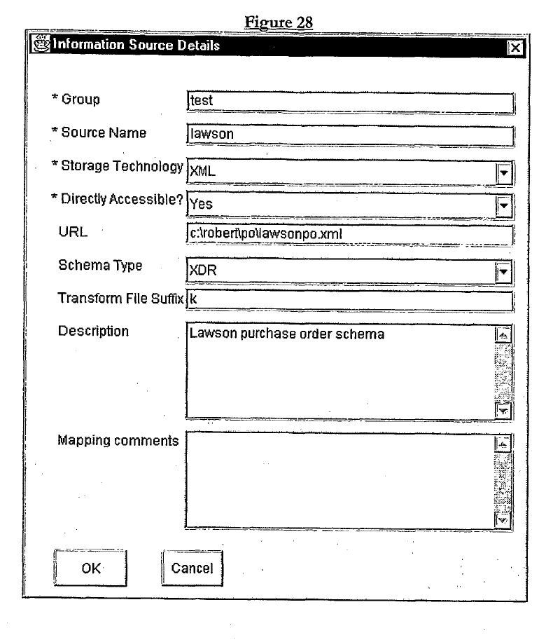

The list headed ‘source’ will contain names you have given to the other XML sources (schemas) you have already captured in XMuLator for use with this business information model. To start to define a new schema, press the enabled ‘New’ button by the ‘Source’ label to show a dialog seen in FIG. 28.

You need to fill in at least the top six fields of this dialogue to proceed.

Some large schemas are defined not in a single DTD or XDR file, but in a group of several such files. Typically some of the schemas in the group define common elements and attributes which are used in several others, using ‘namespace’ invocations to refer to them. To allow XMuLator to make these links, use the same ‘Group’ name for all schemas in a group. Otherwise the group name is unconstrained, as is the ‘Source’ name; this is the name by which XMuLator will denote the particular schema.

If a schema is split into several sub-schemas in this way, you will need to capture the ‘common shared elements’ parts of the schema first, so that when those names are referred to in other parts of the schema under some namespace prefix, the namespaces can be resolved immediately. XMuLator will tell you in the message box when it is trying to resolve namespace references, and whether it has succeeded.

For ‘Storage Technology’ select the option ‘XML’ (other options include relational databases). For ‘directly accesssible’ choose ‘Yes’ indicating that the DTD or XDR file can be accessed by the tool. In ‘URL’ enter the URL or file name of the-DTD or XDR file which defines the schema. In ‘Schema Type’ choose the option ‘DTD’ (for a DTD-defined schema) or ‘XDR’ (for a schema defined in AL Data Reduced) or ‘XSU’ (for a schema defined from a relational database by Oracle's XML SQL Utility) as appropriate. You may also enter some free-text description, and then press ‘OK’. (The ‘mapping comments’ field is typically filled in later, after you have mapped the XML onto the business model.)

After a few seconds you will see the Information Sources dialogue, with the new XML source in the list of sources. Select it, and press the ‘Import’ button. XMuLator will take a few seconds (or longer for large schemas) to capture the schema information from the DTD or XDR file.

If you have chosen the schema type ‘XSU’, whereby an XML language is defined automatically from a Relational Database, then XMuLator needs to access the schema of the database in order to find the schema of the XML which will be generated from it by the Oracle XSU. This XMuLator does by odbc, and a dialogue will appear asking you for the odbc address of the relational database.

When the message box at the top of the main window indicates that the XML schema has been captured, select the XML source again in the ‘Information Sources’ dialogue. The second list in the dialogue box will now show a list of the elements in the XML schema (see FIG. 29).

In this example note that some of the element names are prefaced with ‘ce:’ which denotes that they come from another namespace called ‘ce’. That namespace DTD (or XDR) must be part of the same group, and must have been imported first to be able to resolve the names. In this example it was given the name ‘iec_ce’.

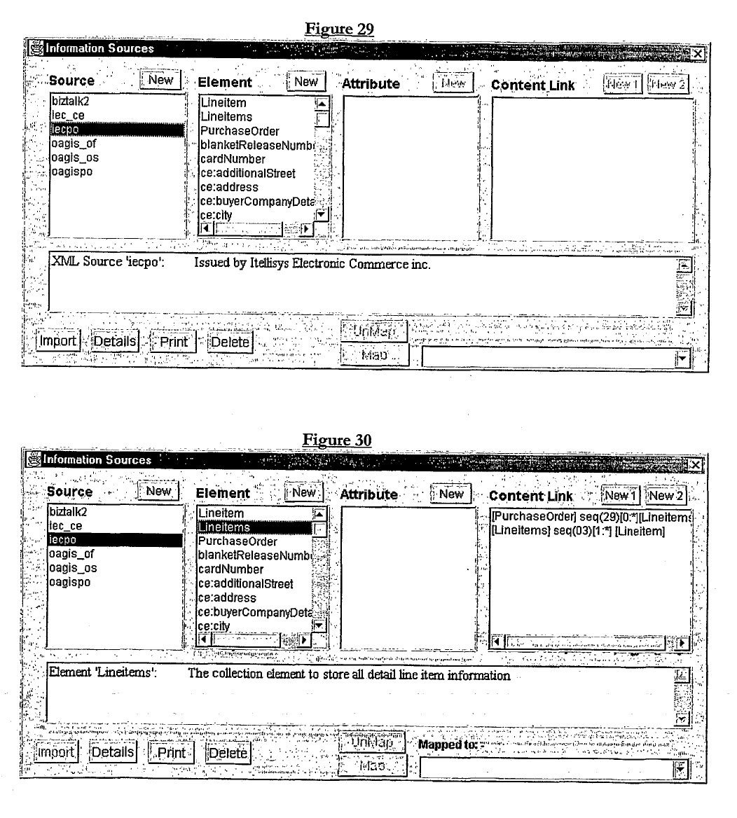

If you select any one of these elements, its attributes and content links will be shown in the dialogue box as in FIG. 30.

The element selected, ‘LineItems’, has no attributes; this is because the schema in question uses very few attributes, but represents most information as elements nested inside elements. The way they are nested is defined in the ‘Content Link’ column, which shows information extracted from the XML element content models defined in the DID or XDR file.

Content models define which elements can be nested immediately inside a particular element in an XML file, defining any constraints on the sequence, number and grouping of those elements. All that information is captured in entries in the ‘content link’ column. In this case, the two entries describe that:

‘LineItems’ occurs as one of a sequence of elements in the element ‘PurchaseOrder’, and it may occur zero or any number of times.

The ‘LineItems’ element may contain one or more ‘LineItem’ elements.

You need to understand something of how these ‘Content Link’ items relate to the content models in DTD or XDR files, because sometimes the content links represent business information, and you will need to record the fact that they do. An XDR-based notation is used for the name of each content link

Any schema can be completely removed by selecting the schema name in the ‘Source’ list, then choosing ‘Delete’. This will remove the schema, all its elements, attributes and content links.

When any Source, Element, Attribute or Content Link is selected in the ‘Information Sources’ dialogue, any description of the item which was provided in the XDR file will be displayed in the lower message area. If there is no description, or if you want to change it, you can select ‘details’ to display a dialogue which will enable you to change the description, or any other property of the item. Other than changing the descriptions, you will probably not want to edit the information imported from a DTD or XDR file in any other way, because it needs to match the DTD or XDR exactly.

The ‘Information Sources’ dialogue box enables you to display all information captured from a DTD or XDR file, and compare it with the (probably more familiar) original form. However, there is also a more useful graphical view of DTD or XDR information (which we will refer to as ‘schema information’) which is introduced in the next section.

11.3 Re-Capturing a Modified Schema

It may happen that you capture the schema (=DTD, XDR) of some XML language, and then spend some time defining how that language defines business information. You will do this by defining mappings from the XML schema onto the business information model, as described in Section 12 below. Then, having put considerable work into mapping a schema onto the business information model, you may find that the schema itself changes—for instance, its authors issue a new version.

In this case, when capturing the modified schema, you do not want to lose all the work you have put in defining mappings of the old schema onto the business model. If you simply deleted the old version of the schema and read in the new one, you would lose all these mappings and would have to re-do them.

In order not to lose the mappings, do not delete the old schema before reading in the new one. Then for any element, attribute or content model link in the XML whose name and description have not changed, XMuLator will preserve all the mappings you have previously defined.

Generally this will preserve most of the mappings you want to preserve. Of course, as the schema has changed, you will in general have to do some work in updating its mappings onto the business model. In particular, if you have moved some element around without changing its name (Le if in the new schema it is nested inside some element different from the one it was nested inside in the old schema) XMuLator does not yet detect this and you will need to modify the mappings by hand.

11.4 Tree Display of Schemas

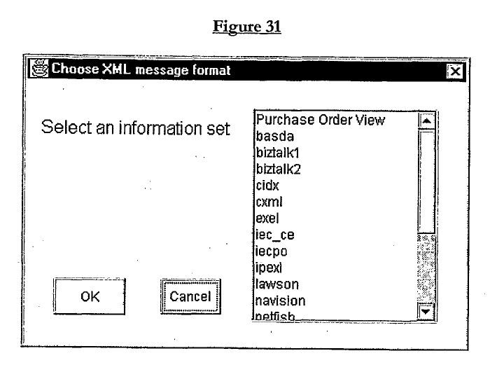

The dialogue boxes shown in the previous section are not the best way to display schema information. Select the menu option View/XML Source and you will be given a choice of sources to display as in FIG. 31.

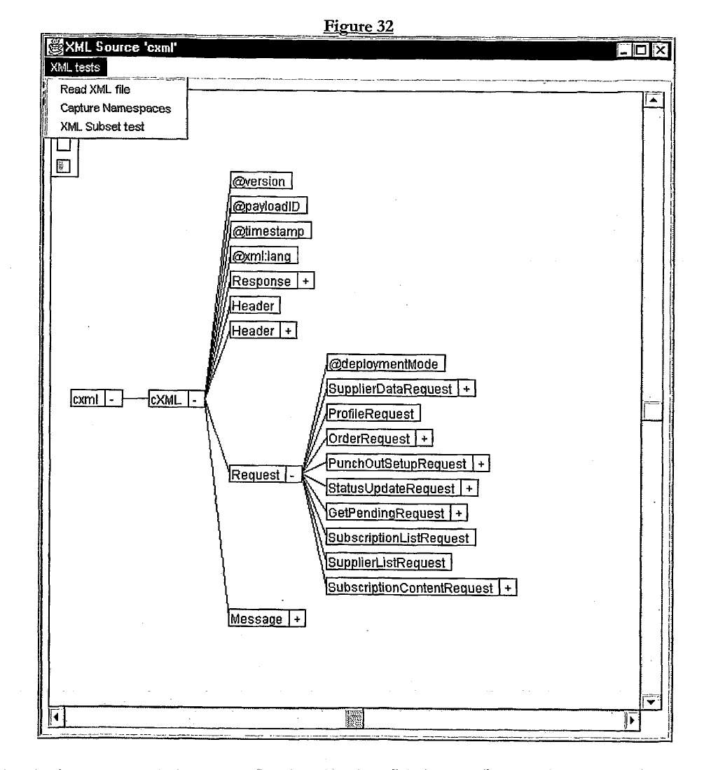

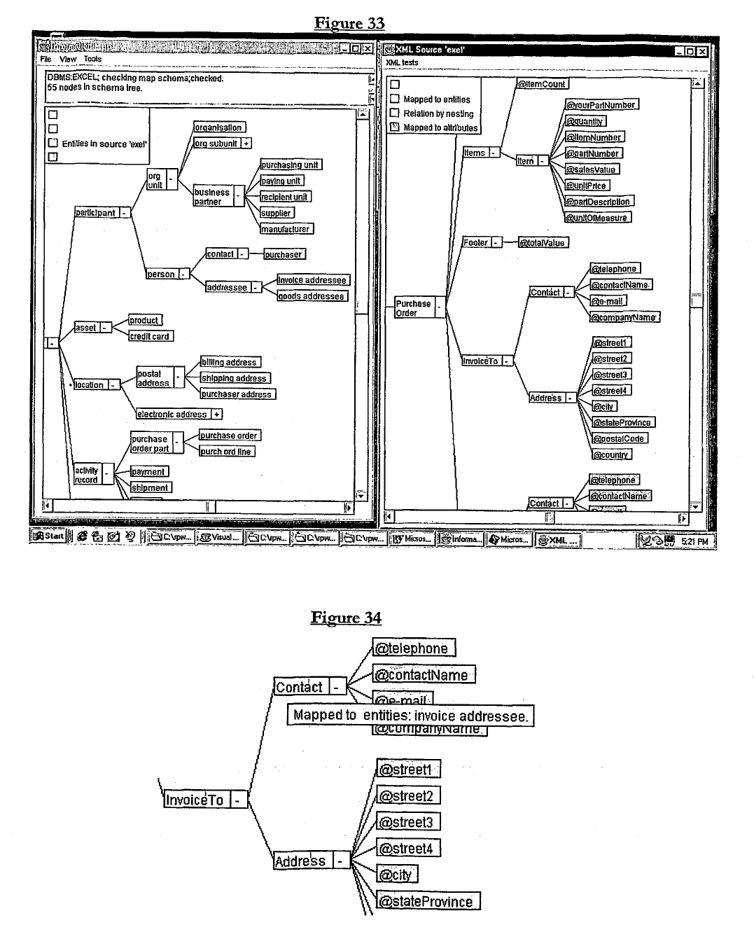

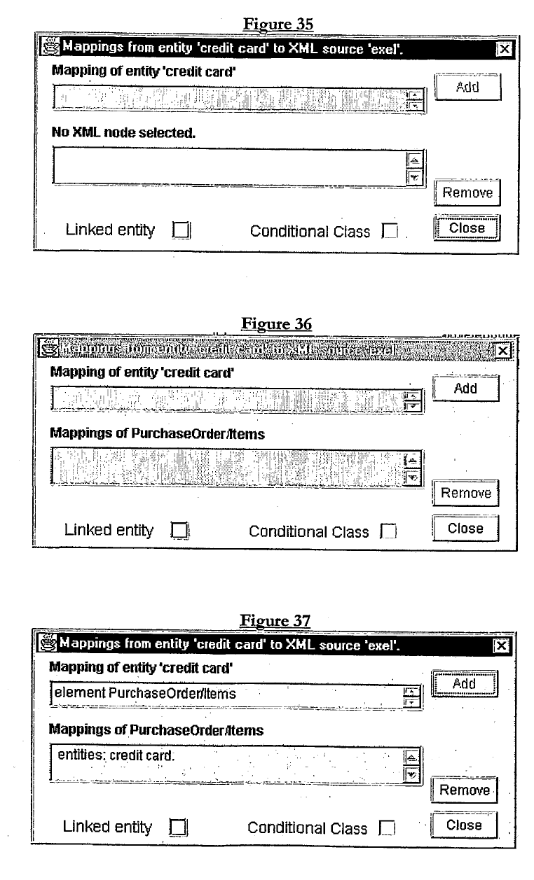

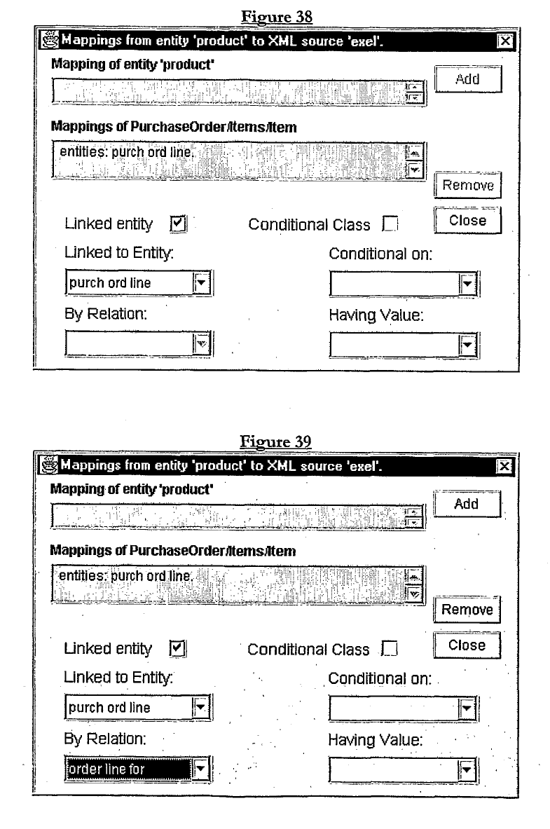

Choose one of these to display a tree diagram of the schema information extracted from the DTD or XDR file (see FIG. 32).

This display shows the elements, attributes and their nesting as defined in the DTD or XDR. As for the business information model, sub-trees can be expanded or contracted to zoom in on parts of the schema—which will often be necessary for the more complex schemas.

If an element occurs in several places—nested inside several other elements—then the element and its subtree will occur in all those places of the tree diagram (but avoiding indefinite expansion for self-embedded elements). Therefore the tree can have more nodes than are declared in the DTD/XDR.

Hovering the mouse over any element or attribute node will show any description which has been supplied for that node. Lines in the tree represent content model links, and the grouping/sequence constraints of a link can be displayed by hovering the mouse over it.

11.5 Capturing Namespace Information

In order to successfully transform a document from one XML language to another, you need to tell XMuLator about the namespaces used in each language. XSLT is namespace-aware, and needs to refer to the correct namespaces of elements and attributes.

Unfortunately, neither DTDs nor XDR will tell you all you need to know about the namespaces of XML documents. The DTD standard pre-dates namespaces. While an XDR does declare any prefixed namespaces for prefixed elements defined in the XDR, it does not tell you anything about default (un-prefixed) namespaces and does not define the scope of namespaces (i.e those namespaces, default or prefixed, which only apply to elements nested inside some other element).

Common XML documents use namespaces widely; for instance, there can often be several default namespaces in one document, with different scopes. Therefore XMuLator needs to know all namespaces, with or without prefixes, in order to generate the correct XSLT. You tell XMuLator about these namespaces by using a sample XML document which declares all the namespaces, both default and prefixed. XMuLator will then assume that these namespaces have scopes as in the sample document—i.e. that each namespace applies to elements and attributes nested inside the elements where the namespace has been declared in the sample document.

Currently the sample document must use the same namespace prefixes as in the XDR file, wherever the XDR file declares and uses prefixed namespaces. However, this does not mean that all documents to be translated must use the same namespace prefixes. XSLT matches prefixes to the namespace declarations individually in each document it translates, and identifies namespaces by URI, not by prefix.

In order to refer to elements which are in a default namespace in a document being translated, XSLT needs to add a prefix to those element names (otherwise, according to the XSLT standard, the elements would be assumed to be in the null namespace). XMuLator generates these prefixes automatically in both the namespace declarations and the element references in the XSLT. If there are several default namespaces in the same document, it generates distinct prefixes ‘def0’, def1’ etc. for them.

In order to inform XMuLator of the namespaces used in an XML language, obtain or prepare a sample document in that language, with a complete set of namespace declarations for both default and prefixed namespaces. Ensure namespace prefixes match those in the XDR. Display the schema tree for the language as above, then use the menu option ‘Capture Namespaces’. This will display a file selection dialogue to select the sample file, which is then read to capture the namespace information.

12. Recording How XML Represents Business Information

12.1 How XML Can Represent Business Information

Business information consists of classes (of entities), attributes and relations. Each of these parts of the business information model can be represented in an XML language, and can be so represented in a variety of ways. It is this variety of the ways in which XML can represent business information which makes the XML transformation problem difficult. Two different languages may represent the same business information in different ways, and it is necessary to transform between them while preserving the underlying business information.

Note that the information in an AL schema (DTD or XDR)—which is captured automatically by the tool, as described in the last section—says absolutely nothing about how the XML represents business information. DTDs and XDR files capture XML syntax, not semantics. Semantics is usually in the eye of the beholder, implied by suggestive element tag names or attribute names, and (occasionally) by explanatory comments in a DTD or XDR file. But semantics is what you now need to capture. XMuLator gives you simple dialogue-based tools to do so, but first you must understand the concepts.

There are many ways in which XML can represent business information. XMuLator does not understand (and so cannot translate) every conceivable one of these ways—all the ways in which XML might be used to represent entities, attributes and relations. However, it does understand those ways which are used in the majority of widely-used XML languages today, and which are arguably the most sensible ways to represent business information in XML.

Terminological note: Unfortunately there are rich possibilities for terminological confusion between (a) business model entities and XML entities, and (b) business model attributes and XML attributes. XML entities are hardly used in this manual, so ‘entity’ always refers to a business model entity which is of some class in the business information model. I shall try to resolve any ambiguity in the usage of the term ‘attribute’ wherever possible.

12.1.1 How XML Can Represent Business Model Entities

The most important way to represent a business model entity is by an XML element. Then the structure of the entity can be represented by structure (attributes and nested elements) typically inside the element which represents it. In this form of representation, all entities of a given class are represented by elements of a given tag name.

It might be possible to represent an entity of some class in the business model by an XML attribute attached to an XML element. However, it is generally not useful to do so—as you would then have to ‘pack’ all the attributes of that entity inside the one XML attribute. This goes against the spirit of using XML structure to represent the structure of the domain. So XMuLator does not support representing business model entities by XML attributes.

You might think that there should be a 1:1 mapping between XML element types and business model entity/classes, so that any XML element type can represent at most one business model entity type, but this is not so. It often happens that one XML element type represents more than one entity type in the business information model. There are two main reasons for this:

1. Many XML languages are, in relational terminology, heavily de-normalised; so that one XML element can carry information about many different types of business model entity at the same time. For instance, in an XML element representing a purchase order, the designers of the language may have chosen to carry several attributes of the customer—although ‘customer’ is clearly a distinct type of entity. In these cases, there must always be a ‘base entity’ which the element represents first; then it can also represent any number of types of ‘linked entities’, as long as each one of them is related by an M:1 or 1:1 relation with the primary entity. Then the element represents the base entity and up to one of each type of linked entity. (If there were more than one of some type of linked entity, each one would need to be represented by some nested element with sub-structure. That is a separate case.) In the example above, the base entity is ‘purchase order’. Every purchase order is for just one customer (an M:1 relation) so customer attributes can be packed into the purchase order element; customer can be a linked entity represented by the same XML element.

2. It is possible to use one XML element type to represent several distinct type of business model entity, using some kind of ‘switch’ or ‘flag’ within the XML element instance to say which particular entiy type it is representing. For instance, in the OAGIS XML model, there is an element ‘PARTNER’ which can represent several different types of business partner—supplier, customer and so on. There is then an element nested within the ‘PARTNER’ element to say which kind of business partner it is. In the business information model, all these classes of business partner will probably be subclasses of a class ‘business partner’.

XMuLator currently supports the first of these cases (linked entity types). How it does so is described in more detail below. It is being extended to handle the second case.

12.1.2 How XML Can Represent Business Model Attributes

There are two main options for representing the attributes from the business information model in XML. You may represent them as X attributes, or you may represent them as XML elements. Both of these options are in common use.

When using elements to represent business model attributes, one ‘natural’ choice is to have those elements nested immediately inside the element that represents the entity. For instance, if the element <per> represents the entity ‘person’, and a person has attributes ‘name’ and ‘age’, represented by XML elements <pName> and <pAge>, then perhaps the most natural form of the XML is as in the example:

<per>

<pName>Fred</pName>

<pAge>40</pAge>

</per>

Here the attribute-representing elements are nested immediately inside the entity-representing element <per>. This is the most natural form, but it is not the only possible form. The element representing an attribute of an entity need not be immediately inside the element representing the entity. In fact it could be anywhere in the document, provided there is a well-defined way to get from the entity-representing element to just one attribute-representing element for that entity, so the value of any attribute is uniquely defined for each entity (as it must be). There are several ways to do this, as well as immediate element nesting. The two most common of these are both recognised by XMuLator:

XML often represents ‘detail’ entities, which cannot exist independent of some ‘master’ entity, as elements nested inside the element for the master entity. In this case, a vital part of the identity of any ‘detail’ entity is the ‘master’ entity’ it belongs to. For instance, a typical purchase order has a number of order lines. An important attribute of an ‘order line’ is the order number of the ‘purchase order’ it is a part of. This attribute is generally not repeated inside each ‘order line’ element, but is held just once in the ‘purchase order’ element So the attribute occurs outside the ‘order line’ element.

Many XML-based languages include element tags whose main purpose is to make the structure of the XML clearer, by grouping together, for instance, attributes of similar purpose (where one entity may have dozens of different attributes). I refer to these elements, which do not convey business information, as wrapper elements. Because of the wrapper elements, attribute-representing elements may not be immediately inside their entity-representing elements, but may be more deeply nested.

<staffMember>

<general>

<name>Joe Smith</naine>

<sex>male</sex>

</general>

<employee>

<staffNo>4567</staffNo>

</employee>

</staffMember>

In this example, the attributes of the ‘staff member’ entity are grouped into ‘general’ attributes and ‘employee’ attributes, both represented as elements. <general> and <employee> are wrapper elements.

There are also more other ways to store attributes remote in the document from the element representing an entity—for instance, using id and idref attributes to point at some remote element—but XMuLator does not yet support these.

Similarly, when business model attributes are represented as XML attributes, the ‘natural’ choice is to make them attributes of the XML element which represents the entity. This makes for simple and compact XML:

<staffMember name=‘Joe Smith’ sex=‘male’ staffNo=‘4567’/>

This is the natural choice, but it is not the only choice. For ‘detail’ entities like order lines in a purchase order, some attributes may be stored as XML attributes of the element which represents the ‘owner’. This type of remote attribute is recognised by XMuLator.

12.1.3 How XML can Represent Business Model Relations

Relations are like the bone structure of a business information model—without them it would just collapse in a heap on the floor. Unfortunately, there is a wide variety of ways in which XML can represent relations, and several of these ways are in widespread use. Understanding them is essential for sound XML translation between languages. That is the main reason why XML translation is not just a matter of substituting equivalent tag names.

There are four main ways in which XML-can represent relations:

1. By nesting of elements inside one another

2. By ‘de-normalisation’—if several linked) entity types are represented by the same XML element, that element also represents the linking relations between the entities

3. By shared values of business model attributes (which may be represented either by XML elements or XML attributes)

4. By idref and id attributes, which act as pointers within an XML document.

5. By some other elements, separate from the elements which represent entities, representing the relations between the elements.

At least four of these representations are in common use. (1) and (2) are popular in hand-written XML schemas, and (3)-(5) typically occur in automatically-generated XML schemas (e.g. from relational databases). XMuLator currently handles all of methods (1)-(4). (5) can often be regarded as a special case of (3).

First, XML can represent a relation by the nesting structure of the elements themselves. For instance, if a teacher may teach several courses, but each course is taught by just one teacher, then it is clear and acceptable to nest the elements representing ‘course’ inside the elements representing ‘teacher’:

<teacher name=‘John Brown’>

<course courseName=‘French’/>

<course courseName=‘Greek’/>

<course courseName=‘Italian’/>

</teacher>

Here, we say that the relation is represented by the content model link between ‘teacher’ and ‘course’ elements. This way of representing relations is only open for relations of constrained cardinality 1:M or 1:1. For many-to-many relations it might involve repeating the whole content of several entities—for instance, repeating the ‘course’ element for every teacher that may teach it. Generally, people do not like to do this, and other representations are used for many-to-many relations.

Second, XML can represent a relation between two or more entity types by de-normalising—collapsing the entity types into the same element. For instance in an XML representation of a purchase order, a single purchase order line may be represented as:

<order_line>

<lineno>3</Iineno>

<qty>200</qty>

<required_by>2/10/2000</required_by >

<prod_code>2146</prod_code>

<prod_descr>large widget</prod_descr>

<mfr_namne>WidgCo</mfr_name>

<mfr_city>Chicago</mfr_city>

</order_line>

Here, the one element <order_line> contains information about the order line itself (e.g. the quantity, and the date it is required by), about the product involved in the order (the product code and its description) and finally about the manufacturer of the product. It therefore implicitly also contains information about the relations [order line] is-for [product] and [product] is-manufactured-by [manufacturer].

(Why do we not say that product and manufacturer are each represented by some element nested inside <order_line>? Because there are several distinct elements describing the product, and they are not grouped together in any way; so there is no clear choice of which one ‘really’ represents the product. Rather than choose one of <prod_code> or <prod_descr> as the ‘main’ element representing product, we choose to say the <order_line> also represents product, with the attributes of product represented as nested elements).

De-normalisation is only appropriate when the cardinality of the linking relation is M:1 in the (base=>linked) direction. In the example above, if there were several products per order line, or several manufacturers per product, they would have to be represented by nested elements with attributes nested inside these elements—in order to group the attributes of one product or manufacturer together unambiguously.

Third, XML can represent business model relations by having shared values of business model attributes in the representation of the entities involved in the relation. This is much like the way in which many relations are represented in relational databases, as ‘foreign keys’. Each foreign key is a set of attribute values, which constitutes a unique identifier for the entity at the other end of the relation.

There are choices as to how and where the business model attributes (which embody the relations) are represented:

They may be held in element A, or element B, or redundantly in both

They may be stored as entities nested in A or B, or as attributes of A or B

Storing foreign keys as elements, you may store several distinct keys (relation instances) within one element, or you may have one element per foreign key. Using attributes, you only have the first choice.

Multiple elements representing instances of a relation may be packed up in a wrapper element

If a foreign key consists of several business model attributes, the values of these attributes may be packed into one XML element or attribute (e.g using some separator character) or may be held in distinct attributes or elements

Fourth, XML can represent a relation between entity A and entity B by idref-to-id pointers between the element representing A and the element representing B. There are several choices open about the nature of these pointers:

They may be held in element A, or element B, or redundantly in both

They may be stored as attributes of A or B, or as attributes of special elements within A or B

One attribute may hold several idrefs, or there may be several nested entities each with a single-idref attribute

The many different combinations of these choices constitute a large number of distinct ways of representing any given relation. These techniques can be used for many-to-many relations, but can equally be used for 1:many or 1:1 relations. Some of them are illustrated below, for the many:many relation ‘student’ attends ‘course’:

<student name=‘Fred’ attends=‘French Latin’/>

<course courseName=‘French’ attendees=‘Fred Henti Joe’>

<student name=‘Fred’>

<attends>French</attends>

<attends>Latin</attends>

</student>

<course name=‘French’ id ‘19607’>

<course name=‘Latin’ id=‘20431’>

<student name=‘Henri’ attends=‘19607 20431’/>

<course>

<name>French</name>

<attendees>

<attendee>Fred</attendee>

<attendee>Joe</attendee>

</attendees>

</course>

Finally, the relation may be stored outside both elements A and B, in separate relation-bearing elements:

<student name=‘Fred’>

<student name=‘Joe’>

<course courseName=‘French’/>

<course courseName=‘English’/>

<attendance student=‘Fred’ course=‘Latin’ term=‘Lent’/>

<attendance student=‘Joe’ course=‘French’ term=‘Summer’/>

This last can be regarded as a special case of the previous cases—where ‘attendance’ is an entity class in its own right, which has and M:1 relation to ‘student’ (each student has several attendances) and to ‘course’ (each course has several attendances).

This discussion has not exhausted all the ways in which business model relations can be represented in XML, but it has covered the ways used by most common XML based languages. On a first pass, it seems complex; but in practice you soon come to know the techniques in most common use, and how they can be captured in XMuLator.

The XMuLator tool can capture these ways of representing relations, and can generate XSL translations between them. For it to do so, you need first to record how each XML language represents the business model entities, attributes and relations, as described in the next sub-section.

12.1.4 Id Attributes

It is quite common in XML documents to represent relations by ‘idref’ or ‘idrefs’ attributes, which point to ‘id’ attributes. You should be aware of the assumptions XMuLator currently makes about id attributes.

The purpose of an id attribute in an XML document is to be pointed at by idref or idrefs attributes in the same document—which represents a relation between the element owning the idref and the element owning the id. Therefore XML requires that an id attribute value should be unique in the document.

In the general case, therefore, it may be unsafe to use an id attribute to convey any other meaning. For instance, if an XML document describes people (who have unique names) and cars (which also have unique names), you could not use id attributes to represent both these names, just in case some car turns out to have the same name as some person. It is safer to create id attribute using element-specific prefixes such as ‘person-Fred’ or ‘car-Ford’ to avoid collisions.

In specific cases it may be safe to use an id attribute to convey other information, and language definers sometimes do so. However, XMuLator does not yet support these cases. It assumes that an id attribute exists solely to support links in the document, and is not mapped to any business model attribute (However, XMuLator does not yet enforce this constraint!)

XMuLator may have to generate transformations from a language which does not use id attributes to a language which does. It can only do so if the element which has the id attribute in the output XML represents an entity class in the business model, and where the input XML represents some set of unique identifier attributes of the class. In this case the XSLT generated by XMuLator will create the id attribute value by concatenating the class name with the values of the unique identifier attributes. This creates a string such as ‘person-Fred’ which is guaranteed to be unique in the document.

In summary, XMuLator assumes that

1. Id attributes are used solely for representing business model relations

2. An id attribute does not represent any business model attribute

3. XMuLator may generate values for id attributes in any way it likes, as long as the appropriate idref or idrefs attributes have the same value to point at the right id.

12.2 Recording How an XML Language Represents Business Information

12.2.1 Overview of the Process

The records of how an XML language represents business information are called ‘mappings’. They are mappings between pieces of XML syntax and pieces of business model semantics. Thus, for instance, if a certain XML element represents some entity/class in the business information model, we say there is a ‘mapping’ between the element and the entity. This section describes how to create and view these mappings—for business model entities, attributes and relations.

These mappings between XML and the business information model are subject to a number of ‘Mapping rules’ which will be described over the next few pages. For convenience these mapping rules are collected together in Appendix B. Many of the mapping rules are enforced automatically by XMulator; for others, warnings are provided when they are violated/

Since the mappings involve both the business information model and the XML schema, you will need to have both of these visible in XMuLator when making the mappings. The tool provides a graphical view of an XML schema (=DTD or XDR), which can be seen using the menu option View/XML Source and then choosing a schema in the dialogue box which follows.

It is then worth arranging the screen so you can see a good part of both the entity class hierarchy and the XML nesting structure, on different halves of the screen as shown in FIG. 33.

Here, the colour highlighting facilities have been used to show what mappings there are already between the XMLschema and the business model, showing them in both directions. Hovering over any node in the XML window can show you what it is mapped to in the business model (see FIG. 34).

Here the mouse pointer (not shown) is over the element ‘Contact’.

As well as having these two windows open, it is also adviseable to have a copy of the XML schema definition (DTD or XDR) in text form, which should be familiar to you, and preferably also to have one or two examples of the XML conforming to this schema. These will help to remind you what the AL structures mean. Because of the premium on screen space, they may well be paper copies.

Logically you need to map business model entities to the XML source before you can map the relations or attributes of those entities. Otherwise there are few constraints on the order of doing things.

12.2.2 Mapping Business Model Entities

To record that an element in the XML represents an entity in the business model, proceed as follows: First click on the business model entity in the ‘Information Map’ to show a pop-up menu and choose the menu item Map/Entity. This will show a dialogue box as in FIG. 35.

This dialogue box, like those for attribute mappings and relation mappings, has two main text areas at the top and the middle—the top area to describe the current mapping status of the selected object in the business information model, and the middle area describing the mapping status of the currently selected XML object. For all these mapping dialogue boxes, there is a colour convention for the text areas:

Green if the object selected is ready to be mapped

White if no object has been selected

Grey if the object selected cannot be mapped (e.g. because any business model entity, attribute or relation can only be mapped to one thing in any XML source)

Light Blue if the two object selected are mapped to each other.

The dialogue is saying ‘No XML node selected’ (and has a white text area) because you have not yet selected the XML element which represents this entity. If you now select some element in the window for the XML source ‘Exel’ this dialog will change to FIG. 36.

Since both text areas are green, you can now (if you wanted to—this is an artificial example) create a mapping between the entity and the element, by pressing the ‘Add’ button which is now enabled. Doing so changes the dialog box to FIG. 37.

The light blue colouring shows that the selected entity and the selected element are mapped to each other. Alternatively, you could select the XML element before selecting the entity; but still the mapping is made from the same dialogue box.

Whenever XML elements or attributes are described in the upper text area, they are defined by the path of elements from the root of the document, separated by ‘/’ characters.

Use the ‘Remove’ button to remove any existing mapping in order to change the mapping.

Note that when selecting an element to map to on the XML schema diagram, you may see several copies of the same element at different parts of the schema diagram—with different paths from the root element of the document. For instance, an ‘address’ element may occur in several places, as a billing address, a delivery address, and so on. Be careful to choose the right address element for each case.

Because each entity class in the business information model can only be mapped to one element in the XML, it is not sufficient in the business information model to have just one ‘address’ class if there are several different addresses represented in the application domain, and in the XML which supports it. The way to handle this is to define sub-classes of ‘address’ to represent the different kinds of address—billing address, delivery address and so on. You are always free to define these additional sub-classes, and they will inherit all attributes and relations from the superclass.

12.2.3 Mapping Linked Entities

When the XML represents several business model entities in the same element (de-normalisation, or linked entities) the mapping process is a bit more complex. This is a frequent case in published XML schemas.

For every set of linked entity classes mapped to the same element, there has to be one ‘base’ class. This means that whenever the element is present, there is an entity of the base class present—even though there may not be entities of every class linked to it in the element.

To map the base entity class to the element, proceed as before. XMuLator will assume that the first entity class you map to any element is the base class for that element. (If you do the wrong class first, undo them all and start again).

Then when you come to map any other entity class to the same element, XMuLator will assume that this is to be a linked class. It will show a more complex entity mapping dialogue box (see FIG. 38).

Note that the ‘Add’ button is not yet enabled, so you are not yet ready to add the mapping. To map a linked entity, you need to define what other entity it is linked to, and the linking relation.

Here, the entity class ‘product’ is to be mapped to an element which already represents the class ‘purch ord line’. In this case, ‘product’ can only be linked to the class ‘purch ord line’; but if there were already other linked entities, ‘product’ might be linked either to the base entity or to one of the linked entities. You use the ‘linked to Entity’ selection box to choose which one.

Once having chosen an entity class to link to, you need to choose a linking relation. A particular ‘product’ cannot appear in the same element as a ‘purch ord line’ unless there is some relation between them in the business information model. The ‘By Relation’ choice box gives you a selection of the eligible relations in your business model to choose from—even though there is typically only one possible linking relation between the two relevant classes. Once you have chosen both the entity to link to, and the linking relation, XMuLator empowers you to add the mapping as in FIG. 39.

In this way one XML element can be made to represent a number of linked classes-linked by a tree of linking relations which is rooted at the base class. Relations and attributes of the base class and all the linked classes can be represented by other structure inside this element. The functionality associated with ‘Conditional class’, ‘Conditional on’ and ‘Having value’ concerns elements which may represent entities of different classes depending on the value of some attribute, and has not yet been implemented.

12.2.4 Mapping Business Model Attributes

XMuLator requires that you define how any entity class is represented before you can define how any of its attributes are represented. Subject to this constraint, to record that some business model attribute is represented by some XML element or attribute, proceed as follows: Click on the entity whose attribute you want to map, and choose the pop-up menu option Map/Attributes to display a dialogue box as in FIG. 40.

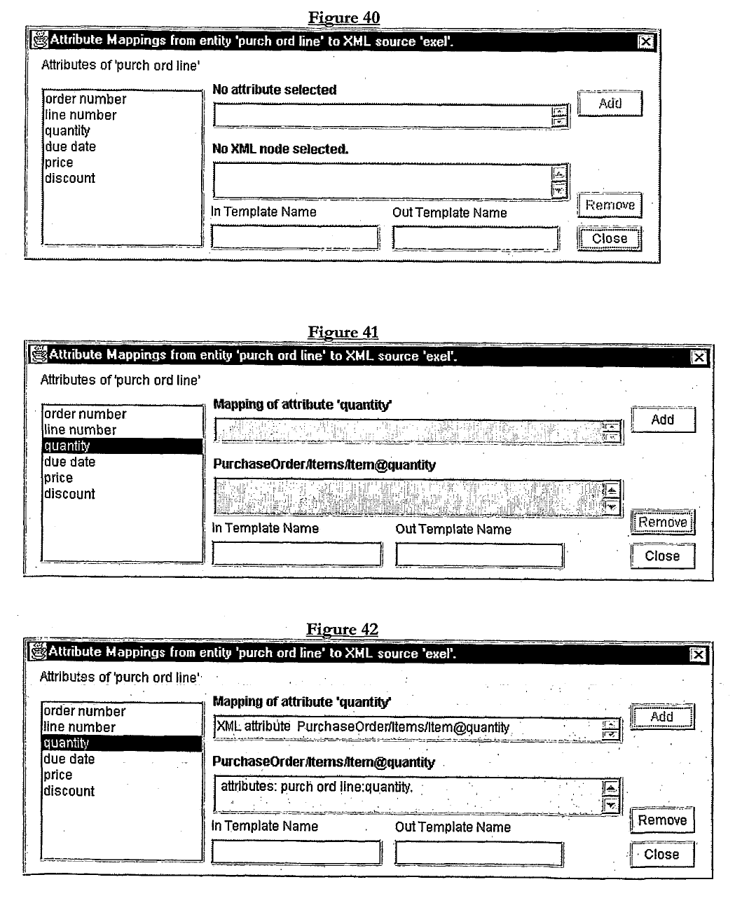

Now select the business model attribute you want to map (from the right-hand menu of this dialogue) and the XML entity or attribute you want to map to it (from the XML schema tree). The dialogue box will change to FIG. 41.

The two text boxes ‘In template Name’ and ‘Out Template Name’ are to be filled in if the XML language uses some different representation for the attribute values from the representation defined in the business model. In this case it is necessary to supply an XSLT ‘In template’ to convert from the values used in the XML to the values used in the business model, and an ‘Out template’ to convert in the opposite direction. Each template should have one parameter, named ‘p1’, to represent the value it is given to convert, and should return the converted value. The templates may include calls to Java classes or other extension mechanisms to make the required conversions, or may be pure XSLT. XMuLator will include these templates and the calls to them as appropriate in the XSLT which it generates.

For instance, if the business model has an attribute ‘day_of_week’ with values ‘Sunday’, ‘Monday’ and so on, and some XML language represents these by integers 1, 2, . . . 7, then the In template could be of the form:

<xsl:template name=“inttotext”>

<xsl:param name=“p1”/>

<xsl:choose>

<xsl:when test=“$p1=‘1”>Sunday</xsl:when>

<xsl:when test=“$p1=‘2’”>Monday</xsl:when>

<xsl:when test=“$p1=‘3’”>Tuesday</xsl-when>

<xsl:when test=“$p1=‘4’”>Wednesday</xsl-when>

<xslwhen test=“$p1=‘5’”>Thursday</xsl-when>

<xsl:when test=“$p1=‘6’”>Friday</xsl:when>

<xsl:when test=“$p1=‘7’”>Saturday</xsl-when>

<xsl:otherwise>day not recognised</xsl:otherwise>

</xsl:choose>

</xsl:template>

Similarly the Out template could be of the form

<xsl:template name=“texttoint”>

<xsl:param name=“p1”/>

<xsl:choose>

<xsl-when test=“$p1=‘Sunday’”>1</xsl-when>

<xsl:when test=“$p1=‘Monday’”>2</xsl-when>

<xsl:when test=“$p1=‘Tuesday’”>3</xsl:when>

<xsl-when test=“$p1=‘Wednesday’”>4</xsl:when>

<xsl-when test=“$p1=‘Thursday’”>5</xsl-when>

<xsl-when test=“$p1=‘Friday’”>6</xsl-when>

<xsl:when test=“$p1=‘Saturday’”>7</xsl:when>

<xsl:otherwise>day not recognised</xsl:otherwise>

</xsl:choose>

</xsl:template>This simple form of ‘switch’ template will be sufficient for many data type conversions, with appropriate changes of switches and values.

Template names should be unique within any XML language, although the same template may be used deliberately to convert values of different attributes. XMuLator will add a ‘mode’ parameter to deal with any name clashes between templates defined for different XML languages (or other templates for converting between attributes in the business model—see section 10.6).

In the most general case, therefore, XMuLator will call a template to convert from the input XML value to the business model value, and another to convert from the business model value to the output XML value. In between, it may also call a template to convert values within the business model—for instance if the input XML represents a name as one ‘Full Name’ and the output XML represents it as three attributes ‘First Name’, ‘Middle Initial’ and ‘Surname’. In this case all four attributes can be represented in the business model, with the conversions between them (see section 10.6).

If both the ‘In template’ and ‘Out template’ fields are left blank, XMuLator assumes that the XML language uses the same representation for attribute values as are defined in the business model, and does no conversion. If one of these fields is left blank, XMuLator assumes there is only a conversion available in one direction.

To change the name of a template used in an attribute mapping, you need to remove the mapping and then add it again with the new template names.

All conversion templates for a given XML language must be supplied in one XSLT file for that language. You will be asked to open this file before XMuLator generates any translations to or from that language. Having filled in all fields to define the attribute mapping, click the ‘Add’ button, and the mapping will be made, changing the dialogue box appropriately to FIG. 42.

As for entity mappings, the XML attribute ‘@quantity’ is defined precisely by the path from the root element of the document to that attribute. There may be several attributes with the same name, with different paths and different business meanings.

You can map several attributes, or can remove any existing attribute mapping, before you close the dialogue box.

Typically, if a business model attribute of an entity is represented by an XML attribute, it will be an XML attribute of the element which represents the entity. Similarly, if a business model attribute of an entity is represented by an XML element, it will typically be an element nested somewhere inside the element representing the entity. In this way, each instance of the entity can have its own unique value for the attribute. However, the representation of a business model attribute is not always ‘inside’ the representation of the owning element—particularly when several entities are known to have the same value of some attribute. For instance, if ‘purchase order line’ entities have an attribute ‘order number’ which is the same for all order lines in the order, then that attribute can be stored outside the elements representing order lines—and indeed probably will be, to avoid duplication.

Wherever a business model attribute is represented in the XML, it should be in a place such that there is a unique path from the element representing the entity to the place representing its attribute—to give a unique value to the attribute. However, when you create the mapping for the attribute, no check is made for a unique path. Such checks are made later when the mapping is used to generate an XSL transformation, and if they fail, a warning message will be produced then.

12.2.5 Mapping Business Model Relations

Recall that there are five main ways of representing business model relations in XML:

1. By nesting of elements

2. By de-normalisation—representing several entity classes in one element

3. By storing shared values of some attributes in both entities involved

4. By using ‘idref’ and ‘id’ attributes as pointers within the XML document

5. By separate elements, outside the elements representing entities, which represent the relation information.

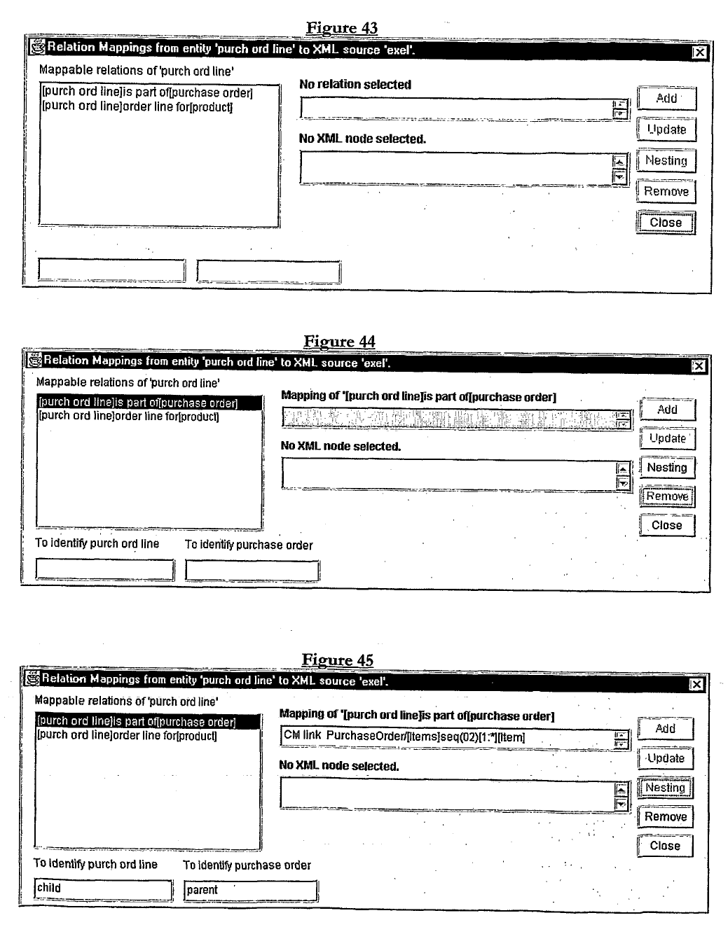

In all cases, to map some business model relation (denoted by [A]R[B]), select one of the two entities A and B involved at the ends of the relation, and choose the popup menu option Map/Relations. This will show a dialogue as in FIG. 43.

As it does for attributes, XMuLator will not allow you to represent any relation before you have represented the entity classes at both ends of the relation. When you open the ‘Map/Relations’ dialog for any entity class, the tool will show on the left all the ‘Mappable relations’ of the class. These are all relations in the business model which involve the class itself and any other class which has been mapped to the current XML source. Typically many of these relations are inherited from more general superclasses.

A relation such as ‘person owns car’ will have several relation instances such as ‘Fred owns Ford Sierra’, ‘Joe owns Jaguar’ and so on. Each one of these relation instances is represented by some part of an XML document—an element, attribute or content model link. Whatever the relation instance is represented by, it needs somehow to identify the two entities (instances of the classes) at either end of the relation—which are themselves represented by elements in the document. It can do this in a wide variety of ways, as described above. Sometimes identifying the entity is simple—for instance if it is represented by the element containing the element or attribute which represents the relation instance. Sometimes it is more complex, as when shared attribute values are used; the entity must be found on the basis of the attribute values. XMuLator defines ‘how a relation instance identifies its two entity instances’ using target functions—functions which find the target entity. The two grey boxes at the bottom left of the mapping dialogue are always to be filled by the target functions for the two entities, as will be described below.

We shall describe mapping representations of relations in the order (1)-(5) above. The first two are simple to map, while the others are more complex.

In order to map any relation, first open a relation mapping dialogue box for either of the entity classes involved, then select the relation you want to map.

Relation represented by nesting: If the relation you have selected can be represented by nesting of elements, then the ‘Nesting’ button will be enabled as shown below in FIG. 44.

Just press the ‘Nesting’ button to represent the relation by nesting, with result: FIG. 45.

The upper text area goes from green to grey to indicate that the relation has been mapped. It has been mapped to the content model link which immediately contains the inner element representing one of the entities. The two target functions have been filled in automatically, to say that one entity is identified as the child of this content model link, the other as the parent (although in fact any ancestor will also do; the inner element may be deeply nested inside the outer element).

The naming of the content model link in the grey text area need not concern you, as it is only used internally by XMuLator. It consists of the path of elements from the root node of the document down to the content model link, followed by a string seq(02)[1:*] which defines the sequencing and cardinality constraints of the link, followed by the element inside the link.

A relation [A]R[B] between two entity classes A and B can be represented by nesting when the following conditions apply:

The element which represents B is nested (either directly or indirectly) inside the element representing A—or vice versa.

If the nesting is indirect, with one or more intervening elements, none of those intervening elements represents any entity class.

The entity represented by the inner element must be a base entity class for that element, not one of its linked entity classes

No other relation to the entity represented by the inner element must have been represented by nesting.

These conditions are all enforced by XMuLator. In fact, when they do apply, XMulator does not allow you to represent the relation in any other way. This is because for every entity represented by an element nested inside an element representing another entity, there should be some relation between the two entities, which justifies the nesting. There would be no point in nesting the elements if there were no meaningful relation between the entities they represent.

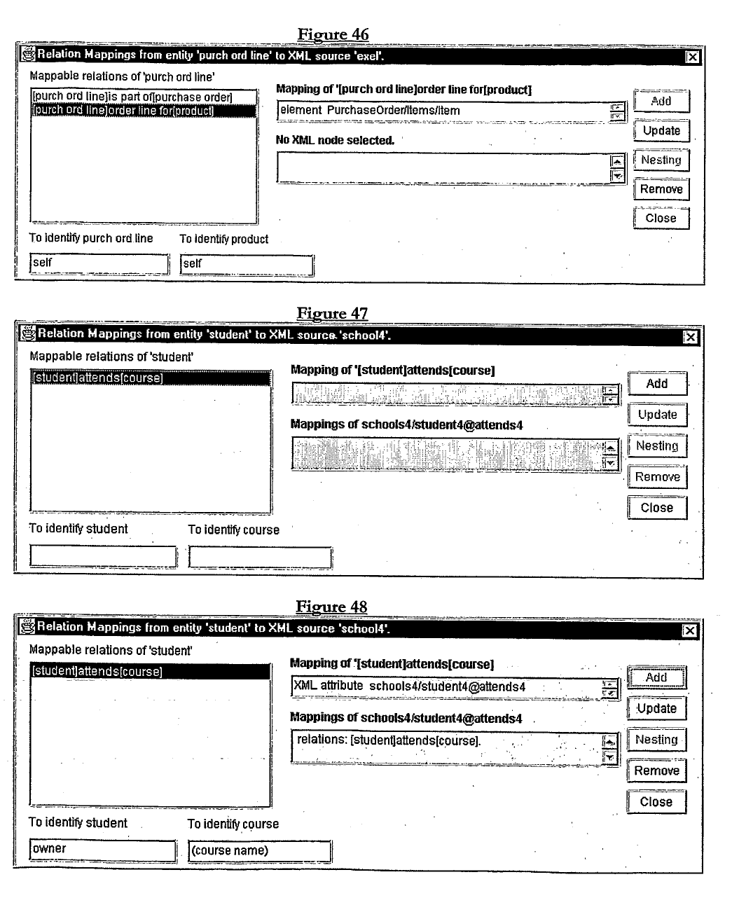

Relation represented by de-normalisation (linked entities): When two or more entities are represented in ‘de-normalised’ fashion by one XML element, there is even less to do—as you have already defined the linking relation and how it is represented when you defined the linked entity representations (above). However, if you select one of these linking relations, XMuLator will show in the dialog box how it is represented, as seen in FIG. 46.

This tells you that the same element ‘Item’, which represents the two entities ‘purch ord line’ and ‘product’, also represents their linking relation. The two target functions are ‘self’—meaning that to get from the relation instance to either entity instance, you do not have to move in the XML document at all.

Relations represented by shared values of business model attributes: In this case, the XML element representing one entity contains an element or attribute whose purpose is to represent the relation. This element or XML attribute contains the values of some business model attributes which uniquely identity the entity(s) at the other end of the relation. For instance, the elements <person name=“Robert’” owns_car=“K164FEG”> and <car reg=“K164FEG”> represent a person, a car and a relation of ownership—an instance of the relation [person]owns[car].

The relation may be represented either by an XML attribute, or by a nested entity; and there are important sub-cases to consider.

The relation may involve just one target entity per starting entity (cardinality 1:1 or M:1), or it may involve several target entities per starting entity (cardinality 1:M or N:M)

The target entity may be uniquely identified by the value of just one attribute, or of several attributes taken together

These different possibilities are handled by different values of the target functions, which you need to know about and type in to the lower left ‘To identify . . . ’ text areas (there is no menu-selection of target functions yet).

Take first the simple case of an XML attribute which represents a relation to a single entity identified by just on of its attributes, as in the example above. For an attribute to represent a relation in this way, it must be an attribute of type ‘CDATA’. To capture this mapping, first select one of the entity classes involved in the relation, and use the menu item Map/Relations to show the relation mapping dialogue as before. Next select the attribute which will represent the relation, and it will be shown in the relation mapping dialogue as in FIG. 47.

Now all that remains to be done is to fill in the target functions before mapping the relation. These describe how, starting from the attribute ‘attends4’ which represents the relation, you can find the two entities at either end of the relation, for each instance of the relation.

The student involved in this instance of [student] attends [course] is represented by the element ‘student4’ which ‘attends4’ is an attribute of. So the target function is just ‘owner’, to find the element that owns this attribute.

The course involved in this instance of [student] attends [course] is the course whose (business model) attribute ‘course name’ matches the value of the XML attribute ‘attends4’ which represents the relation. In this case the target function is then (course name).

Filling in the two target functions and pressing ‘add’ gives result as shown in FIG. 48.

In this example, a student can only attend one course whose name is given by the attribute. If the student may attend several courses, denoted by different course names within the same attribute, then the appropriate target function would be (course name*).

If the target entity cannot be identified by just one business model attribute, but is uniquely identified by several attributes in combination, then the XML attribute which represents the relation must hold these different business model attributes concatenated in some way. Typically this will be done using some separator character which is known not to occur within the attribute values themselves. XMuLator needs to know the names and order of the business model attributes used, and the separator character. This is done by using a target function such as (group/name) which indicates that the attributes are ‘group’ and ‘name’ and the separator is ‘/’. Similarly a target function (group/name*) indicates that several target entities can each be identified by a combination of group and name with ‘/’ as separator within the key attributes of one entity, and “(space) as separator between entities.

When a relation is represented by an element rather than an attribute, with the element defining the target entity by some business model attributes, the target functions identifying the ‘distant’ entity are very similar. The target functions (course name), (course name*), (group/name) and group/name*) would be unchanged and have exactly the same meaning as above. However, there is one extra possible target function (course name)*. This indicates that there may be multiple elements within an element representing an entity, each one representing one instance of a relation. This possibility did not exist with attributes, which must occur singly.

The target functions identifying the ‘nearby’ entity are also different for elements. In stead of ‘owner’ (the element owning an XML attribute), the two possible target functions are ‘parent’ (the element immediately outside the element representing the relation) and ‘ancestor’ (an element somewhere outside that element).

Relations represented by id/idref pairs: These effectively form pointers within an XML document between the elements representing the entities in the relation. One entity type will have an attribute of type ‘id’. The other entity type will have an attribute of type ‘idref’ or ‘idrefs’ which holds the pointer to one element (idref) or to several elements (idrefs).

To capture this type of relation representation, select Map/Relation for one of the entity types involved,and select the XML attribute which is to hold the idrefs. One of its target functions will be ‘owner’ (to select the element owning the XML attribute) and the other target function will be ‘idref’ or ‘idrefs’, depending on whether it picks out one or several target entities.

Relations represented by separate elements: In all of the cases we have described so far, the XML structure (element, attribute or content model link) which represents a relation is found somewhere inside the element representing one of the entities in the relation. So one of the entities can be found just by looling ‘upwards’ using a target function ‘owner’, ‘parent’ or ‘ancestor’. However, it is also possible to represent a relation by elements outside the elements representing either entity.

XMuLator currently does not support this possibility directly, but it can be done indirectly by an approach commonly used in relational databases. In stead of a relation [A]R[B] between two classes, it is possible to create a new entity class C which embodies the relation itself, and then in stead of the relation [A]R[B] to use two separate relations [A]R1 [C] and [C]R2[B]. In XML terms, the relation [A]R[3] may be represented outside the elements representing A and B, but inside the element representing the new class C. XmuLator can then use the methods already described to map the relations R1 and R2 onto elements and attributes inside the elements representing C.

For instance, in stead of [student] attends [course] we could introduce a new entity class ‘attendance’ and two new relations [student] fulfils [attendance] and [attendance]is at[course]. Very often this is a useful move for other reasons, as the attendance may have interesting attributes of its own (dates, grade achieved and so on), which can be stored with the new ‘attendance’ entities.

Therefore XMuLator supports a wide range of ways of representing relations. Without doubt other ways of representing relations can be devised which are not supported.

However, if any of these methods becomes widespread and important, the product can be extended to support it.

13. Generating and Applying XSLT Transformations

13.1 How Much Can Be Transformed?

Once you have defined the business information model and the mappings of several XML languages onto it, XMuLator can generate direct transformations between any pair of XML languages automatically. However, the mappings may not allow all of a message in one XML language to be translated to another. If so, this arises not from limitations of XMuLator, but because of a lack of semantic overlap between the different XML languages.

There are some simple tests which can help you determine in advance, before generating a translation, which parts of the XML will be translatable from one language to another, and what will necessarily be left out.

The first check is to display the entity hierarchy of the business information model, highlighting in two different colours those entities which map onto the two XML sources you wish to transform between. Entities which are highlighted in both colours can generally (subject to another check—see below) be transformed both ways between the two languages. For any entity highlighted in just one colour, there will be some restriction on the transformation.

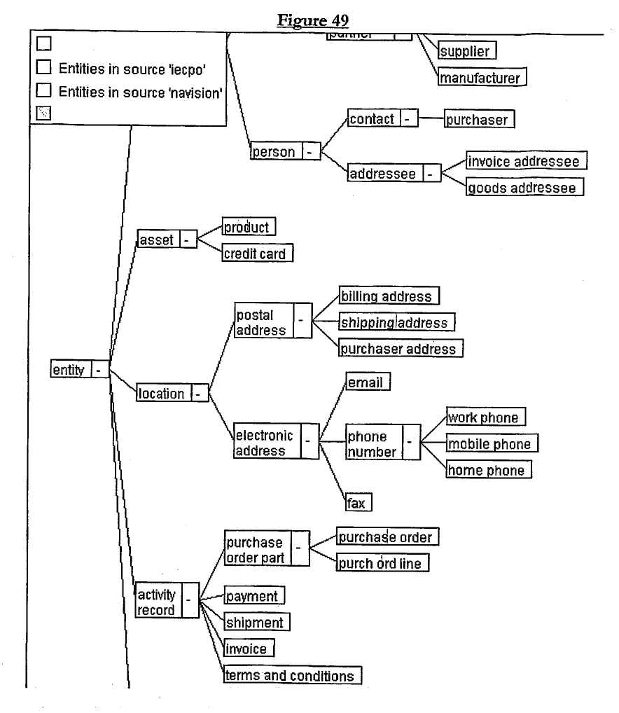

In the main ‘Information Map’ window, click one of the coloured boxes in the top left-hand corner, to show a pop-up menu. Select the menu item ‘Mapped to Source’ and you will be asked to choose which XML information source to highlight. Having chosen one XML source, all entities mapped to that source will be highlighted in the colour you chose. Do this again for a second XML source in a different colour, and you can then see the amount of overlap between the two sources on the business information model. The overlap is in the entity boxes which are coloured in both colours. A simple example is shown in FIG. 49 below. This overlap of bi-coloured boxes defines how much you will be able to transform information between the two XML sources.

This simple example shows a partial overlap between two purchase order message formats from IEC and Navision. Entities highlighted in both green and yellow will be translatable between the two, while others will not.

You will want to go further and analyse which attributes and relations of those entities will be translatable between the two languages. To examine the attributes or relations of some entity, select that entity and use the popup menu options ‘Show/attributes’ or ‘Show/relations(table)’. These will display tables for attributes a. FIG. 50.

This shows all business model attributes of the entity ‘purch ord line’ and the elements or XML attributes they are mapped to in the two highlighted XML sources. Wherever there is an entry in both the ‘iecpo’ and ‘navision’ columns, the attribute will be translatable.

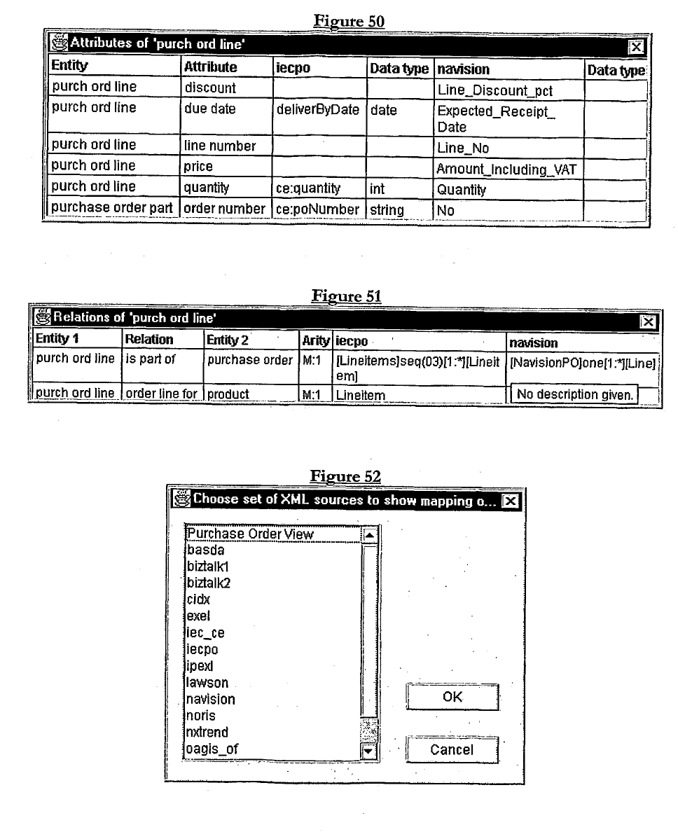

For relations the display is similar (see FIG. 51).

This shows the relations of the business model, and the XML structures they are mapped to. The complex descriptors in the ‘iecpo’ and ‘navision’ columns are descriptors for content model links, indicating that these relations are represented by nesting.

For both attributes and relations you can hover the mouse over the XML columns to get descriptive comments about the XML structures which may (if you are lucky) describe what they represent, as a check of the mapping.

This kind of overlap analysis between two or more XML languages can be done more quickly by using the main window menu option Tools/Count Overlaps. This will display a dialog as shown in FIG. 52.

This gives the name of every XML language you have captured in this XMuLator database, and which you may have mapped to the business model. You then select one, two or more of these XML sources to analyse their overlaps—the business model entity classes, attributes and relatins which have mappings to all of the selected XML sources. (You may for instance select three sources to see what information can be freely translated between all three).

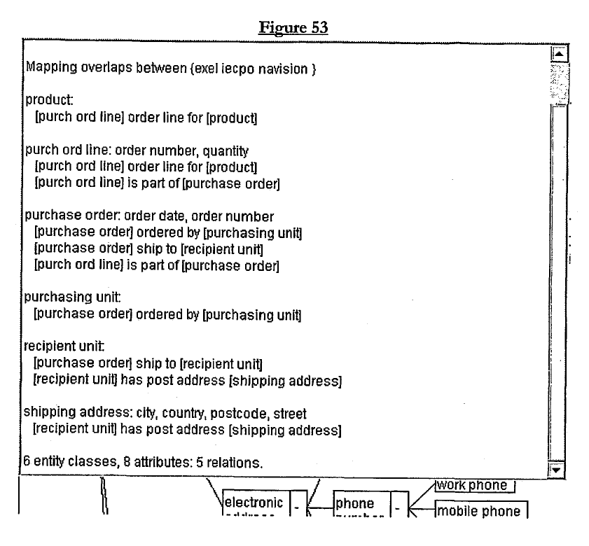

XmuLator then automatically does this overlap analysis and displays the result in the small message area at top left of the main map window. To make this easily readable, use View/Expand Message Area to show FIG. 53.

This text can also be saved to a file, and gives a concise summary of what can be translated between any pair of the three XML sources shown.

This quick overlap analysis does not address one important case which sometimes arises, concerning subclasses and superclasses.

If source X₁ represents entities in a class B on the diagram, and source X₂ does not represent entities in the same class, but represents entities in some ancestor (superclass) A on the diagram, then it is possible to transform information about these entities from X₁ to X₂, but not from X₂ to X₁. This is because every B is an A; so whenever language X₁ describes an entity of class B it is also describing an entity of class A, which can be output in language X₂. The reverse does not hold; something which is an A need not necessarily be a B, so X, cannot necessarily describe it

To detect these subclass/superclass overlaps, you need to look at a highlighted entity tree; the ‘Count overlaps’ function does not detect superclass/subclass overlaps.

If the class of an entity represented by X₁ bears no hierarchic relation to the class of an entity represented by X₂ (neither class is a superclass of the other), then there can be no inter-translation of the elements representing those entities.

Whenever an XML source contains information about an entity, it should in principle contain enough information to uniquely identify the entity; otherwise the information it gives is ambiguous. Furthermore, when translating between two languages, the unique identifier information about an entity should be translatable between the two. Otherwise the information given about the entity in language 1 is not enough to uniquely identify it in language 2. Therefore the two XML sources should both represent the same set of business model attributes which constitute some unique identifier of the entity; otherwise it will not be possible to translate the entity from one language to the other.

In practice, however, many XML message formats do not strive to provide unique identifiers for all the entities they represent, relying on context information outside the XML message to identify them. So when generating translations, XMuLator simply warns you about possible problems with unique identifiers, but produces a transformation anyway.

If any entity is not translatable between two XML sources, then none of its attributes will be translatable, and no relations involving the entity will be translatable.

In this way you can check in advance whether you have enough semantic overlap between the two XML sources to make useful transformations between them. The XSL translations generated by XMuLator are subject to the constraints above. Similarly, XSL transformations written by hand should be subject to the same fundamental semantic constraints.

13.2 Generating XSL Transformations

To generate an XSL transformation between two XML sources, select the main menu option Tools/XSL Transform. You will see a dialogue box as in FIG. 54.

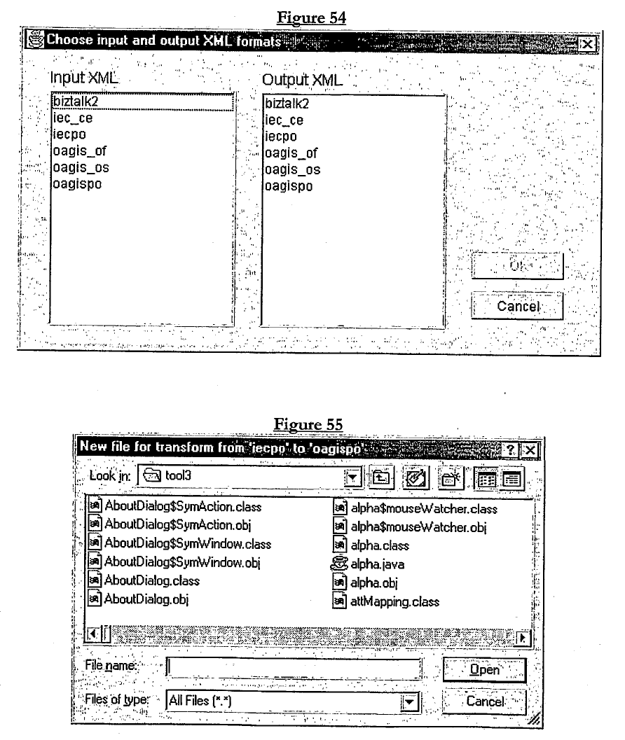

Choose an input XML language (source) and an output XML language, then click OK. You will see another dialogue box (see FIG. 55).

This dialogue simply defines the name and location of the file you wish the generated XSL to be written to. When you have completed it, then after a few seconds the tool will show a message in the message area, saying that the XSL file has been written. That is all you have to do.

Typically XMuLator produces several warning messages when generating a transformation—where obligatory XML elements or attributes in the output XML cannot be created for lack of input information, and so on. You can view these warning messages in any of three different ways:

1. The messages are all sent to the small message area in the main window. Using View/Expand Message Area you can read these messages, and can also save them to a file.

2. If, before generating the transformation, you have selected the menu option Tools/Warnings in XSLT, then all the warnings will be embedded as comments in the appropriate place in the generated XSLT file.

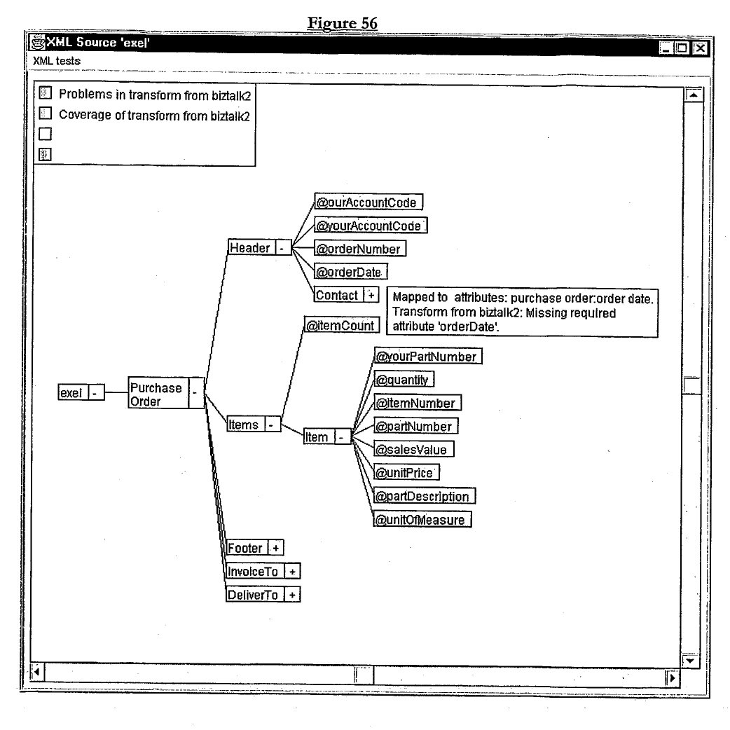

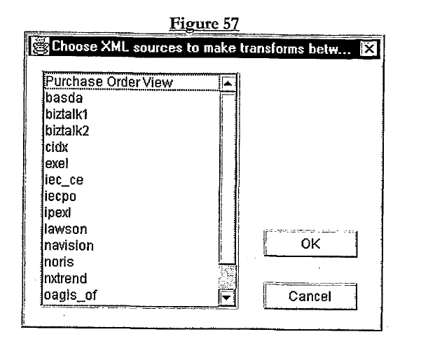

3. Each warning message is attached at an appropriate place to the structure tree of the output XML. The messages can be viewed, attached to the appropriate node, by selecting View/XML Source, using the colour highlight Transform/problems and hovering the mouse over the highlighted (problem) nodes. This will show a result such as in FIG. 56.

Here, we have also used another colour highlight ‘transform coverage’ to show in green which elements and attributes can be expected in the output XML. Problems are highlighted in red. the mouse pointer (not shown) is over the node ‘@ordetDate’.

A typical simple XSL transformation file, generated by XMuLator, is shown in Appendix A. Note that this XSL contains comments which define which part of the business information model is being transformed by any piece of XSL. So you can find out which parts of the business model will be missing from the output XML, even if you have no knowledge of XSL.

13.3 Generating Multiple Transformations

It is possible with one operation to generate all possible transformations between any pair of XML languages in a set of languages. If the set contains N languages, XMuLator will generate all N(N−1) transformation files.

In order to identify the XSLT files for the different transformations in the set, XmuLator adds two suffixes (one suffix for the input language, one for the output language) to a toot filename which you supply. You need first to define what suffix you want for each XML language. To do this, go to the ‘Information Source Details’ dialog shown in section 4, and alter the ‘Transform file suffix’ field.

Next select Tools/Multiple XSLT transforms to show a dialog as in FIG. 57.

Select all the XML languages you require transforms between and click ‘OK’. Remember this will cause XMuLator to generate all N(N−1) transforms, taking typically up to a minute for each one (depending on the complexity of the languages).

You are then shown a file dialogue similar to the one above, for you to select the root file name and directory for all the transform files. If you choose a root file name ‘foo’ and have suffixes a, b, etc., then the XSLT file names will be fooab.xsl, fooac.xsl, and so on.

As the transform files are generated, warning messages will be displayed in the message area as usual. You will probably not be able to read them there. However, the warning messages for the transforms ate saved in separate files fooab.doc, fooac.doc, and so on in the same directory as the transform files—and are then cleared from the message area to stop it overflowing.

13.4 Warnings And Error Conditions

When generating an XSLT transformation file, XMuLator outputs warning messages wherever it detects a potential problem. Sometimes you may be surprised by the large number of these warning messages, so it is useful to understand how they arise. Many of them are in practice unimportant; they signal issues which will not have any impact on practical transformation or use of the transformed XML, but you must be the judge of that.

They typically arise because XMuLator takes the DTD or XDR seriously, and the syntactic constraints in the DTD or XDR may not always precisely match the semantics you have assigned to the language. They may also arise because required information is missing from the input XML The main types of mismatch are listed below.

13.4.1 Unique Identifier Attributes

Suppose you have declared that some element represents an entity in the business model, and that certain other elements represent some of its business model attributes. You have also declared (in the business model) that some combination of attributes forms a unique identifier for the entity—that is, no two entities will have the same values for all these attributes.

XMuLator cares about unique identifier attributes, because (a) they may be used as foreign keys to define relations between different entities, and (b) they may be needed to construct ‘id’ attributes in the output XML. The ideal situation is that an XML language guarantees to define a unique identifier of any business model entity which it represents, and to define it uniquely. That is, every business model attribute which is a part of the unique identifier should ideally be represented in the XML by an element or attribute which:

(a) Always occurs, whenever an element representing the entity occurs (e.g. is nested inside it with minOccurs=1)

(b) Is defined uniquely for the entity (e.g. is nested inside the element representing the entity, with maxOccurs=1; or is an XML attribute of the element).

Any deviation from this ideal situation, for any entity represented in the input XML, is noted as a warning such as:

Entity ‘purchasing unit’ has no guaranteed unique identifiers in the input XML source ‘basda’.

The message is unimportant if the output XML does not attempt to use unique identifiers as foreign keys in relations, or to construct ‘id’ attributes—which is very often the case. If, however, the output XML does either of these things, you may have a problem.

13.4.2 Required Elements and XML Attributes

The DID or XDR of the output XML will often require that certain elements or XML attributes be present, whenever their containing elements are present. For instance, many elements typically have minOccurs=1 or greater, in XDR notation.

The XSLT generated by XMuLator will only create an element in the output XML if either (a) it represents something in the business model or (b) it contains something which represents something in the business model. So if you have not mapped an element in the output XML language or any of its contents to the business model, the XSLT from XMuLator cannot create that element If that element has minOccurs=1 or greater, XMuLator will output a warning message such as:

Cannot write obligatory output element ‘formaction’ inside ‘PurchaseOrder’.

Similarly, for a missing obligatory attribute, the warning message has a form like:

Missing required attribute ‘a-dtype’.

In this case, the context in the message text will make clear which element ‘owns’ this XML attribute.

Even if you have mapped an element or attribute in the output XML to some part of the business model, these warnings may still be output—if that part of the business model is not mapped to anything (i.e. not represented) in the input XML If there is no input information, that part of the output XML clearly cannot be created.

Note that an attribute or element may frequently be missing from the output XML, because the required information is missing from the input XML; but XMuLator will only write a warning if the missing element or attribute is required by the output XML schema constraints.

13.4.3 Single-Valued Attributes

XMuLator uses a semantic model in which attributes are unique-valued. If you need a multi-valued attribute for some entity class, you need to make it an an attribute of another class which is related to the first class by a one:many relationship.

Therefore if you declare that some XML node (element or attribute) represents a business model attribute, XMuLator will expect that node to occur at most once for every entity of the class—that is, to occur at most once for every element representing an entity of the class. For instance, the node could be an XML attribute of the element representing the entity, or it could be a nested element with maxOccurs=1.

In cases where the node representing the attribute can occur more than once in the input XML—so that the input XML can in effect assign more than one value to the attribute—XMuLator writes a warning message of the form:

Warning path from PO to PO/POHeader does not define a unique value for attribute purchase order:order number

Here the business model class is ‘purchase order’ and its attribute is ‘order number’. There may be spaces in business model class and attribute names.

In these cases, the XSLT generated by XMuLator simply picks up the first value of the node in the input XML and assumes that to be the value of the business model attribute. So in cases where the input XML's DTD or XDR does not constrain the value to be unique, but where it is actually unique in any document, this gives the correct result in the output XML.

13.4.4 Wrapper Element Warnings

It often occurs that some element in an XML language does not represent any entity, attribute or relation of the business model, but that some element or attribute inside the first element does. In these cases, the outer element is called a ‘wrapper’ element

Currently XMuLator generates XSLT which creates wrapper elements in a fairly straightforward way. For instance, it will not create multiple copies of a wrapper element so that each one can contain an element representing a separate entity; it will create one wrapper element to contain many elements representing entities. Note: if you want the first effect, you should probably make the wrapper element into the one representing the entity; such choices are often available).

Because XMuLator makes this choice automatically, there are sometimes conflicts between the multiplicity constraints on the wrapper element as declared in the DTD or XDR, and the multiplicity constraints on that element from the XSLT generated by XMuLator. In the case of any possible conflict, XMuLator writes a warning message, such as:

Optional wrapper element ‘POHeader’ will always occur inside ‘PO’.

or:

Repeatable wrapper element ‘POLines’ will only occur once inside ‘PO’.

You will need to judge the importance of these warnings yourself in the light of the application which will use the output XML.

13.4.5 Cardinalities of Relations

You may sometimes define that an XML language represents a business model relation in a way which is inconsistent with the declared cardinality of the relation. For instance, if a relation is represented by nesting of elements (which is very frequently done), the relation should be 1:1 or 1:M (in the direction outer element: nested element). It is not correct to represent a many:many relation in this way.

Whenever XMuLator detects a conflict of this kind in generating XSLT (not before!) it writes a warning message such as:

13.4.6 Missing Mappings

If an entity class is represented by an element nested inside another element which also represents an entity class, then XMuLator expects that the nesting of the two elements represents some relation between the two entities they represent—otherwise why is one nested inside the other?

If there is no relation, then XMuLator has no way to know which entities of the inner class are to be output inside any element representing an entity of the outer class—so it generates XSLT which outputs no inner entities, and gives a warning message of the form:

Nested element ‘ce:purchaserDetails’ represents an entity, but CM link from outer element ‘PurchaseOrder’ does not represent a relation to the entity.

This message indicates that the mappings you have made from the XML to the business model are sin some way incomplete; you need to define which business model relation is represented by the nesting of the elements. In some cases, the relation you want to model is not a relation to the entity represented by the outer element—in which case, the XML cannot represent the business model in the way you might like to.

13.4.7 No Mappings at All

If you have not made any mappings at all from an XML source to the business model, XMuLator will refuse to generate any transforms for that language, with a message of the form:

No mapped elements in input XML source ‘pq4’

13.4.8 Too Many id Attributes

XML uses attributes of type ‘id’ to uniquely identify an element within a document. XMuLator expects any element type to have at mose one attribute of type ‘id’ and if not issues a warning of the form:

3 id attributes for element ‘Fred’.

13.4.9 Cannot Construct an id Attribute

If the output XML element, which represents an entity, has attributes of type ‘id’, XMuLator attempts to construct these attributes by using unique identifier attributes of the entity which are defined in the input XML—because these can be concatenated to make a string which is unique within the document. If XMuLator cannot find any set of unique identifier attributes which are represented in the input XML, then it issues a warning message of the form:

No unique identifier to construct an id for ‘Passenger’

13.5 Applying XSLT Transformations

To use the generated XSLT files to actually transform XNM from one language to another, use any standards-conformant XSL translator such as James Clark's XT. This is available for free download from . . . , and is simply installed on a Windows or Unix computer. Under Windows, XT runs from within the DOS command window, and it is useful to write a simple BAT file encapsulating the required command line, and leaving parameters to define the input XML file and the input XSL file.

This will probably suffice for testing purposes; for operational use, an XSL transformation engine such as XT will probably be embedded in other processes, in an architecture which is outside the scope of this document

14. Validating XSLT Transformations

Transformations between XML messages cannot be used for business-critical operations unless you are very sure that they are correct. Inevitably this will involve building your own test cases and test harnesses as well as inspecting the input and output messages by hand.

In addition to this, XMuLator gives you a number of tools which can automate parts of the testing process and give you a high degree of confidence that the transformations are working correctly. In particular, a very stringent ‘round trip’ test can be done and its results evaluated automatically with XMuLator.

The various validation tools are described below, in approximately the order they should be used.

14.1 Validating Input and Output XML

Before testing the transform from some input XML language to an output language, it is worth testing that the input test messages obey the syntactic constraints of their XML language. Similarly, of course, it is even more worthwhile to check that the output XML obeys the constraints of its language—except where you know that because of missing information it is bound to violate them.

As these constraints may be expressed in either a DTD or an XDR file (and in future, in an XML schema), it is not easy to find a validating parser to handle all of these formats. XMuLator can do its own syntactic validation of an XML file against a schema (currently, DTD or XDR), and display the results for convenient comparison with other relevant information. This validation does not include all possible validation against complex content models, but does include the occurrence checks of the comparatively simple content models found in most ‘data-oriented’ XML languages.

To validate an AL file against its schema, first select View/XML Source to show the schema in tree form. Then in this schema tree window, select XML Tests/Read XML File to read in a file, validate is syntax, and note any problems against nodes of the tree.To highlight problem nodes, use the colour highlight option X M L File../problems.

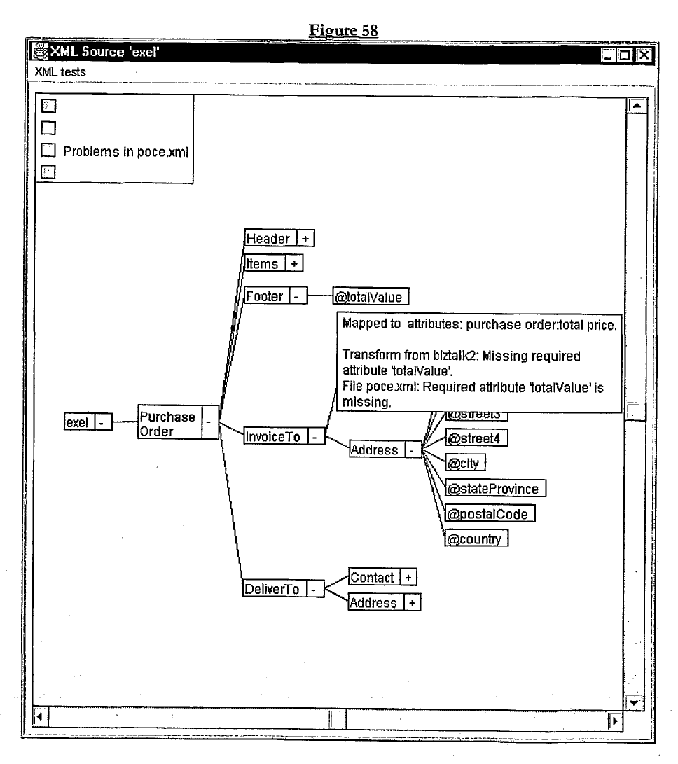

An example is shown below, FIG. 58, for a transform output file in the format ‘exel’ for purchase orders.

This example reveals quite a few syntax problems with the output XML, which can be examined by hovering the mouse over the relevant nodes. From this it is evident that nearly all the problems are of required elements or attributes which are missing, due to the quite limited information in the ‘biztalk2’ sample purchase order from which it was transformed.

14.2 Input and Output XML Coverage

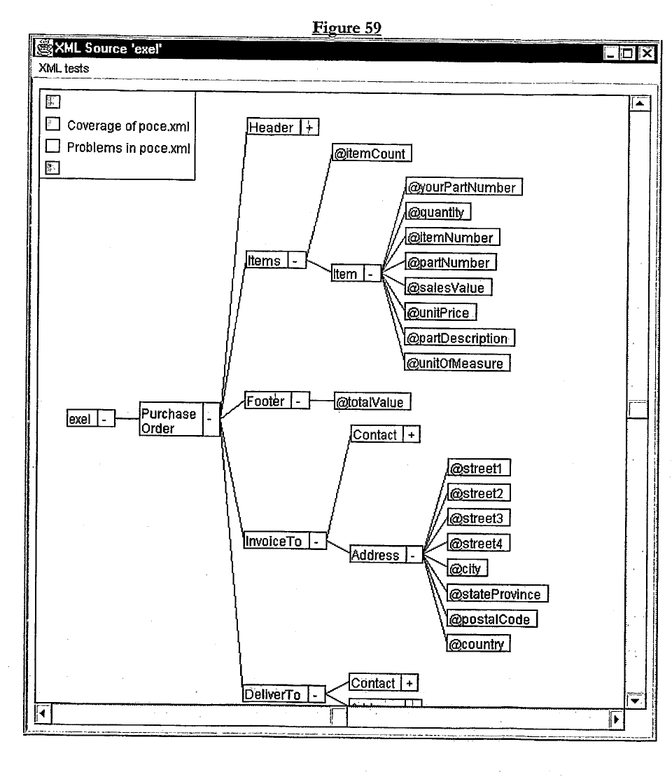

Most of the problems you will encounter are not syntax violations so much as missing information, due to limited coverage or lack of overlap between the two XML languages involved. To examine this more directly, you may proceed as before to analyse an XML file, but display the results differently, using the colour highlighting XML file../coverage. This is shown below in FIG. 59 for the same transform output file.

Here the green boxes show elements or attributes found where expected in the output of a transform, while the yellow boxes show problems again. This makes it clear that the problems are nearly all missing information.

More directly, the actual coverage of an XML file can be compared with the expected coverage from the transform generation process, to check that the XSLT file creates all the output XML which you expect it to create.

It is also useful to do the same coverage analysis on input XML files, to ensure that any problems of missing information in the output have not arisen from missing information in the particular input sample (as opposed to missing information in the input message format).

14.3 Round Trip Tests

If a set of XML languages are mapped to a common model of business meaning, XMuLator can generate the transformation between any pair of the languages equally easily. Therefore it can generate all the transformations required for a round trip A=>B=>A, or for longer round trips A=>B=>=C=>A and so on.

If all the transformations in a round trip are all correct, then the final message in language A will be a strict subset of the input language in the same language at the start of the round trip. The final message can only differ from the initial message by the omission of pieces of information which could not be translated because they are not represented in one or more of the intermediate languages. What information should and should not survive the round trip can be calculated by looking at the overlap of the mappings, as described in the previous section.

Even the shortest round trip A=>B=>A is quite a stringent test of the transformations. The output of the first transformation from A to B must be a syntactically correct form of B in order to serve as input for the second transformation. It must also (subject to an exception noted below) have the tight information in the right places, or that information would not come out in the tight place after the second translation. Longer round trips test a larger number of translations simultaneously.

In practice the round trip test can be done by generating a set of linked transformation files as described in the previous section, doing a round trip set of transformations automatically in a batch (e.g. with a number of invocations of XT tied together in a DOS batch file), then doing two tests on the result.

First, the coverage of the output XML file is examined using the XMuLator ‘XML coverage’ facility described above. This can be compared with the coverage expected from the overlap analysis of the XML languages involved in the round trip, to see if any information which should have survived the round trip (because it is represented in all the languages in the trip) did not survive.

Second, the output XML file and the input file (which are in the same XML language) can be automatically compared to see if one is a subset of the other. To do this, first display the tree structure of the appropriate XML language by selecting View/XML Source. Then select XML tests/XML subset test and input the names of the two files you wish to compare. Some messages will appear in the message area, followed by either’ subset test passed’ or ‘subset test failed’. Generally the test should pass exactly, and if it does not there is something wrong.

If the test is not passed, the reasons for failure can be examined by selecting the colour highlight ‘Subset violations’. This will highlight any nodes where subset violations have occurred, and the nature of the violation can be seen by hovering the mouse over the node, as shown in FIG. 60.

This example was produced artificially, by mutilating the output file. Generally it is quite difficult to produce subset violations.

A note of warning: the file subset test used in XMuLator is not a general XML subset test, but relies on some special features of the subsets produced by XMuLator transformations—roughly, that if elements of a certain type are expected, they will either be all there or all absent. If these assumptions are violated (e.g. by hand-editing one of the files) you are likely to be swamped with error messages where lots of mismatches are detected—whereas a more sophisticated algorithm would look around for ways to maximise the amount of fit between the two files.

While the round trip test is a highly sensitive test of the correctness of the transformations, both syntactic and semantic, it is mainly a test of the mechanics of the transformation process. There are certain mapping errors which it cannot test for. For example if, for one of the XML languages in the round trip, some of the attribute mappings had been done wrong—say, transposing two attributes ‘price’ and ‘quantity’—then this transposition would be made when translating in to that language, and then undone when translating out of that language again. So it would not be detectable in the results of the round trip.

That is why, as well as semi-automated tests like the round trip test, it is also important to inspect the output XML with the naked eye to ensure that its meanings are realistic.

If you have enough XML based languages, you can make long round trips through five or more languages. However, these long round trips are generally not a very sensitive test of the translations, because so much information gets lost of the way round. It seems more effective to test a variety of round trips through two, three and four languages at a time.

A variant of the round trip test is the ‘dog-leg’ test, where a direct transformation A=>B is compared with an indirect transformation A=>C=>B, with the same end points. In this case, the output of the indirect transformation should be a strict subset of the output from the direct transformation.

15. Building the Business Process Model

Building a business process model is not directly relevant to XML transformation, which depends only on the declared meanings of entity classes attributes and relations, and on the mappings of these to XML structure. However, the process model is often a very important underpinning of the meanings of things in the information model, since it defines how these things are used. It is therefore worth taking time to build a business process model and relate it to the business information model.

15.1 The Form of the Business Process Model

Business results are achieved by carrying out a set of business processes. Following the widespread use of business process re-engineering (BPR), many companies think of their business in terms of these processes, and there are many techniques available to analyse and model processes. The mapping tool uses a fairly neutral notation to represent business processes, which is compatible with the major techniques used for process analysis.

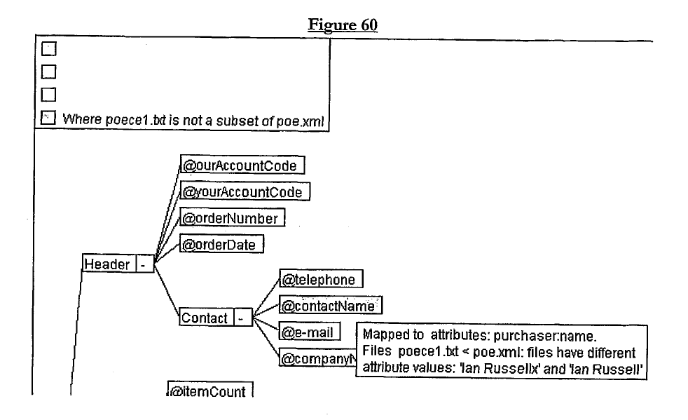

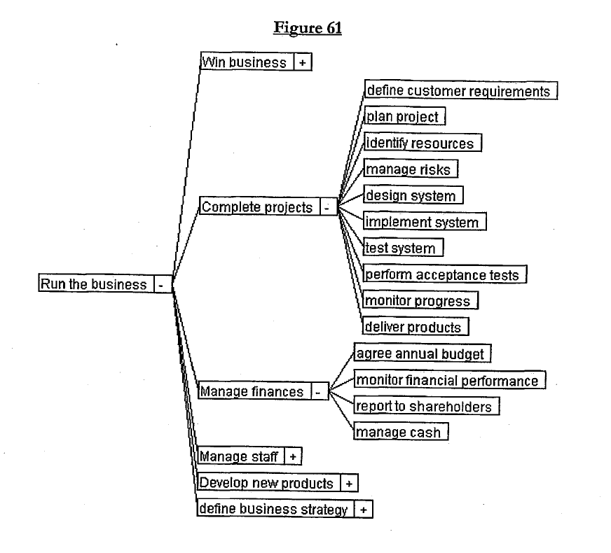

In the business process model, all business processes are arranged in a hierarchy, from a single top-level process (which is typically called ‘Run the business’) down through a few top-level processes (such as ‘win new business’ or ‘develop new products’) to more specific and fine-grained processes. This hierarchy can be taken right down to individual activities if required. The first few levels of a typical hierarchy of processes are shown in FIG. 61, as they are displayed by the mapping tool.

Here only two of the top-level business processes have been opened out to show their constituent processes. Typical process models go down to three or more levels, giving more detail than this simplified example.

This purely hierarchic model of processes is an approximation; there are sometimes common sub-processes shared across several processes. This happens infrequently enough that the duplication required in the model to represent such sub-processes is acceptable.

The set of information about each process which XMuLator can capture is quite open-ended; different attributes of a process can be built into the model at will. Typical information held about each process may include the role responsible for carrying out the process, the number of times the process is carried out, its typical costs and elapsed time.

Processes are typically arranged in flows. If there is a flow from one sub-process to another, this means that the first sub-process must be completed before the second starts. This may be because some resource (such as information, or a physical asset) is produced in the first sub-process and used in the second. These process flows can be modelled in the mapping tool. You can define a flow between any two processes on the process hierarchy, and define the type of the flow to be any type you wish. In this way the mapping tool can be used to capture the results of common process modelling techniques, such as IDEF.

While the business process model on its own can be very useful, its real power comes from the ability to capture mappings between the information model and the process model—mappings such as ‘Process X uses information Y’—and thus to model precisely the uses of information in the business. These mappings are described below.

15.2 Browsing the Process Model and its Mappings

Selecting View/Processes reveals a new window very similar in form to the main entity tree window, showing the top level of the process tree, as in FIG. 62.

Just as for the entity tree, each process node has a popup menu, and the process tree can be expanded by clicking the ‘+’ boxes or using the menu option Process/Expand Subtree. Other options in the process popup menu are shown below in FIG. 63.

As for entities, a description of each process can be shown by hovering the mouse over its node.

For each process, you can show either its external or internal process flows. A process's external flows are flows from other processes (which are not its sub-processes) into the process or its sub-processes, or flows in the opposite direction. Internal flows are process flows entirely within the sub-processes of a process.

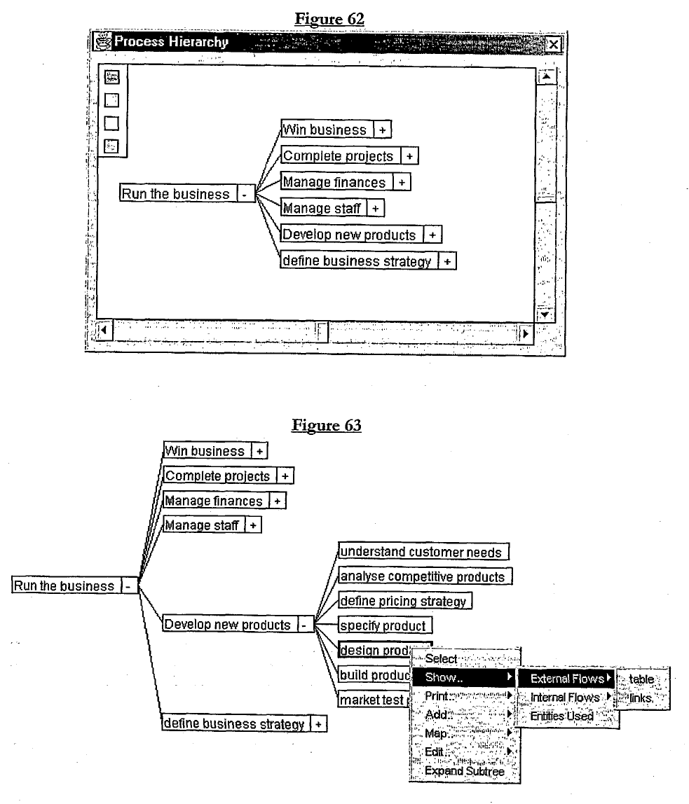

The diagram below shows the external flows of the process ‘win business’. In this simplified example, there is only one external flow, and its description can as usual be shown by hovering the mouse over it as seen in FIG. 64.

Internal flows of a process can only be shown in tabular form, using Process/Show/Internal Flows/Table as in the table below (see FIG. 65).

In these examples, the flow types ‘trigger’ and ‘info’ have been used. You can define and use any set of flow types you wish, to capture the content of different business process modelling notations such as IDEF.

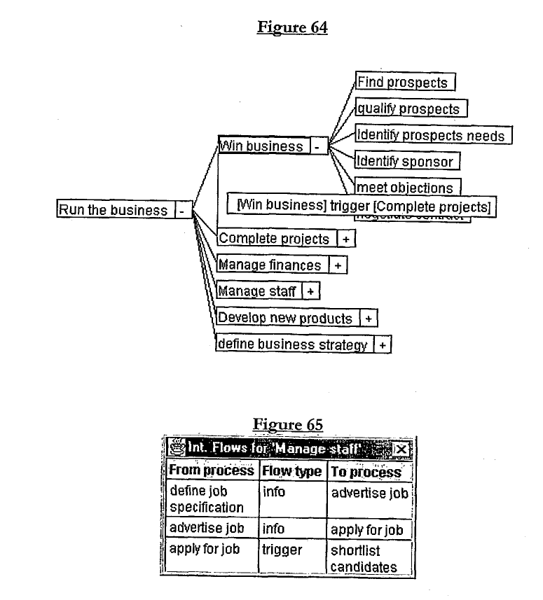

Using Process/Edit/Details shows the detail information held for the selected process itself, as in FIG. 66.

In this map database, the only detail information held for a process (besides its description) is the Responsible Role. Depending on how a map database is set up, other detail information (such as the frequency or cost of a process) can be entered and shown here. Section 9 describes how to set up a map database to hold such extra information.

XMuLator enables you to record and show what information is used by a process, and what processes use certain information. This can be done either by coloured highlighting, or in tabular form.

To highlight all process which use or modify the information about some entity, first select that entity in the entity window, by the popup menu option Entity/Select. This will show the box for the selected entity in bold. You can then go to the Processes window to highlight all processes which use or modify that entity. To do this, click on one of the four coloured highlighting boxes, to reveal a popup menu of highlighting options as in FIG. 67.

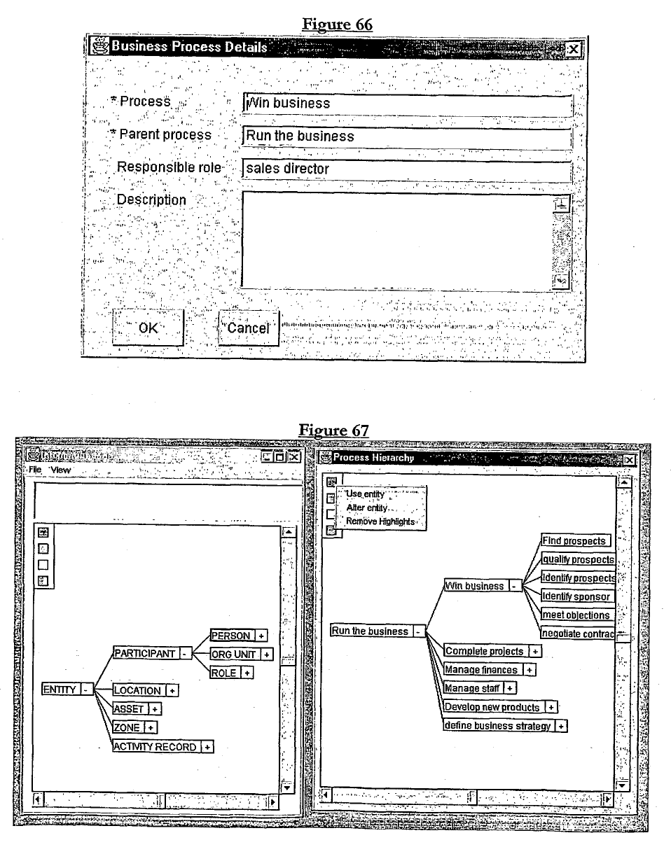

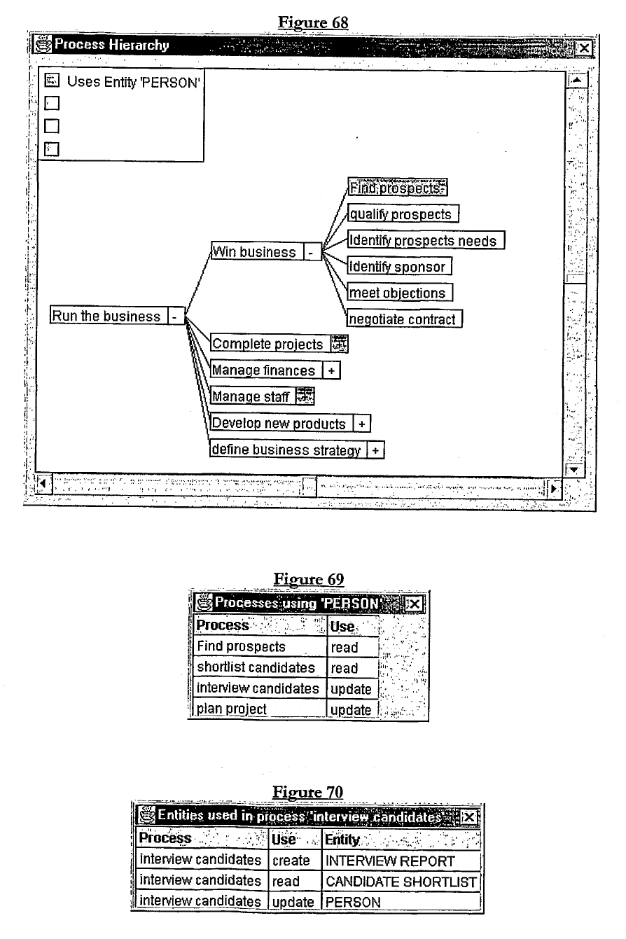

Selecting the menu option Red/Use entity will then highlight in red all processes which use (i.e which create, update, read or delete) information about the selected entity ‘person’ as in FIG. 68.

The coloured ‘+’ box in ‘Complete projects’ means that some sub-processes of ‘Complete projects’ use the entity ‘person’. These can be revealed by expanding that process node.

Sometimes the corner area where the highlighting is explained can cover parts of the entity tree. To avoid this, you can do one of two things: scroll the entity tree to the right, or click in the corner area to shrink it. Another click will re-expand it.

In stead of highlighting all the processes which use some entity, you can show them as a table (see FIG. 69). Starting in the entity tree window, use Entity/Show/Processes Using to give a table of processes which use the selected entity.

To go the other way, and find all information used by a particular process, you can do one of two things. First, you can use the menu option Process/Show/Entities used to show a table of all these entities as in FIG. 70.

Second, you can use Process/Select to select a process and then in the entity tree window Colour/Used in process to highlight the same set of entities which use that process as in FIG. 71.

Here the entities ‘INTERVIEW REPORT’ and ‘CANDIDATE SHORTLIST’ are subtypes of ‘HR EVENT’ which have not yet been revealed.

You can also show which process flows carry information about an entity by using Entity/Show/Process flows carrying. In these ways you can easily build up a complete picture of how processes use information in the business.

15.3 Building the Process Tree

The empty map database supplied with the mapping tool already has a small process tree with the top ‘process’ node, and you will grow the process tree from this top node. To grow the tree below a process node, or to modify it, click on the node to show its ‘process’ popup menu. The relevant commands are as follows:

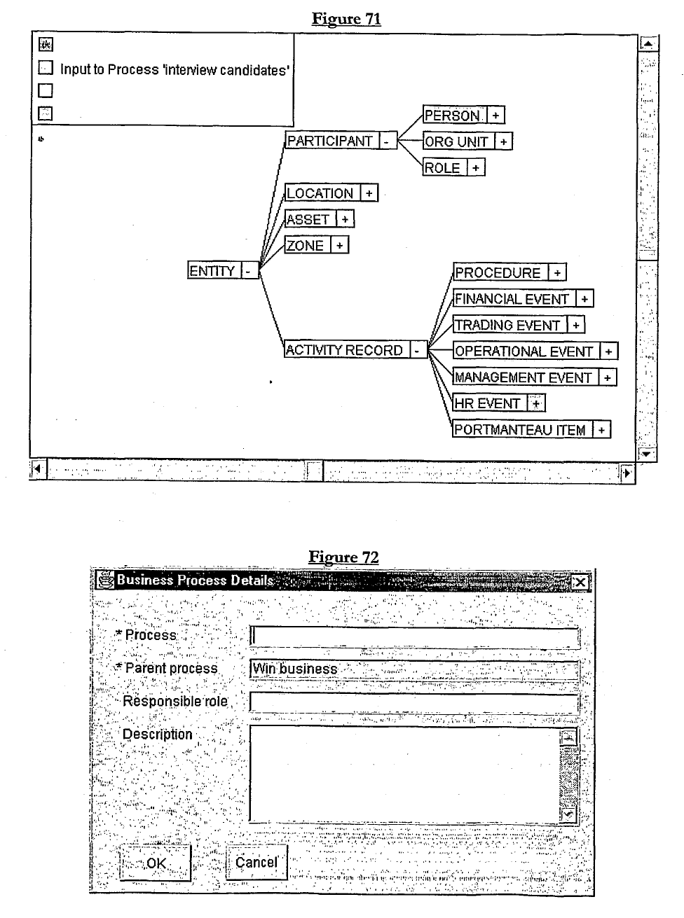

Process/Add/Child Process shows the following dialogue in FIG. 72, enabling you to add a process immediately below the selected process in the tree.

The ‘Parent process’ field is greyed out, showing you cannot change it. You need to provide a new process name, and can provide an optional description and responsible role. The new child process will be added below any other existing children in the screen image of the tree.

The tool will prevent you from adding a process whose name duplicates any process already present; in this it treats upper and lower case as distinct.

To change the name of a process without moving it in the tree, use Process/Edit/Details; similarly to add a text description, or change it

To delete a process, use Process/Edit/Delete; remember that this will delete all its process flows, all its descendant processes with their flows, and all their mappings. You will be asked to confirm any delete command.

You may want to order the descendant nodes form a process node in some meaningful order on the screen. To do this, use Process/Edit/Move up to move a process up one place in the order below its parent, or Process/Edit/Move Down to move it down. Its whole sub-tree moves with it.

To move a sub-tree in any other way (that is, to attach it to a different parent) use Process/Edit/Details on the root node of the subtree, and change the name in the ‘Parent process’ field to the name of the new parent.

15.4 Adding Process Flows

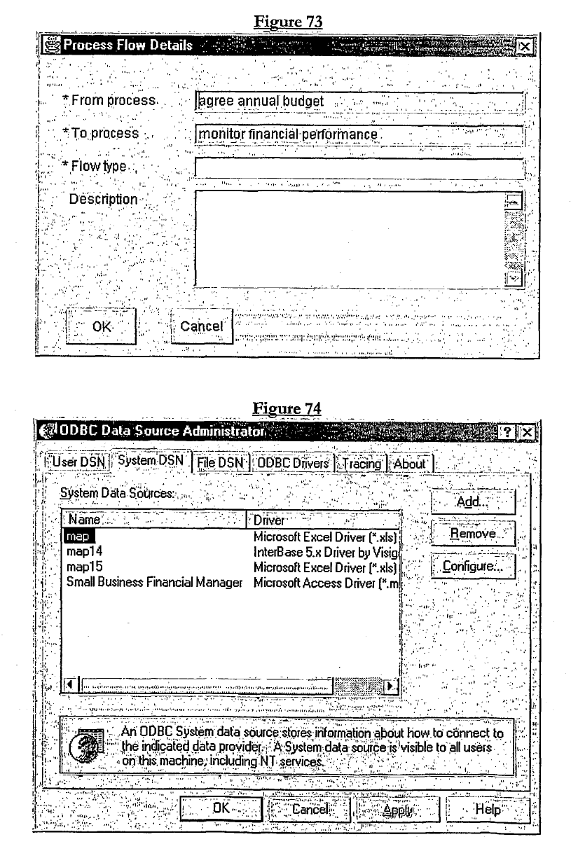

To add a new process flow between two flows, drag the mouse from one to the other. This will display the dialogue as in FIG. 73.

You will need to enter a flow type, and you may choose this from a small set of pre-defined values depending on the approach you are using for process modelling.

To delete a process flow, select the process at either end of the flow and use Process/Show/External Flows/Table to display all its flows. Then select the flow to delete, use Flow/Delete, and confirm the deletion.

To change the name or other details of a process flow, select the flow as before and use Flow/Edit Details to show the dialogue above, to change its name or other properties.

15.5 Defining Mappings Between the Process and Information Models

Currently XMuLator only models the relations between the business information model and the process model at the level of entities, not going down to the level of attributes ands relations. To record the fact that information about some entity is used or modified by some process, first select the entity in the information model tree. Then select the process node and one of the menu items Map/create, Map/read, Map/Update or Map/delete. This will record the appropriate mapping.

Alternatively, the same mapping can be made by first selecting the process node, then selecting the entity node and using the menu options Map/Used by process../create, read etc. You can also record that information about an entity is carried in a process flow, by selecting the process flow and then using using Map/carried by flow.

These mapping facilities are fairly limited, and can easily be enhanced to record at a more fine-grained level—that certain attributes of entities have their values created in certain business processes, and so on. This will then give useful confirmation of the meanings assigned to the attributes.

15.6 Removing Mappings Between the Process and Information Models

From time to time you will have recorded that some entity is used or created by some process, or carried by a process flow, and will want to remove that record—as you got it wrong in the first place, or have changed your mind.

Wherever you can display such an entity usage in one of the dialog boxes described above, you can click on the ‘Use’ box to reveal a popup menu with only one item, ‘Remove Usage’. If you select this one item, then after a confirmatory dialogue XMuLator will remove the usage mapping you have selected.

16. Installing and Running XMuLator

XMuLator is available in two main forms—as an application which runs on a single machine, and as a java applet to be made available on a server. The applet will then run in a browser on any machine which can access that server. Installation and use of the applet is not described here.

To set up the XMuLator application, you need to do two things: (1) Install XMuLator itself, and (2) set up the map database as on odbc source. These will be described in turn.

16.1 Installing XMuLator

The XMuLator application is available in two alternative implementations—either as a native Windows executable, or as a .jar file (java bytecode) which runs on the java virtual machine.

The java bytecode version of the application is not significantly slower than the native Windows version, because it runs on the Java Runtime Engine Ore) which has a just-in-time (JIT) compiler, and so is much faster than interpreted java. In fact for loading large DTDs or XDR files, the native java version runs considerably faster than the Windows.exe version.

16.1.1 Installing the Native Windows Executable

The native Windows form of the tool is supplied as an executable March.exe or Bankhol.exe. Its name is unimportant and you can change it if you like. Move this file to somewhere convenient on your machine.

To run, it requires a set of Dynamic Link Libraries (dlls), mainly those from Symantec which provide parts of the Java virtual machine in native form. The required dlls and their sizes are:

snjrt11.dll 2,822 KB

snjawt11.dll 2,322 KB

xmlparse.dll 1300 KB

snjbeans11.dll 317 KB

snjrmi11.dll 817 KB

snjres11.dll 167 KB

snjnet11.dll 439 KB

snjint11.dll 128 KB

snjsec11.dll 619 KB

snjzip11.dll 172 KB

snjsql11.dll 67 KB

snjJdbcOdbc11.dll 318 KB

snimath11.dll 109 KB

symbeans.dll 3,258 KB

They are supplied in a set of zipped files z1.zip . . . z5.zip. Not all of them are actually necessary for running XMuLator, but they are all supplied to allow for later extensions to the tool which use other java facilities.

Move all the dlls and snjreg.exe into a folder on your machine where they will stay and be run from. Some of the dlls need to be ‘registered’ using a utility snjreg.exe from Symantec, which is also supplied in one of the zipped files. To register the required dlls, under the MS-DOS prompt, move to the folder where you are storing the dlls and type:

snjreg -class snjrt11.dll snjawt11.dll snjsql11.dll snjJdbcOdbc11.dll snjmath11.dll

It should come back with the ‘C:’ prompt without giving any error messages. You may include all the dlls in one command line as above, or run snjreg separately for each one.

Exit MS-DOS. You should then be able to start up XMuLator by double-clicking the icon for the executable file (march.exe or bankhol.exe), although you cannot yet open a map database.

If you have not run snjreg properly, you will get an error message something like “The dll snjawtll.dll could not be found in the specified path C:\WINNT\System32 . . . ”

For updates to the tool, you should be able simply to replace the executable without reinstalling the dlls.

16.1.2 Installing the Java Bytecode Application

This is delivered in a file, march.jar or bankhol.jar. In order to run, it needs a java virtual machine. The easiest way to provide this is to use the java runtime engine (jre) from Sun. This is a 2.5 MByte download from the Sun website at http://java.sun.com/products/jdk/1.1/runtime.html.

Download this file, and follow the instructions to install it (the file is an executable which does the installation automatically).

Put the XMuLator jar file in some high-up directory (say c:/map/). (Use a high directory to minimise the amount of typing below)

You can then run the tool under the MS-DOS prompt by typing after the C: prompt:—

jre -cp c:\map\bankhol.jar -mx64000000 map_frame

This will run the tool, with an MS-DOS window in the background, sending messages to the MS-DOS window (which occasionally comes to the front). To suppress this window, use ‘jrew’ in stead of ‘jre’.

The parameter -mx64000000 gives java 64 Mbytes of heap space, which may be required for loading very large DTDs or XDR files.

You will probably find it convenient to package up the command line above in a batch file (e.g a windows.bat file) to avoid retyping it every time you run the tool.

Read the information at the Sun website carefully for any fixes and workarounds to jre. For instance, with jre 1.1.7 the following is necessary: ‘The download/install from the Java website installs the software in directories ‘lib’ and ‘bin’ under C:/program files/JavaSoft/jre/1.1/. Before issuing the jre command, you need to SET PATH=C:\“program files”/JavaSoft/jre/1.1/bin. Then it executes OK. Otherwise you get a message to the effect that jre cannot find the java runtime.’

16.2 Setting up the Map Database

The map database can be stored in any form that can be accessed as an odbc or jdbc data source. It has been tested as an MS Access database, as an Oracle database, as an InterBase database, and as an Excel workbook.

MS Access is not recommended; although it starts up OK, it tends to slow up and run like treacle after about 5 minutes. Excel is the simplest to install and use, and it also has the advantage that the database can be easily inspected using Excel. The performance of Excel can get a bit slow for large map databases, but not intolerably so. Some sample Excel map databases are included on the disc as .xls files. One of these is an empty map database, suitable for starting any new application.

16.2.1 Setting up an Excel Map Database

Ensure you have Excel 5.0/95 or a later version. Put one of the sample Excel workbooks in a convenient folder where it is going to stay. Then go into the MS ‘Control Panel’ (typically accessible under ‘My Computer’) and click ‘32 bit ODBC’. Choose the tab ‘System DSN’ and you will see a dialogue like FIG. 74.

You will not yet have as many system data sources, if you have not set any up yet. Next click ‘Add’ to reveal a dialogue like FIG. 75.

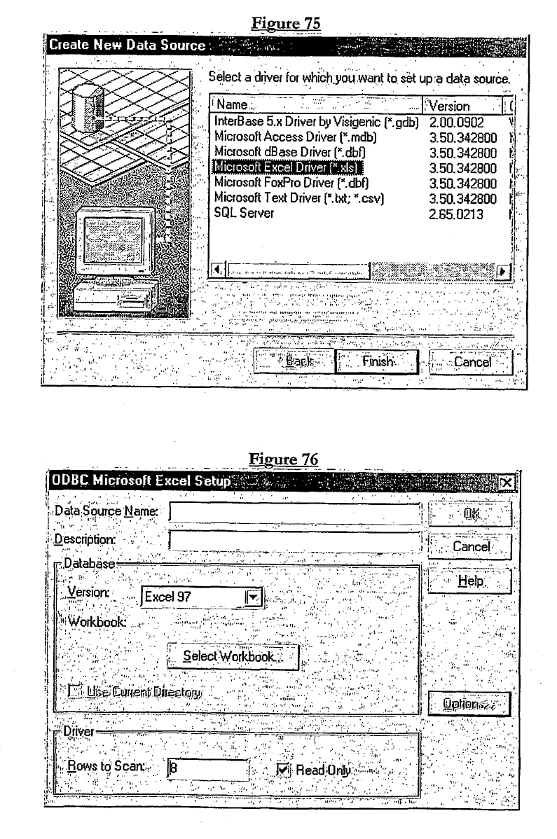

Select ‘Microsoft Excel Driver’ as in the diagram and click ‘Finish’ (don't worry, you haven't finished yet). This will pop up yet another dialogue as shown in FIG. 76.

From the top of this form downwards:

Enter a simple data source name; then in the mapping tool you will use a URL ‘jdbc:odbc:fred’

Type in any description you like

Choose the correct version of Excel

Hit ‘Select Workbook’ to browse your file system and select the Excel workbook which will be the map database, in the folder where you put it

Hit ‘Options’ to reveal the bottom part of the dialogue

Uncheck the ‘Read Only’ checkbox if you will be wanting to update the map

Then hit ‘OK’ and other exit buttons as required. You really have finished now.

Now in the ‘System DSN’ tab of the ‘ODBC Data Source Administrator’ dialogue you should see your new data source.

The dialogues shown are from Windows 98. The details of these dialogues will differ in fascinating ways from one version of Windows to another, but you will have to enter the same information.

Note: when running the mapping tool, you cannot have the map database open at the same time in Excel.

16.2.2 Setting up an InterBase Map Database

Install InterBase on your machine. The map databases are supplied as .gdb files. Put one of these in a folder where it will stay to be accessed. Note the full path name of this folder, as you are going to have to type it in later

Open the ‘ODBC Data Source Administrator’ and ‘Create New Data Source’ dialogues as before. Now select the ‘IntetBase 5.X Driver’ and hit ‘Finish’ as before to reveal FIG. 77.

‘Data Source Name’ and ‘Description’ are as before. In ‘Database’ you need to type the full pathname of the .gdb file which will be the map database. You must then enter the username and password which you have set up for this database (the files on the disc have username=‘ROBERT’ and password=‘robert’).

16.3 Running XMuLator with Oracle

The odbc driver supplied with Oracle 8 seems to have a strange restriction, that when accessing a result set from an SQL query, you need to access columns in the same order as they are declared in the relational schema. XMuLator has not yet been modified to do this in all places, so this Oracle odbc driver cannot be used.

The result is that to run XMuLator with Oracle, you need to use the Oracle native java jdbc driver, rather than the Sun jdbc-odbc bridge and Oracle odbc. Some people may prefer this anyway.

The required Oracle driver is called the Oracle thin jdbc driver, and you need to obtain a version which is appropriate for your version of Oracle, and for java 1.1, not java 2. This is obtainable from the Oracle web site as a jar archive in a file classes111.zip.

Because the driver is available from Oracle as a zip file, not a windows dll, it is not possible to run the windows executable version of XMuLator with Oracle—you will have to use the jar version of XMuLator.

Obtain the jdbc driver classes111.zip and ensure it is on your java classpath—for instance by storing it in the same directory c:\map as the XMuLator jar file and altering the command line you use to run the jar file to:

jre -cp c:\map\bankhol.jar -cp c:\map\classes111.zip -mx64000000 map_frame

You then need to create an empty Oracle database with the schema given in Appendix B, and to populate it with the contents of an initial XMuLator map database. The ‘initial’ XMuLator map database in not entirely empty; it has a few records in the tables next_key_value, bus_entities, processes, ancestors, map_fields, map_field_values and map_integdity. These records are supplied in the Excel initial database blank.xls.

To make an initial Oracle database, go through the following steps:

Create a completely empty Oracle database, with schema as defined in appendix B. This database will have a host identifier, a port number and a service id (sid), which combine to make a jdbc connection string of the form “jdbc:oracle:thin:@<host>:<port>:<sid>”. It will also have a user name and password, which you need to know in order to connect to it.

Set up the Excel initial XMuLator database ‘blank.xls’ as an odbc source, for instance with the odbc identifier ‘initial’.

Run XMuLator using the command line above, so it can connect simultaneously to the Excel database and the Oracle database (in order to transfer the initial database records from one to the other).

Use the menu item File/Connect to connect to the Excel initial database, using the connect string “jdbc:odbc:initial”.

Use the menu item File/Transfer Map. This will show you another ‘Open Database Connection’ dialogue, into which you should enter the jdbc connection string, user name and password for the Oracle database.

Having successfully opened the Oracle Database, you will be asked: ‘Transfer all map tables, without individual confirmation?’. Answer yes. This will transfer all records from the initial Excel database to create an initial Oracle database.

Alternatively, if you have already populated an Excel map database with a business model, XML schemas and mappings, and want to transfer all of these to an Oracle database, you can do that by using the same sequence of operations as above, using your already-populated Excel database in stead of ‘blank.xls’.

Note: for initially populating an Oracle map database, rather than actually using it, it is possible to use the Oracle odbc driver rather than jdbc, if you wish).

Having populated an Oracle database, you then need to restart XMuLator in order to connect directly to the Oracle database, with no further use for Excel.

16.4 Running the XMuLator Application

Having installed XMuLator and set up a map database as an odbc data source, you are ready to run the tool. Start it up as described in above, and use File/Connect to show the map database connection dialogue.

Under ‘URL’ you need to enter the data source name you defined in the ODBC setup dialogue, preceded by ‘jdbc:odbc:’ (for odbc) or whatever jdbc connection string you have defined (for direct jdbc). For Oracle or InterBase, you also need to enter a user name and password.

Unfortunately, if you somehow fail to connect to a map database (e.g if you type in the wrong name), it has not been possible to trap all the exceptions neatly, and the program may die horribly. Otherwise, the status window should then display ‘Connected to jdbc:odbc:map14’ (or whatever your odbc source is called) and the top-level entity tree will be shown.

If the map database is stored in an Excel workbook, there are some peculiarities which you should be aware of:

Excel cannot actually delete rows from its tables. The mapping tool gets round this by marking deleted records with a special value ‘del’ of the field keyvalue (or of the field mapping-type in the table ‘mappings’. If you delete large numbers of records, it may be worth using Excel off-line to weed out these deleted records, which if they accumulate in large numbers will eventually hinder performance.

Excel does not confirm the updates to its worksheets unless the application shuts down properly, so if your machine crashes you might lose more map updates than you expected. Under Excel, there is an extra menu option File/Save to commit all updates made so far.

17. Utilities

In order to use theses utilities fully, you will need to understand how the information map is stored in the map database—for instance, to know the names of tables used to store different types of map information, and the meanings of fields in those tables. For this knowledge, see Appendix B.

There is basically one table to store each kind of information in the map database—a table ‘bus_entities’ to store information about business model entities, ‘bus_attributes’ to store their attributes, ‘bus-relations’ to store relations. Information about XML sources is stored in another set of tables: ‘info_sources’ with one record per schema, ‘is_entities’ to element definitions, ‘is_attributes’ to store XML attribute definitions, and ‘is_relations’ content mode links. These are called the map data tables. There are three further tables ‘mappings’, ‘att_mappings’ and rel_mappings' which store all the mappings between XML sources and the business information model, and various supplementary tables which will be used below.

17.1 Extending the XMuLator Information Model

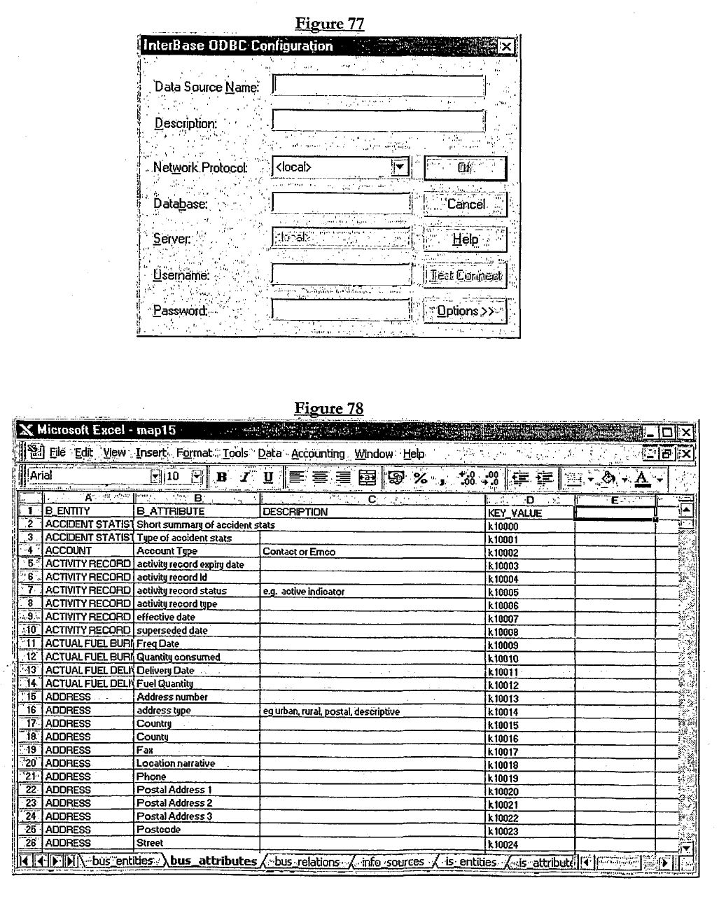

Each map data table, such as the ‘bus_attributes’ table, has a set of required columns which store different kinds of information about each business attribute. You can easily add columns to these tables, and extend the tool to enable you to maintain the information in the new columns. This section explains how. First you need to extend the map database itself to have the new columns. If the map database is stored in Excel, extending it is easy. The Excel workbook has one sheet for each map table, and each sheet name is the corresponding table name. Open the map database in Excel, and it will look like FIG. 78.

Tab to the table you want to extend (in this case, ‘bus_attributes’). You will see the column names in row 1 of the table. Add the new column name after all existing column names—in the selected cell in the diagram shown at FIG. 78.

For any other DBMS (such as InterBase) there will be some simple DBMS-specific procedure to add a column.

Next you need to set up the initial values of the new columns for all existing records. If this value is blank or ‘NULL’ there is nothing to do; but if there is a default value such as ‘YES’ you need to add this value to all records. For most DBMS this can be done by an interactive SQL UPDATE statement. For Excel, you would just insert the new default value in the top row—immediately beneath the column name—then paste it down to all the other rows below using ‘CTRL D’.

Next you need to alter some steering data which tells XMuLator what columns there are in each table, which must be displayed in dialogues to add and update records in that table, so the user can enter values for the new field. This steering data defines the form of all the ‘Edit Detail’ dialogues shown above.

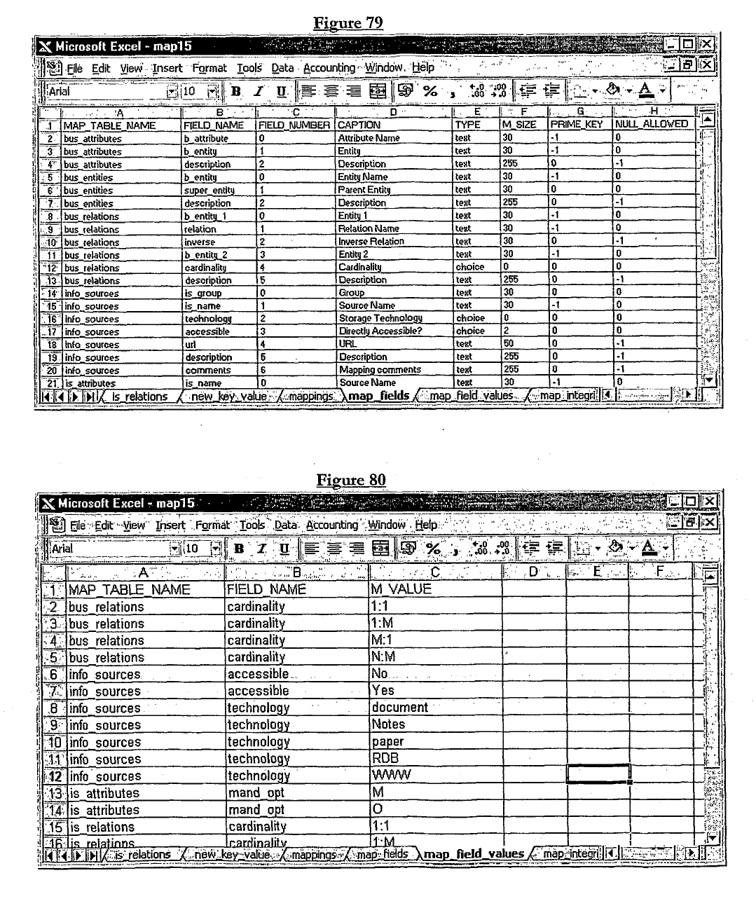

The steering data is held in two tables of the map database—‘map_fields’ and ‘map_field values’. With an Excel database (such as the sample databases on the disc), you can easily inspect these tables. The map_fields table looks like FIG. 79.

Study this table carefully, as you are going to add a new row to it, to define your new column to the mapping tool. Put this new row amongst the rows for the relevant table, with values in its cells as follows:

MAP_TABLE_NAME: the name of the table you are adding a column to.

FIELE_NAME: the name of the new column you are adding.

FIEID_NUMBER: These must go 0,1,2..N to define the order of the fields, from top to bottom in the dialogues for users to enter or edit values. These are the dialogues shown in sections 13 and 14. Enter the new column where it is to go, and increment the number for columns below it.

CAPTION: This is the caption which appears in the dialogue, to the left of each data entry area.

FIELD_TYPE: the type of data to be entered. Currently supported types are only ‘text’ (for text up to some maximum length) and ‘choice’ (for one of a few allowed values, to be selected by menu).

M_SIZE: The maximum size of a text field, in characters.

PRIME_KEY: Put ‘0’ in here, meaning ‘no’; you are not allowed to add to the prime key of map records.

NULL_ALLOWED: Put ‘−1’ if the field is allowed to be blank, ‘0’ if some value must be entered.

If the new column is a ‘choice’ column, with only a few allowed values, you will now have to alter the ‘map field_values’ table to define what the allowed values are. This table looks like FIG. 80.

Add one row for each allowed value of the new column. The values in the cells of each row should be:

MAP_TABLE_NAME: the table where the new column is to be added

FIELD_NAME: The name of the new column

M_VALUE: one of the allowed values.

Now dose Excel and run up XMuLator with the modified database. When adding or editing records in the altered table, you should see your new column name in the dialogue, and be able to enter values for the new column.

If the map database is held in a DBMS rather than in Excel, you will use the interactive update features of that DBMS to make the same changes to the affected table, to map_fields and to map_field_values.

17.2 Bulk Import of Data From Excel (or Other odbc Source)

All types of map information can be input to the mapping tool in bulk from an odbc source—in particular, from Excel configured as an odbc source. This may be particularly useful when working with another CASE tool; metadata can be output from the CASE tool, massaged as necessary in Excel, and then input into the map. We shall describe only the use of Excel for this; other odbc sources can be used in analogous ways.

There are three steps in doing a bulk import of map data:

1. Prepare the data in an Excel workbook

2. Set up this workbook as an odbc source

3. Use File/Import Map Data in the main window of the mapping tool

You can import data into any of the map tables of the map database, to define new business model entities, attributes or relations, new information sources or new IS entities, attributes or relations. You can also insert mappings.

You can only insert new records, not modify or delete existing records. New records which duplicate existing records are ignored. While bulk-inserting records, all the map integrity checks of section 13.1 are applied, and records which violate any check are ignored (with an error message output). The mapping tool automatically makes these inserts which will not violate the integrity checks, as long as the input data does not violate the checks (e.g it will add an entity before its attributes—but will refuse to add attributes which have no entity).

Because the tool cannot add an entity before it has a parent for the entity, it will import entities by a multi-pass approach—first adding whichever entities have a parent already present, then adding their children in the next pass, and so on until no more entities can be added. It operates similarly for processes.

Make up an Excel workbook with one worksheet for each map table you wish to insert into, in the order required to satisfy the integrity checks—entities before attributes and relations, information sources before IS entities, everything before mappings.

In each worksheet, put the column names in the first row. Use File/Output Map Schema in the mapping tool to see these column names, and to see which columns are key fields, or which must be non-null. The worksheet must contain all key or non-null columns of the table, and may contain any of its other columns except for the column ‘key_value’. The value of this column is assigned automatically by the mapping tool, and should not be input Then put the records you want to insert in the following rows.

You do not need to set the worksheet name to be the table name; the tool works out which table is appropriate from the column names.

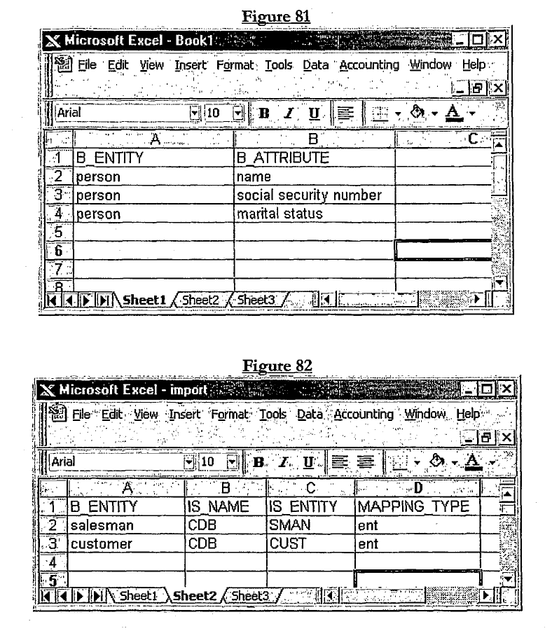

An example import worksheet is shown below in FIG. 81.

This is an import of some business model attributes, into the table bus_attributes. The only necessary columns are the key columns B_ENTITY and B_A ThIBUTE. The optional column DESCRIPTION has not been provided.

Warning—even though you may think you have deleted a worksheet from the Excel workbook (and it is not visible in Excel) sometimes the sheet is still visible over the Excel odbc link, and so is seen by the mapping tool.

To import mappings, you should provide a worksheet whose columns are precisely the key columns of the tables you are mapping between, with one extra column, MAPPING_TYPE. For instance, an attribute mapping is a mapping between the IS_AIrIBUTES table and the BUS_ATTRIBUTES table; so the input worksheet must have just the columns {IS_NAME, IS_ENTITY, IS_ATTRIBUTE, B_ENTITY, B_A™ UTE, MAPPING_TYPE}. These columns can be in any order.

Add a row to the worksheet for each mapping instance you wish to add. In each row, put the key fields of the two records you want to map together, and set the value of MAPPING_TYPE to ‘ent’ for entity mappings, ‘att’ for attribute mappings, and ‘rel’ or ‘inv’ for relation mappings. ‘rel’ denotes a direct relation mapping, where (Entity1 relation Entity2) maps to (Owner relation Detail). ‘inv’ denotes an inverse relation mapping, where (Entity1 relation Entity2) maps to (Detail relation Owner). In an inverse mapping, the business model relation maps to the inverse of the IS relation, and vice versa.

An input worksheet to add two new entity mappings is shown in FIG. 82.

The name you give to the Excel workbook when you save it is not directly visible to XMuLator; what is visible is the name you give it as an odbc data source. Do this by the procedure described in section 12.2; this time you can leave the workbook as ‘read-only’. It is convenient the call the odbc data source ‘import’, as this is the default name in the XMuLator dialogue used to open it; using ‘import’ will save you retyping its name.

(Once you have defined an odbc source for importing data, you will not need to do so again. For subsequent imports, give the Excel workbook the same name as your original import workbook, and store it in the same directory. Odbc will then pick up the new workbook as the source for the next import).

17.3 Transferring Between DBMS

It is sometimes necessary to transfer a map database from one DBMS to another, or to transfer it between Excel and a DBMS. This can be done from the main window by the menu command File/Transfer Map. This transfers all records in all tables of the map database automatically to a new database, leaving the old database unchanged.

In each table, this utility transfers the value of every column which is present in both the source and the target table; therefore you can add or remove any columns with optional values as part of the transfer.

The steps involved in malting a transfer are:

1. Create a new target database with all the tables of the source database, and no records in any table.

2. Register this database as an odbc source

3. In the mapping too, choose File/Transfer Map

4. When the odbc source dialogue appears, enter the name of the target database.

You will then be given a choice of transferring all tables without further intervention, or choosing individually to transfer each table.

18. Known Problems and Workarounds

18.1 Creating the Business Information Model

Changes not Always Reflected Immediately On-Screen: Some changes to the business information model, while being properly captured to the database, are not always immediately reflected in the in-memory version or in the screen image. Do things to make it refresh. In the last resort restart.

Inheritance Name Clashes: If you try to give an entity class a new attribute with the same name as one it already inherits, this has potentially harmful effects downstream, but XMuLator currently does not stop you form doing so. Similarly if you try to give two classes a relation between them, with the same name as one they already inherit, XMuLator does not yet stop you doing so. To avoid these problems, use Show/Attributes or Show/Relations(Table) to display inherited attributes or relations before you add a new one.

18.2 Capturing XML Schemas and Mappings

Complex Content Models: XMuLator represents content model links by a string showing the path through content model links from an outer element to an inner element nested inside it. These strings are intended to be unique for any given outer and inner element When reading an XML schema from a DTD, if an element has a complex content model, in which the same subsidiary element appears nested more than once, then the content model string may be identical for the two occurrences of the element. This causes XMuLator to try to store two records with identical primary keys in its database. Excel does not object to this, but other DBMS will.

Reading XDR files: When capturing XML syntax from an XDR file, the XML parser will sometimes not recognise the root element of the XML document which defines the XDR. The workaround is to remove the <?xml . . . > and <?xml-stylesheet> elements which occur before the top <Schema > element in the XDR file.

18.3 Generating Transforms

Trailing Spaces in Values: XMuLator generates XSLT which sometimes creates a trailing space in the value of an element or an attribute. This is intended to separate multiple values in the element or attribute, but will produce a trailing space anyway. If this is a problem, you can use a post-processing XSLT file which uses xsl:normalise-space to remove them. The round-trip subset test detects these trailing spaces and reports them as errors.

Empty Elements: XMuLator generates XSLT which occasionally creates an empty element in the output, where the input had no data. This is quite hard to eliminate completely in a one-pass approach. If these are a problem, you can use a post-processing transformation to remove them. We will be writing one for general use, and in due course this can be incorporated in the main XSLT file produced by XMuLator. The round-trip subset test detects these empty elements and reports them as errors.

18.4 Testing Transforms

Naive Subset Test: The module which tests that the result of a round-trip transformation is a subset of the input currently makes some naive assumptions about the result of the transformation process. Mainly, it assumes that round-trip transformation does not alter the order of elements nested inside another element. This is true most of the time, but not always—e.g. if during the round-trip the elements have been grouped in some other way. The result is that the subset test is over-sensitive—it sometimes reports errors where on inspection there is none

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

1. A computer program which uses a set of mappings between XML logical structures and business information model logical structures, in which the mappings describe how a document in a given XML based language conveys information in a business information model.

2. The computer program of claim 1 which achieves some functionality using XML, in which the same functionality can be achieved with different XML based languages by using a set of mappings appropriate to each language.

3. The computer program of claim 1 in which the set of mappings is embodied in an XML document.

4. The computer program of claim 1 adapted to generate XSL using the sets of mappings for a first and a second XML based language to enable a document in the first XML based language to be translated automatically to a document in the second L based language.

5. The computer program of claim 4 in which using the set of mappings involves the step of reading XML documents defining of the sets of mappings between XML logical structures and business information model logical structures.

6. The computer program of claim 1 adapted to translate dynamically a message in one AL language to another using the sets of mappings for the two languages to some common business information model.

7. The computer program of claim 6 in which using the set of mappings involves the step of reading XML documents defining the sets of mappings between XML logical structures and business information model logical structures.

8. The process of automatically generating a computer program, using information from the mappings as defined in claim 1, so that the generated programs will work with different XML languages depending on which set of mappings each program was generated from.

9. The computer program of claim 1 as used in an interface layer providing an API which insulates code written in a high level language which accesses or creates documents in XML based languages from the structure of those XML based languages.

10. An API computer program comprising an interface layer adapted to insulate code written in a high level language from a given XML based language to enable an application written in the high level language to interface with the XML based language by using the program of claim 1, so that the code in the application is not dependent on the structure of the XML language.

11. A computer program in which an interface layer adapted to insulate code written in a high level language from XML based languages takes as an input a document in a XML based language and converts in one or both directions between a tree mirroring the structure of the XML based language and business information model logical structures by using the mappings between them as described in claim 1.

12. A computer program in which an interface layer uses the mappings of a first XML language onto a business model to read in data in the first XML language and convert it to an internal form reflecting the logical structures of the business model, and in which the interface layer uses the mappings of a second XML language onto the same business information model to convert data from the internal form reflecting the logical structures of the business information model to the structures of the second XML language

13. A method of translating between a first and a second XML based language by using the computer program of claim 12.

14. The method of claim 13 adapted to allow runtime translations, allowing the choice of the input and output XML languages to be made dynamically by the use of the appropriate mappings

15. The computer program of claim 11 in which the code written in a high level language allows users to submit queries in terms which reflect the logical structures of the business information model, not requiring knowledge of the structure of an XML language, and the translation layer allows a document in the an XML based language to be queried, using the mappings of that XML language onto the business information model.

16. The query program of claim 15 in which the same query can be run against documents in different XML languages by using the sets of mappings appropriate for each such language.

17. The computer program of claim 1 in which the logical structures of the business information model categorise the information relevant to the operations of the business organisation in terms of (a) classes of entities, (b) attributes of the entities of each class and (c) relations between these entities.

18. The computer program of claim 1 in which the mappings are specifications of what nodes need to be visited and paths traversed in the XML to retrieve information about given objects of classes, attributes and relations.

19. The computer program of claim 1 in which the XML logical structures are objects classified according to XML element types, XML attributes and XML content model links.

20. The computer program of claim 1 in which the XML logical structures are derived from schema notations.

21. The computer program of claim 1 in which the business information model logical structures categorise information in terms of ontological knowledge representation techniques.

22. A method of performing e-commerce transactions between several organisations using different XML-based languages of XML, in which a computer program as defined in claim 1 is used.

23. A method of enterprise application integration within an organisation using different XML-based languages, in which a computer program as defined in claim 1 is used.

24. A method of enabling a business organisation to alter an e-commerce business model reliant on XML interoperability, comprising the use of a computer program as defined in claim 1.

25. A method of creating a XML-based language comprising the following steps:
(a) creating a business information model
(b) defining requirements for an XML-based language in terms of classes, attributes and relations in the business information model that need to be represented in documents in the language
(c) automatically generating a schema definition of the XML-based language which meets those requirements, applying automatically various choices as to how different pieces of business information in the requirement are to be represented in XML.

26. The method of claim 25 comprising the further step of, as the schema is generated, recording the automatically generated mappings between the elements, attributes and content model links of the schema and the classes, attributes and relations which the schema is required to represent in the business information model.
